(19) United States
(12) Patent Application Publication
(10) Pub. No.: US 2025/0258803 A1
(43) Pub. Date: Aug. 14, 2025

(54) METHOD FOR AUTOMATED GRAPH SCHEMA GENERATION AND RELATED APPARATUS

(71) Applicant: PoppyQuery Inc., Santa Clara, CA (US)

(72) Inventors: Weimo LIU, Santa Clara, CA (US); Danfeng xu, Belmont, CA (US); Lei Huang, Fremont, CA (US); William y. Yao, Folson, CA (US); Theresa xu, Santa Clara, CA (US)

(21) Appl. No.: 19/063,915

(22) Filed: Feb. 26, 2025

Related U.S. Application Data
(63) Continuation-in-part of application No. 18/442,085, filed on Feb. 14, 2024.

(51) Int. Cl. G06F 16/21; G06F 16/28; G06F 16/901

(52) U.S. Cl. CPC G06F 16/211; G06F 16/283; G06F 16/9024

(57) ABSTRACT

This application is directed to automated graph schema generation. A schema generation method includes receiving a graph schema having vertices and edges associated with a plurality of data tables. The method also includes automatically generating, based on the plurality of data tables and the graph schema, one or more suggestions using a computational model. The one or more suggestions identify one or more vertices and/or one or more edges. The one or more suggestions include a respective suggestion that identifies a respective subset of the one or more vertices and/or the one or more edges. The method further includes receiving a first user input that is a selection of the respective suggestion from the one or more suggestions. The method further includes updating, based on the first user input, the graph schema. The method further includes outputting the updated graph schema.

### RELATED APPLICATION

This application is a continuation-in-part application of U.S. patent application Ser. No. 18/442,085, entitled “Method for Performing Data Query Using a Graph Analytics Engine and Related Apparatus” filed Feb. 14, 2024, which is incorporated by reference herein in its entirety.

### TECHNICAL FIELD

This application relates generally to data query, including but not limited to techniques for performing data query and generating graph schema.

### BACKGROUND

Data querying serves as a fundamental building block of data management and analytics. Continuous advancements in data querying technologies and methodologies are required to keep pace with users' demands. Challenges in data querying spans various aspects, including query optimization, query scalability, and complexity of traversing interconnected data. In particular, large-scale graph-based data querying requires an efficient graph processing and an effective integration into expandable databases. Moreover, balancing trade-offs between query complexity and computational efficiency remains an ongoing challenge in this domain.

Additionally, databases (e.g., graph databases) have become popular for their ability to represent and manage highly interconnected data in various fields. Data stored in databases often contain complex, interrelated information that can be more intuitively understood when visualized using graphs. Therefore, it is important to create graph schema(s) that defines structure and organization of data within a database. Moreover, a graph schema of a database specifies types of edges and vertices (e.g., nodes), their properties, and relationships between them. The graph schema enables efficient querying, traversal, and analysis of data within the database. In some circumstances, creating a graph schema for querying a database is often a time-consuming process. A user needs to create the graph schema (e.g., by manually writing a graph schema) in a data format to specify edges and vertices and their mappings to associated tables/attributes stored in the database.

As such, there is a need to address one or more of the above-identified challenges. A brief summary of solutions to the issues noted above are described below.

### SUMMARY

Various embodiments of this application are directed to implementing a graph analytics engine that brings a unique solution to data querying and provides a robust data querying platform for accessing large-scale databases. This approach brings several advantages. First, an “Extract, Transform, and Load” (ETL) Process is no longer required. Users can query tables to obtain graphs based on existing tabular databases. The existing tabular databases can be built on Apache Hive, Apache Iceberg, Apache Hudi, Delta Lake, MySQL/Postgre SQL, or other forms that support database connectivity. Second, auto-scaling becomes achievable, as scalability is no longer a concern for graphs. This is because data are auto-sharded, with computation and storage being separately distributed. Third, exceptional performance can be achieved with low latency for complex data queries (e.g., queries for 10-hop neighbors). Fourth, a data querying platform based on the graph analytics engine can be easily migrated because of its compatibility with existing query languages (e.g., Apache Gremlin and OpenCypher) and established data lakes (e.g., Apache Iceberg, Apache Hudi, and Delta Lake). Fifth, data management is streamlined, because there is no need to create additional persisted data copies, which simplifies retention obligations. This simplification of data management process can be further achieved by leveraging existing data lake permissions. Lastly, a data querying platform based on the graph analytics engine empowers users to maintain complete control of their data within data centers that are seamlessly integrated into their cloud-native infrastructure.

Additionally, various embodiments of this application are directed to implementing an automated graph schema generation system to create graph schemas from tables (e.g., relational data tables) stored in relational databases. The automated graph schema generation system leverages data analysis techniques and artificial intelligence (AI), thereby significantly reducing the need for manual interventions. In particular, the automated graph schema generation system constructs graph-based data models (e.g., rule-based suggestion model, AI-based suggestion model) for processing data (e.g., relational data). For example, automated graph schema generation system automatically identifies and generates vertices (e.g., nodes) and edges from user-provided relational data, allowing real-time interaction between a user and a graphical user interface to dynamically create a graph schema based on auto-generated suggestions. This approach significantly reduces mental and physical effort required to navigate large relational tables, e.g., enabling a user to simply click and select from suggested vertices and edges, streamlining a graph-building process in a short amount time. In some embodiments, the automated graph schema generation system simplifies and streamlines a schema generation process by implementing a schema suggestion generator having a computational model. In some embodiments, the schema suggestion generator iteratively expands a graph schema using the computational model by allowing a user to select respective suggested edges and vertices. In some embodiments, the computational model includes a rule-based suggestion model (e.g., for rule-based suggestions) and an intelligence model (e.g., for AI-based suggestions). The intelligence model executes large language models (LLMs). In some embodiments, both rule-based suggestion model and intelligence model provide user-computer interaction, allowing the user to guide suggestions provided by the computational model. In some embodiments, the schema suggestion generator selects, based on the user's input, between the rule-based suggestion model and the intelligence model based on available resources and data. In some embodiments, selecting the rule-based suggestion model is a preferred option (e.g., when resources are limited and no LLM is available). In some embodiments, selecting the intelligence model is a preferred option (e.g., when a database has comprehensive information, such as documentation or specification files, when an LLM or an associated application programming interface (API) is accessible). The schema suggestion generator receives the user's input(s) based on natural language and guides the user to generate the graph schema. In some embodiments, the schema suggestion generator combines the rule-based suggestion model and intelligence model for graph scheme generation (e.g., the schema suggestion generator switches from one model to another after generating a partial graph schema). In some embodiments, the schema suggestion generator includes a graphical interface (e.g., a graph visualization tool) for displaying, in real-time, graph-based representations for generated graph schemas. In some embodiments, the automated graph schema generation system brings advantages of (i) significantly minimizing user effort by requiring user selection from suggestions and thereby removing the need to manually write complex schema files, (ii) maximizing usage of data (e.g., graph data, metadata, documentation files, specification files, etc.) to enhance accuracy in graph schema generation, and (iii) providing flexibility in selecting and combining models (e.g., the rule-based suggestion model and the intelligence model) based on available resources (e.g., computation power, LLMs, other AI-based resources, etc.).

In accordance with some embodiments, a data query method comprises receiving a query that defines a graph relationship between target entities within a to-be-queried database. The data query method further includes traversing the to-be-queried database using the query through a graph analytics engine to obtain a plurality of output entries. Each output entry includes a plurality of data items matching the graph relationship defined by the query. The graph analytics engine includes an auxiliary component for the query. The auxiliary component further includes a plurality of vertices and a plurality of edges associated with the to-be-queried database, and each edge links two vertices. The data query method further includes generating a graph-based representation of the plurality of output entries.

In accordance with some embodiments, a computer device performs a schema generation method by performing a set of operations. The computer device receives a graph schema that includes vertices and edges associated with a plurality of data tables. The graph schema includes at least a first vertex from a first data table of the plurality of data tables. The computer device then automatically generates, based on the plurality of data tables and the graph schema, one or more suggestions using a computational model. The one or more suggestions identify at least one of the group consisting of one or more edges and one or more vertices. The one or more suggestions include a respective suggestion that identifies a respective subset of the at least one of the group consisting of the one or more vertices and the one or more edges. The one or more vertices are distinct from the first vertex. The computer device further receives a first user input. The first user input is a selection of the respective suggestion from the one or more suggestions. The computer device further updates, based on the first user input, the graph schema. The schema generation method further includes outputting the updated graph schema.

In accordance with some embodiments, a computer system comprises one or more processes and memory storing one or more programs. The one or more programs are configured to be executed by the one or more processors. The one or more programs include instructions for any of the methods described above.

In accordance with some embodiments, a non-transitory computer-readable storage medium stores one or more programs. The one or more programs comprise instructions that, when executed by a computer system that includes one or more processors, cause the one or more processors to perform operations for any of the methods described above.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example data query system based on a graph analytics engine, in accordance with some embodiments.

FIG. 2 illustrates an example data query system based on the graph analytics engine, in accordance with some embodiments.

FIG. 3 illustrates an example graph query process based on an example graph analytics engine, in accordance with some embodiments.

FIGS. 4A-4C illustrate an example transaction trace graph query based on the graph analytics engine for a to-be-queried tabular database, in accordance with some embodiments.

FIGS. 5A-5L illustrate a series of graph query steps associated with an example person_knows_person graph query that is performed based on a management user interface (UI) of the graph analytics engine, in accordance with some embodiments.

FIGS. 6A-6F illustrate a series of graph query steps associated with an example person_knows_person graph query that is performed based on the management UI of the graph analytics engine, in accordance with some embodiments.

FIGS. 7A-7D illustrate an example graph query using the graph analytics engine with locally deployed Apache Iceberg, in accordance with some embodiments.

FIG. 7E illustrates an example graph query using the graph analytics engine with locally deployed PostgreSQL, in accordance with some embodiments.

FIG. 7F illustrates an example graph query using the graph analytics engine with locally deployed DuckDB, in accordance with some embodiments.

FIGS. 8A-8J illustrate an example graph query using the graph analytics engine with data lakes, in accordance with some embodiments.

FIGS. 9A-9O illustrates an example graph query using the graph analytics engine with relational databases, in accordance with some embodiments.

FIGS. 10A-10Q illustrate a series of screenshots of an example schema creation UI for creating an example person_knows_person_UI graph schema, in accordance with some implementations.

FIG. 11 illustrates an example schema generation system that performs automated graph schema generation, in accordance with some embodiments.

FIG. 12 illustrates an example schema generation system that iteratively expands vertices and edges of a graph schema based on automated graph schema generation, in accordance with some embodiments.

FIG. 13 illustrates an example schema generation system that includes an AI-based suggestion model with various functionalities for generating suggestions associated with a graph schema, in accordance with some embodiments.

FIG. 14A is a flow chart of a rule-based suggestion model that expands vertices and edges associated with a graph schema, in accordance with some embodiments.

FIG. 14B is a flow chart of the rule-based suggestion model that further illustrates an operation of the flow chart of FIG. 14A, in accordance with some embodiments.

FIGS. 15A-15C illustrate an example transaction trace used for generating schema graphs.

FIGS. 16A-16H illustrate an example schema generation using the example transaction trace of FIGS. 15A-15C, in accordance with some embodiments.

FIG. 17 is a block diagram illustrating a computer system that supports a data query system and a schema generation system, in accordance with some embodiments.

FIG. 18 illustrates a flow diagram of an example data query method, in accordance with some embodiments.

FIG. 19 illustrates a flow diagram of an example schema generation method, in accordance with some embodiments.

These illustrative aspects are mentioned not to limit or define the disclosure, but to provide examples to aid understanding thereof. Additional embodiments are discussed in the Detailed Description, and further description is provided there.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, and networks have not been described in detail so as not to unnecessarily obscure aspects of the embodiments.

### System Architectures

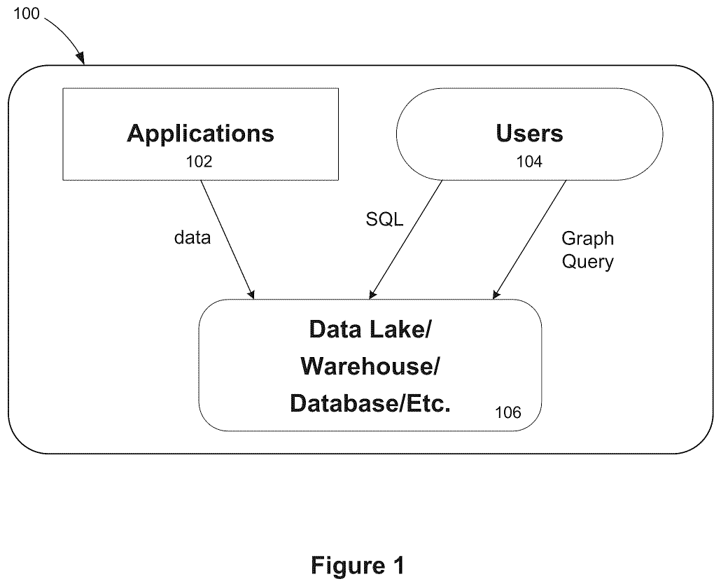

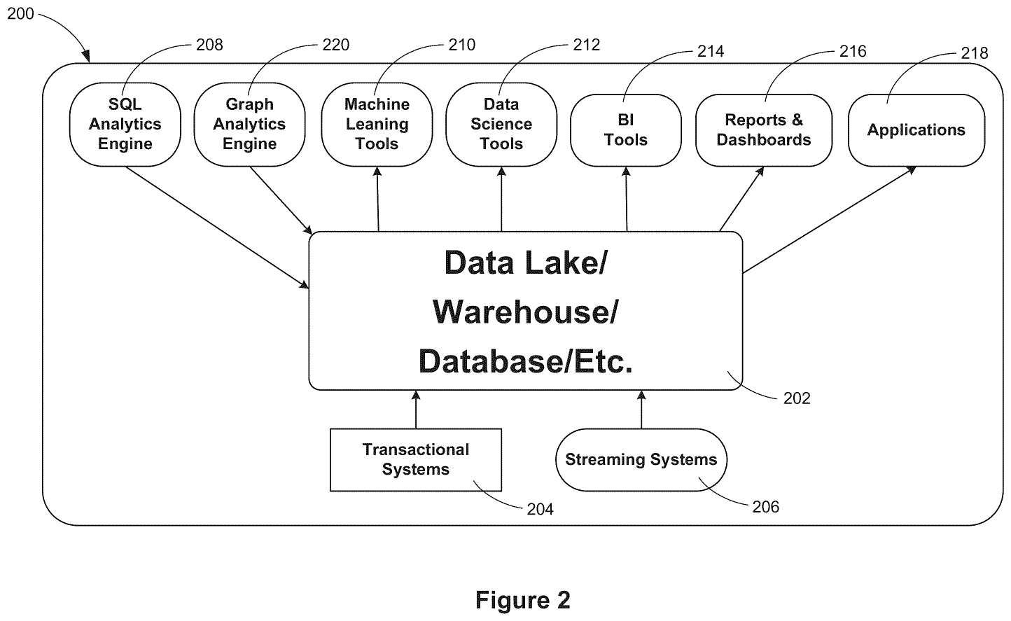

FIG. 1 illustrates an example data query system 100 based on a graph analytics engine, in accordance with some embodiments. As shown in the example graph query system 100, applications (e.g., software, networks, user interfaces, or open-source projects) 102 are configured to create and manage a to-be-queried database 106. The to-be-queried database 106 is created in accordance with a data architecture that includes at least one of a relational database, a data warehouse, a data lake, or other forms. In particular, the to-be-queried database 106 includes non-graph relationships between non-graph entities and/or graph relationships between graph entities. A user 104 creates a non-graph query that defines a non-graph relationship between the non-graph entities and/or generates a graph query that defines a graph relationship between the graph entities. The user 104 traverses the to-be-queried database 106 using the non-graph query via structured query language (SQL) to obtain output non-graph entries for the non-graph query. Alternatively, the user 104 traverses the to-be-queried database 106 using the graph query through the graph analytics engine (described below in reference to FIG. 2) to obtain output graph entries for the graph query, where each output graph entry for the graph query includes data items matching the graph relationship defined by the graph query.

In some embodiments, for querying a to-be-queried database, a user no longer needs to choose between a SQL-based data model or a graph-based data model. For instance, as shown in FIG. 1, the to-be-queried database 106 can be constructed using SQL-based data models and/or graph-based data models, and it can then be accessed by a data query via the graph analytics engine.

FIG. 2 illustrates an example data query system 200 based on the graph analytics engine 220, in accordance with some embodiments. A to-be-queried database 202 is built in accordance with a data architecture that includes at least one of relational database, data warehouse, data lake, or other forms. In some embodiments, the to-be-queried database 202 includes a non-SQL (NoSQL) database. The to-be-queried database 202 includes non-graph data and graph data, which are received from transactional systems 204 (e.g., storage devices) and/or streaming systems 206 (e.g., cloud storages). In particular, the non-graph data and graph data in the to-be-queried database 202 can be stored in formats compatible with SQL. A SQL analytics engine 208 is configured to traverse the to-be-queried database 202 using non-graph queries (e.g., written in SQL). On the other hand, the graph analytics engine 220 is configured to traverse the to-be-queried database 202 using both graph queries (e.g., written in graph languages) and non-graph queries (e.g., written in non-graph languages). Then, output entries obtained from the non-graph and/or graph queries are sent to accessory tools for data processing and/or visualization. For instance, the accessory tools include machine learning tools 210, data science tools 212, business intelligence tools 214, reports and dashboards 216, and applications 218 in other forms.

In some embodiments, the graph analytics engine is configured to generate a graph-based representation of output entries obtained from a data query. The graph-based representation can be a network diagram (e.g., network graph, neural network diagram, mesh topology diagram, or other forms). For instance, as shown in FIG. 2, it is optional that the graph analytics engine 220 also includes features for data processing and/or visualization, similar to features provided by the accessory tools (e.g., 210, 212, 214, 216, and 218).

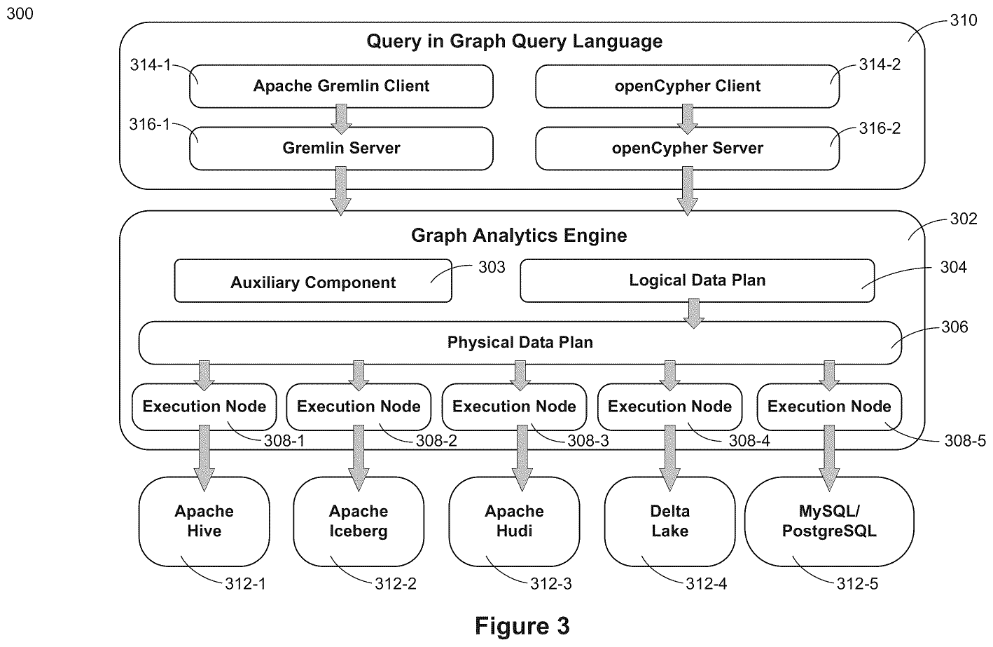

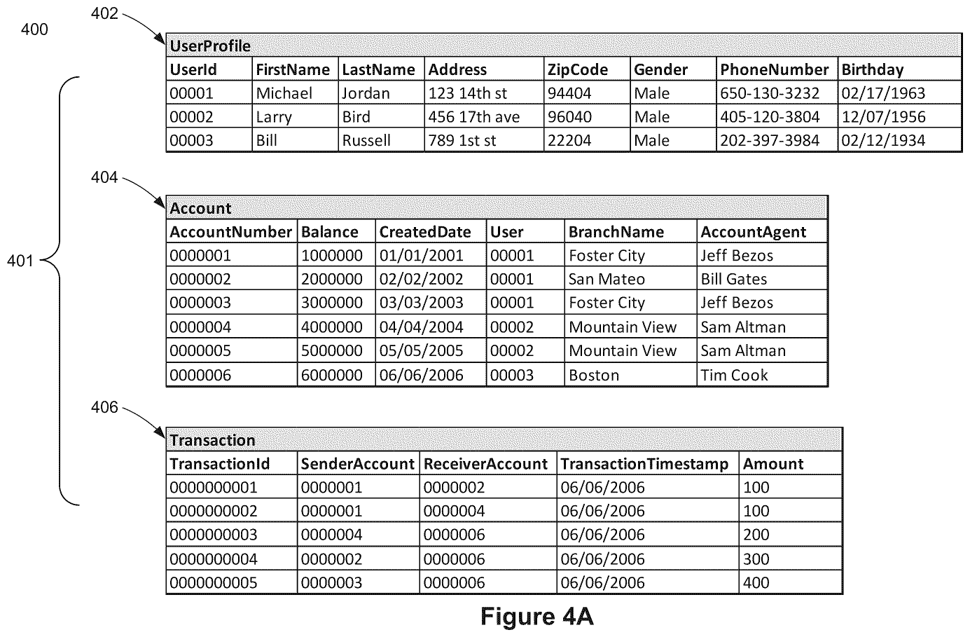

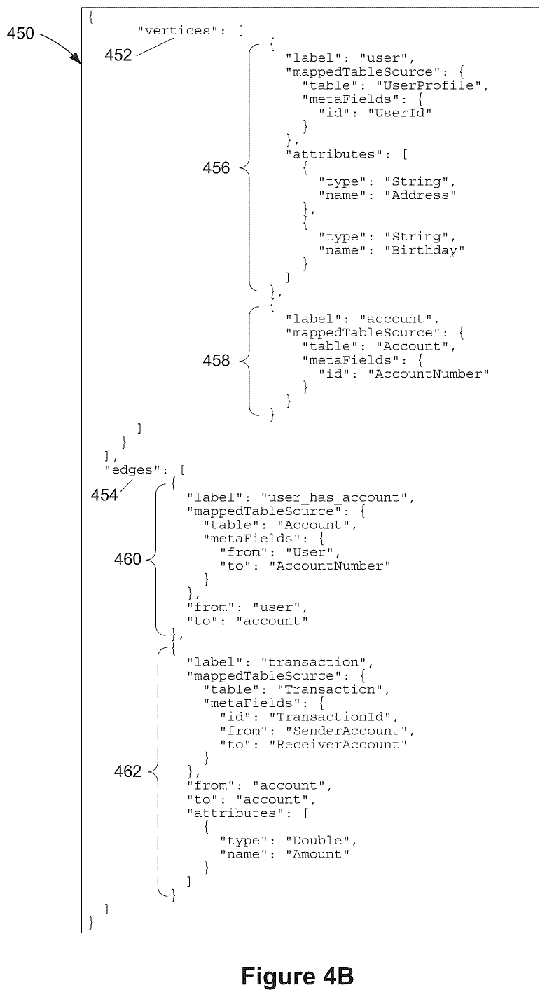

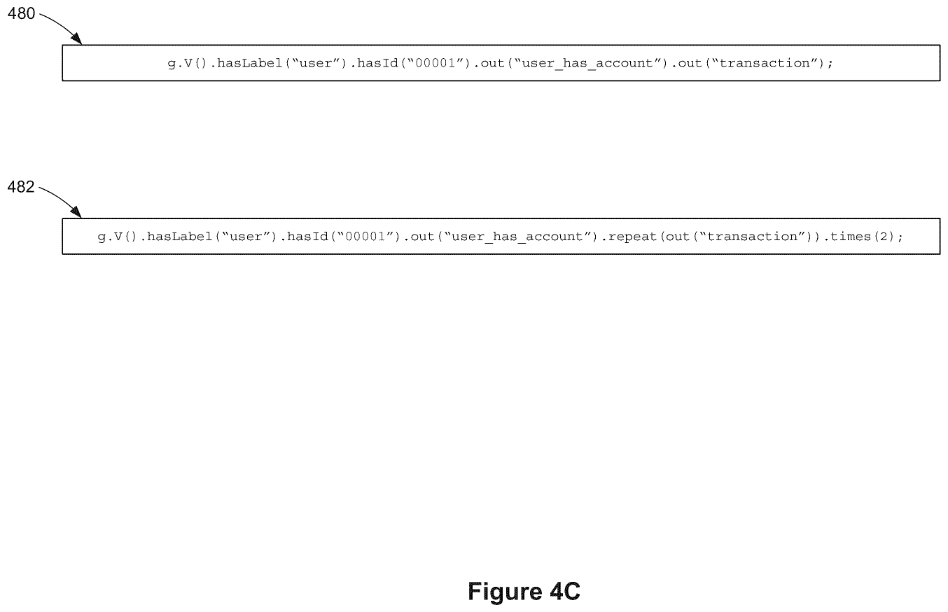

FIG. 3 illustrates an example graph query process 300 based on an example graph analytics engine 302, in accordance with some embodiments. The example graph analytics engine 302 is an example of the graph analytics engine 220. The example graph analytics engine 302 includes an auxiliary component 303, a logical data plan 304, a physical data plan 306, and one or more execution nodes 308. In the example graph query process 300, a user first creates a graph query and then traverses one or more to-be-queried databases 312 using the graph query through the graph analytics engine 302. Specifically, the user starts from creating the graph query on a platform 310 (e.g., software, network, user interface, or open-source project). The graph query defines a graph relationship between target entities within the one or more to-be-queried databases 312. The user can choose to create the graph query using an open-source project that is written in a graph query language. For instance, the user creates the graph query on a client portal of Apache Gremlin 314-1 and submits the graph query to a server portal of Apache Gremlin 316-1. In another instance, the user generates the graph query on a client portal of openCypher 314-2 and transfers the graph query to a server portal of openCypher 316-2. After the graph query is created, the user imports the graph query from the platform 310 to the example graph analytics engine 302. Next, the example graph analytics engine 302 is configured to map the graph query to the logical data plan 304 in accordance with a defined hierarchy of the target entities being stored in the auxiliary component 303 (described with more details below in reference to FIGS. 4A-4C). The example graph analytics engine 302 is further configured to translate the logical data plan 304 to the physical data plan 306. Then, the example graph analytics engine 302 is further configured to query, based on the physical data plan 306, the one or more to-be-queried databases 312 through the one or more execution nodes 308 for obtaining output graph entries. Each output graph entry includes data items that match the graph relationship defined by the graph query.

Additionally, as shown in FIG. 3, each execution node of the one or more execution nodes 308 is associated with a respective to-be-queried database of the one or more to-be-queried databases 312. The example graph analytics engine 302 includes five execution nodes (e.g., 308-1, 308-2, 308-3, 308-4, and 308-5), which are associated with five to-be-queried databases Apache Hive 312-1, Apache Iceberg 312-2, Apache Hudi 312-3, Delta Lake 312-4, and MySQL/Postgre SQL 312-5, respectively.

In some embodiments, a graph query process based on the graph analytics engine supports data sources distributed across cloud platforms and regional networks.

In some embodiments, the graph analytics engine includes an auxiliary component for a data query (e.g., a non-graph query and/or a graph query). The auxiliary component includes vertices and edges that are associated with a to-be-queried database, where each edge links two vertices. For instance, as shown in FIG. 3, the example graph analytics engine 302 includes the auxiliary component 303.

In some embodiments, traversing a to-be-queried database using a query through the graph analytics engine includes mapping the query into a logical data plan in accordance with an auxiliary component. Traversing the to-be-queried database using the query through the graph analytics engine includes translating the logical data plan to a physical data plan. Traversing the to-be-queried database using the query through the graph analytics engine further includes querying, based on the physical data plan, the to-be-queried database through an execution node. For instance, as shown in FIG. 3, the example graph analytics engine 302 is configured to receive the graph query from the platform 310 and map the graph query into the logical data plan 304 in accordance with the defined hierarchy of the target entities being stored in the auxiliary component 303. In an example, the defined hierarchy of the target entities reflects the graph relationship of the target entities. Next, the example graph analytics engine 302 is further configured to translate the logical data plan 304 to the physical data plan 306. Then, the example graph analytics engine 302 is configured to query, based on the physical data plan 306, the one or more to-be-queried databases 312 through execution nodes 308. Lastly, the example graph analytics engine 302 is configured to obtain output graph entries and generate a graph-based representation of the output entries, e.g., visualization using a network diagram.

In some embodiments, a logical data plan is a high-level structured representation of a data query (e.g., a non-graph query or a graph query). The logical data plan can be implemented based on a structural framework, e.g., tree architectures.

In some embodiments, a physical data plan is a low-level structured representation of a data query (e.g., a non-graph query or a graph query). The physical data plan defines physical storage structures (e.g., access methods and indexing) for data models and queries.

In some embodiments, the graph analytics engine includes a plurality of execution nodes, and each execution node is associated with a respective to-be-queried database. For instance, as shown in FIG. 3, the example graph analytics engine 302 includes five execution nodes (e.g., 308-1, 308-2, 308-3, 308-4, and 308-5). The execution nodes 308-1 to 308-5 are associated with the to-be-queried databases Apache Hive 312-1, Apache Iceberg 312-2, Apache Hudi 312-3, Delta Lake 312-4, and MySQL/Postgre SQL 312-5, respectively.

In some embodiments, the graph analytics engine includes a plurality of execution nodes, and one or more respective execution nodes of the plurality of execution nodes are associated with a respective to-be-queried database. For instance, the graph analytics engine can include two execution nodes that are associated with a respective to-be-queried data lake. As a result, the graph analytics engine can traverse the respective to-be-queried data lake through either one of the two execution nodes or through the two execution nodes simultaneously. Offering multiple execution nodes for one respective to-be-queried database brings several advantages, including parallel processing, scalability, and cost efficiency.

In some embodiments, a data query is written in a graph query language. For instance, as shown in FIG. 3, the data query can be written in Gremlin or openCypher. In some embodiments, the data query is written in a non-graph query language. For instance, as shown in FIG. 1, the data query can be written in SQL. Specifically, the graph analytics engine is not confined to particular query languages and can support a wide range of query languages.

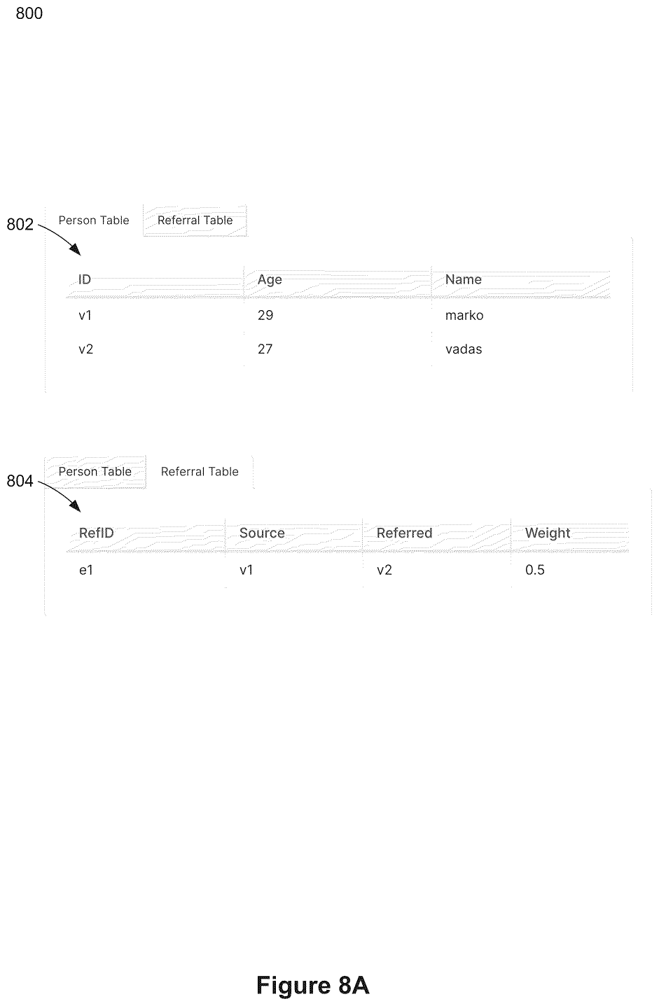

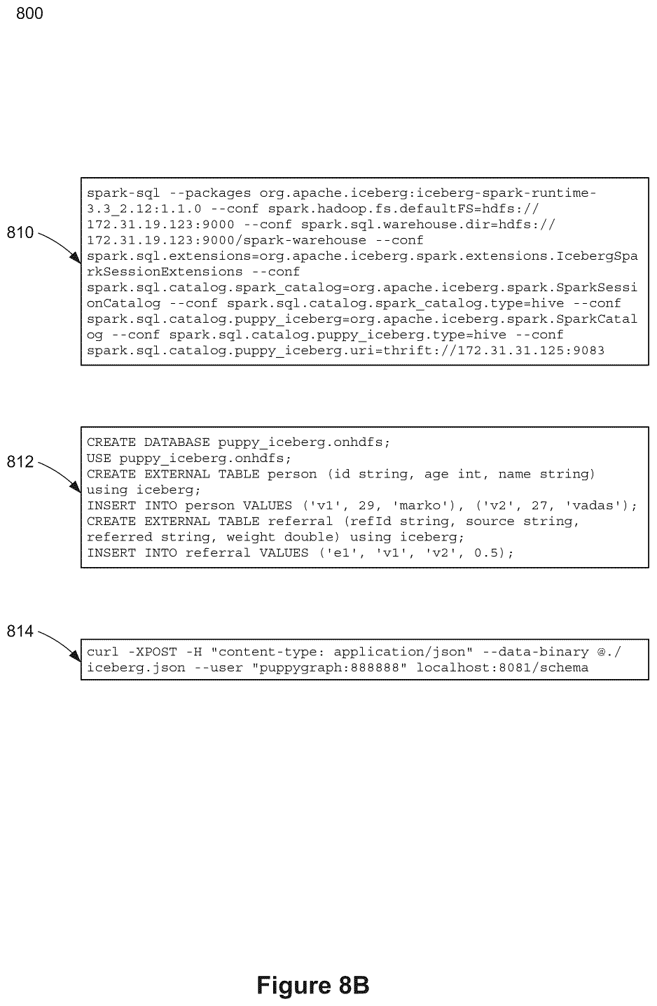

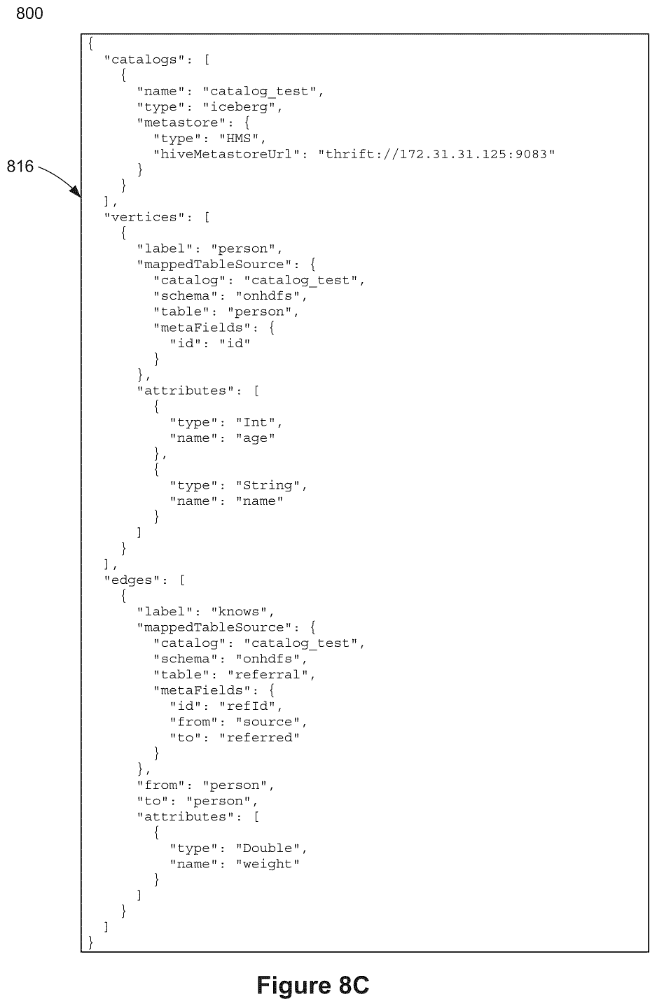

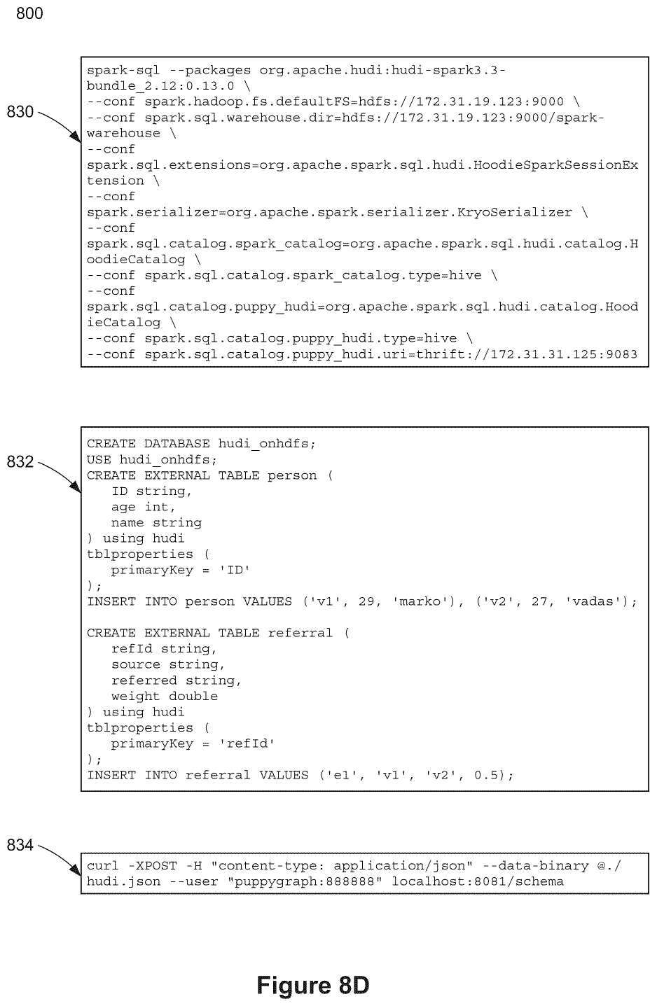

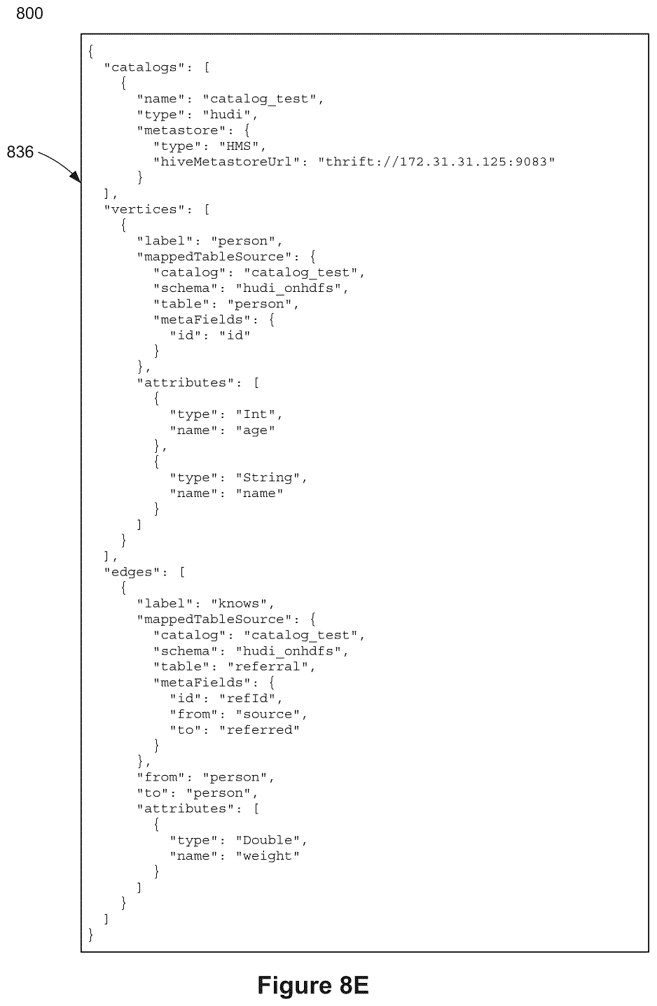

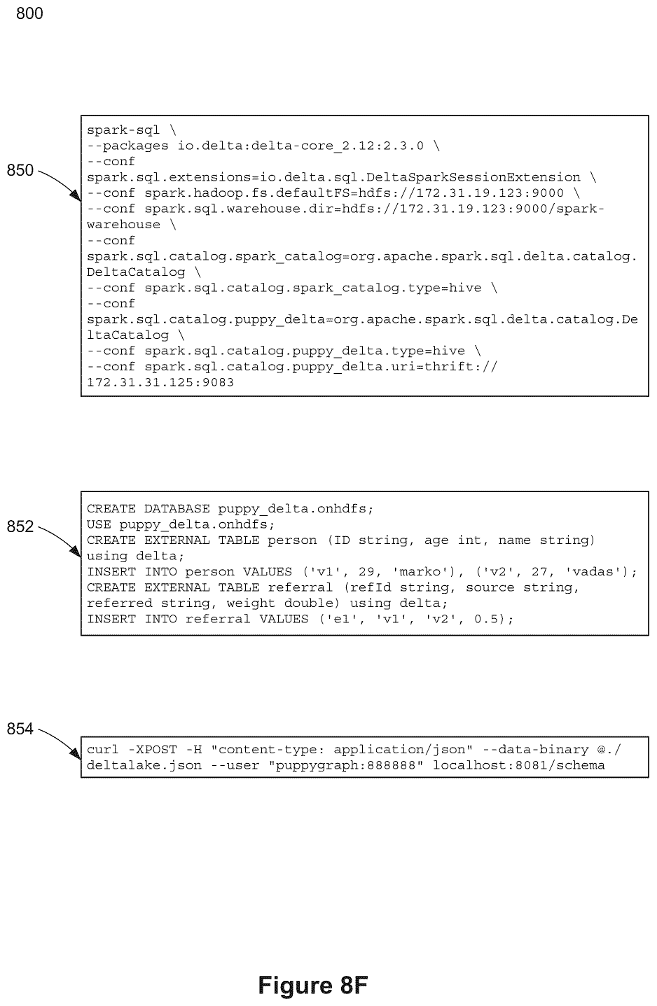

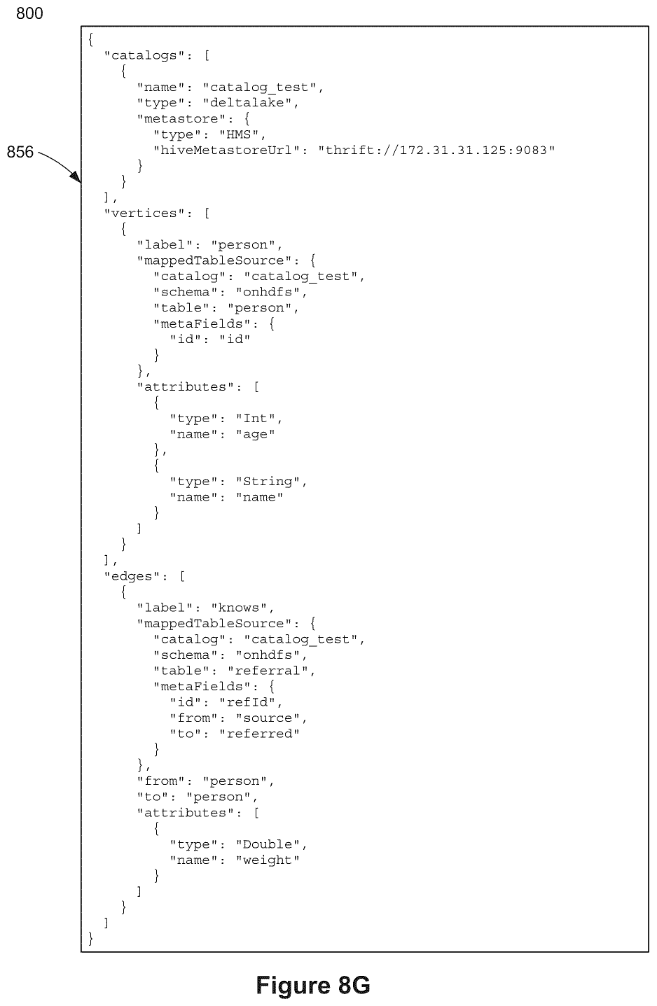

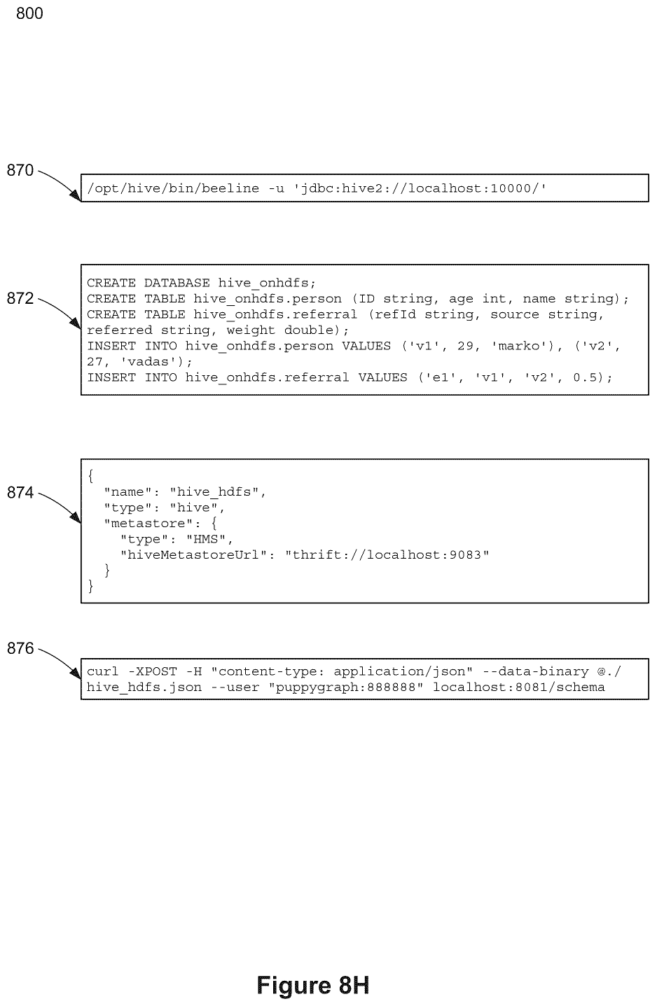

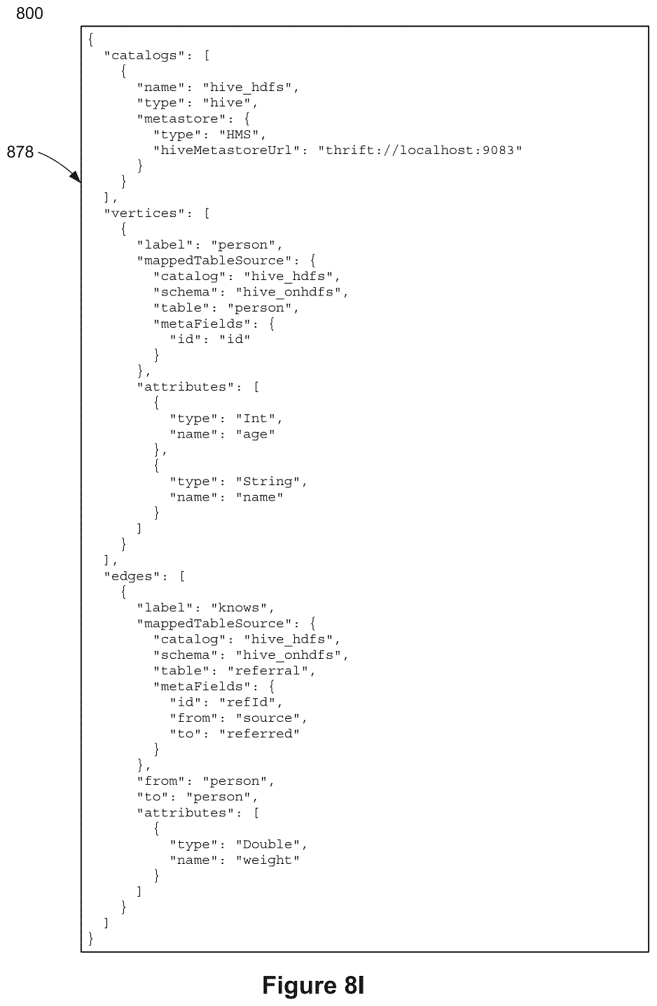

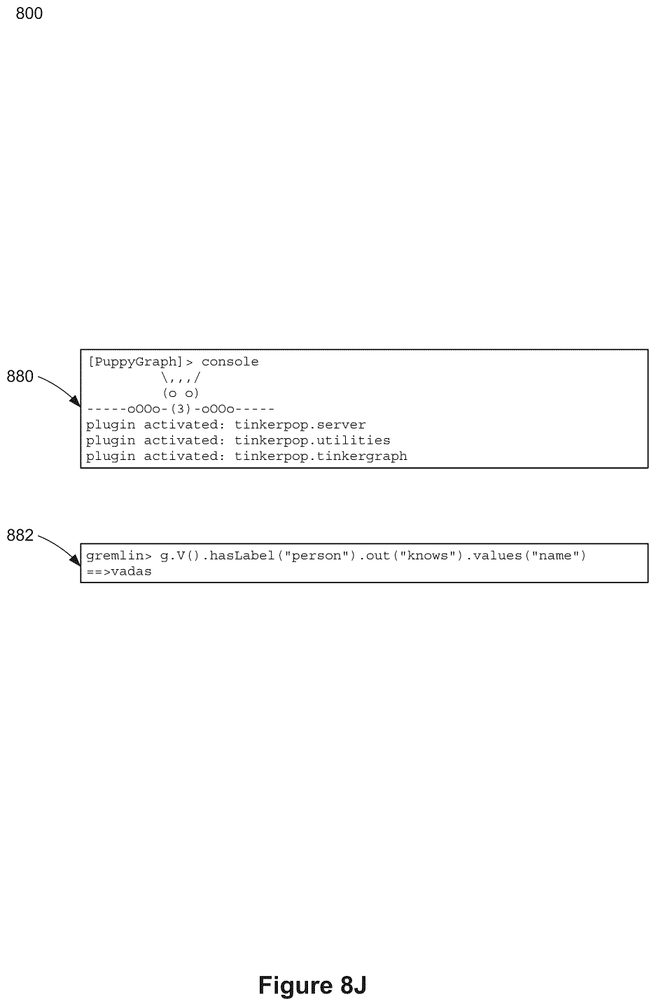

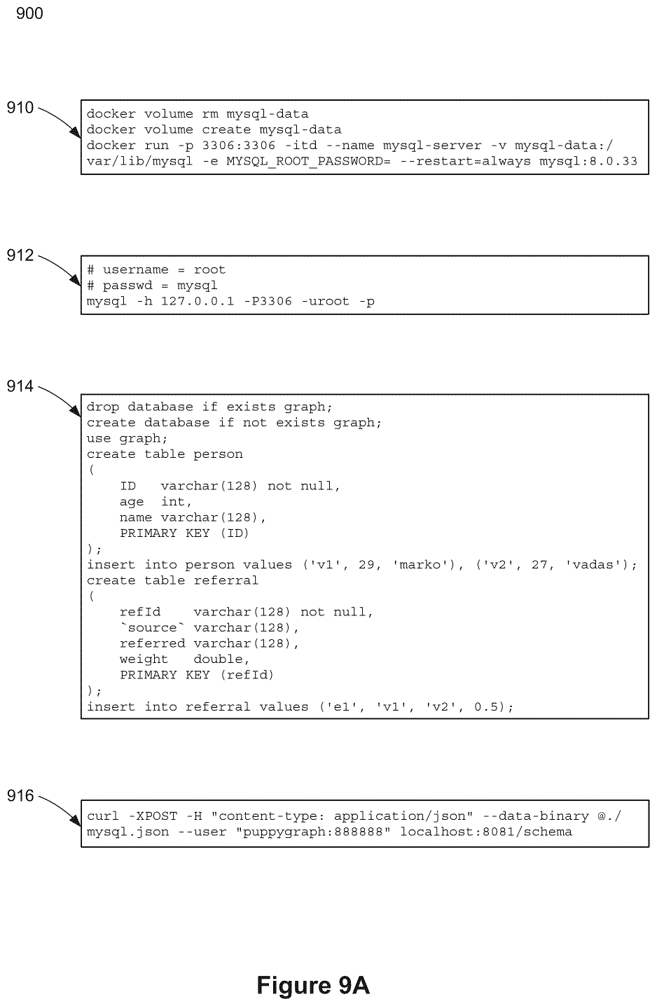

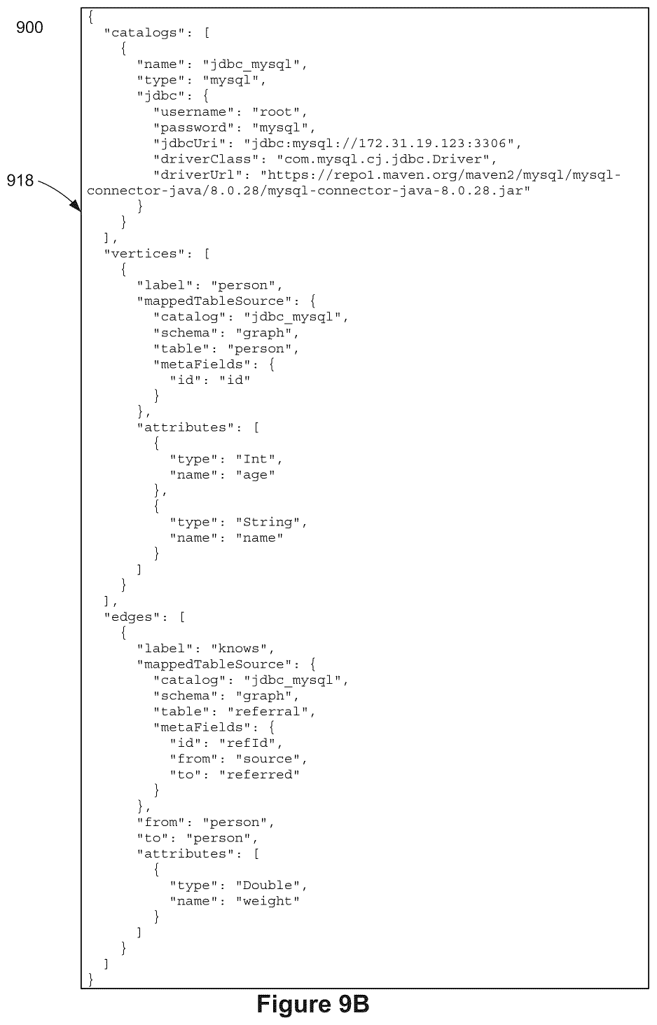

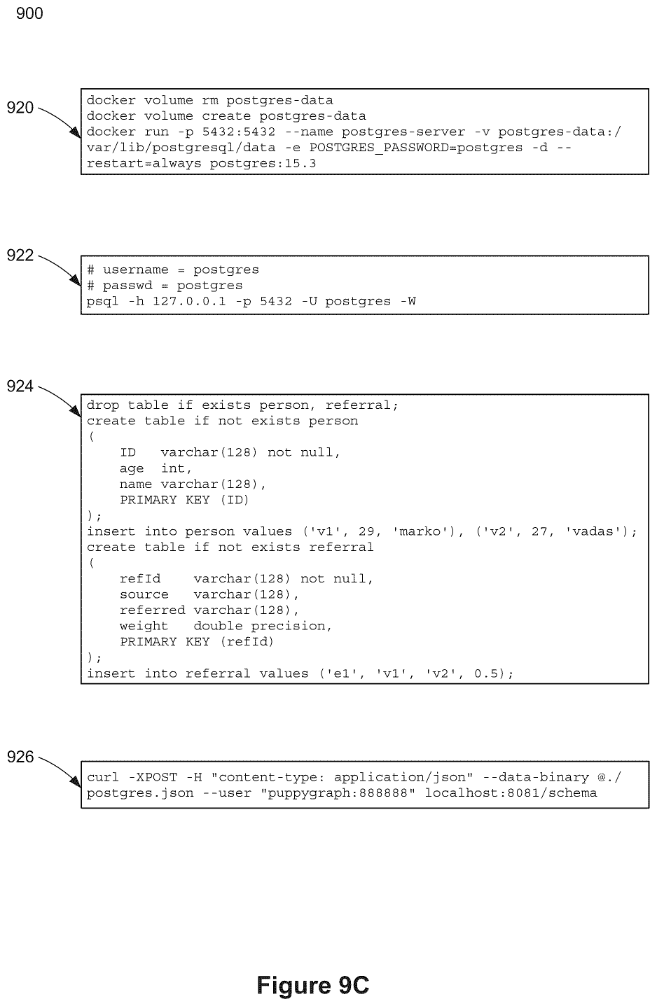

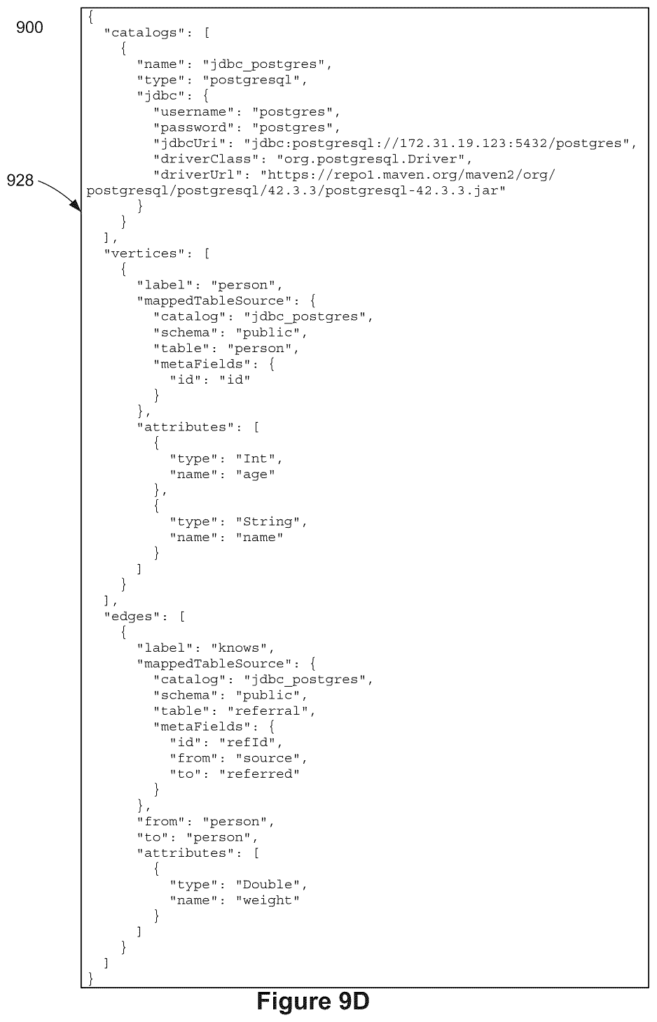

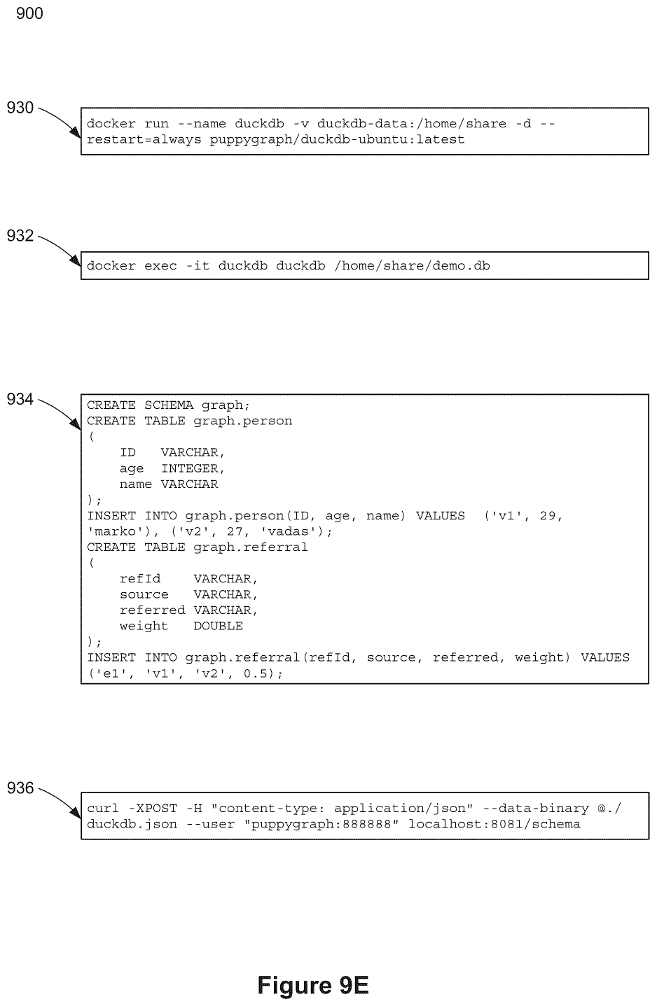

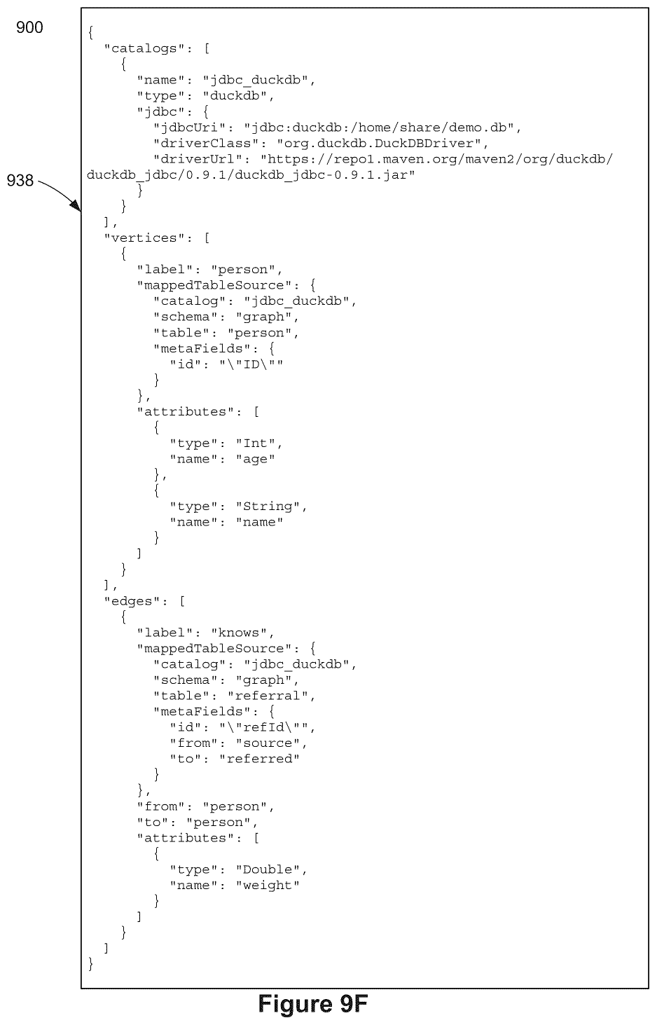

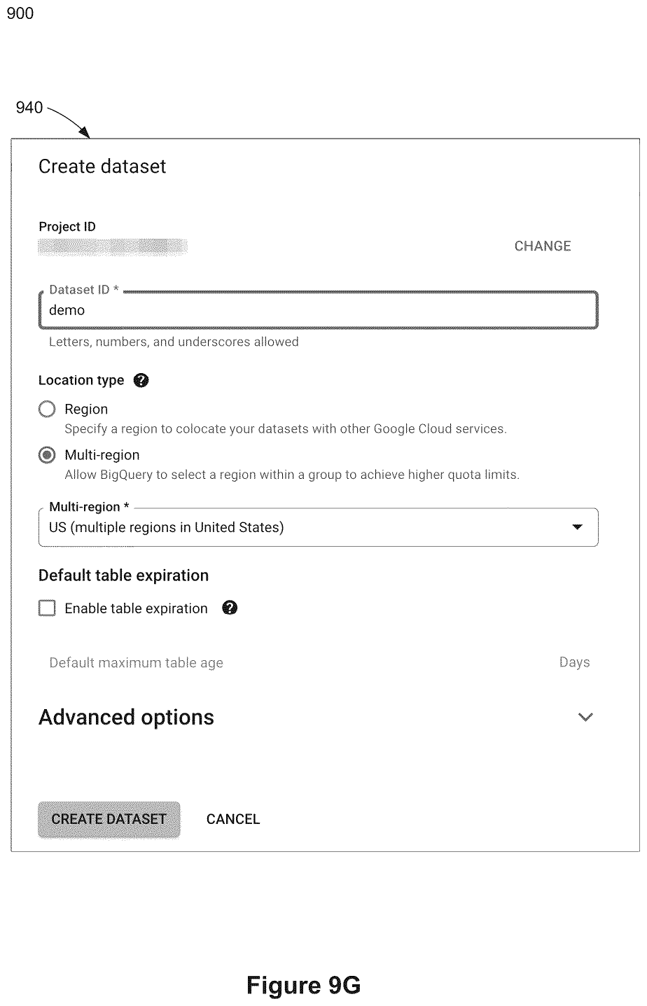

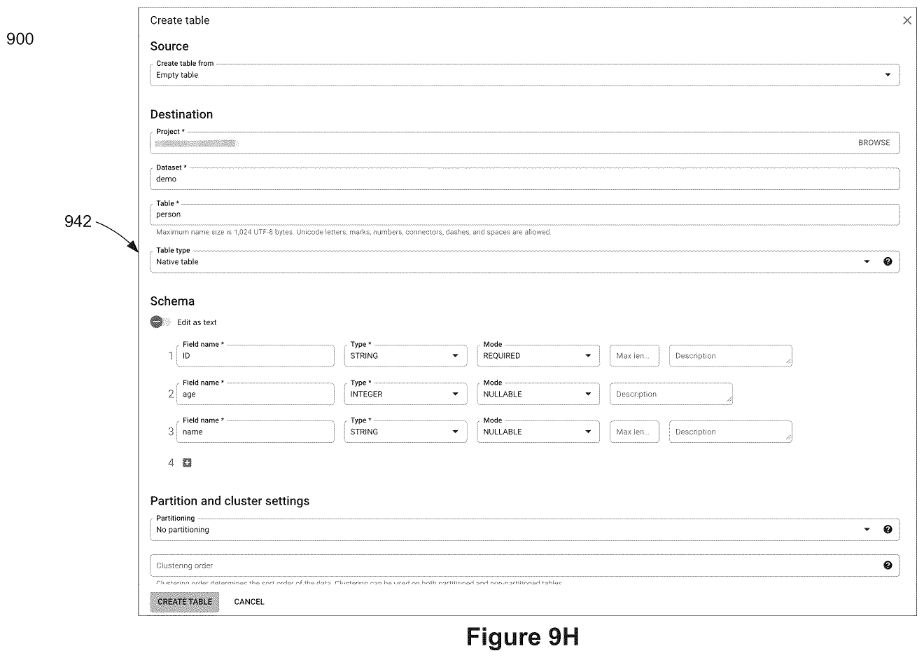

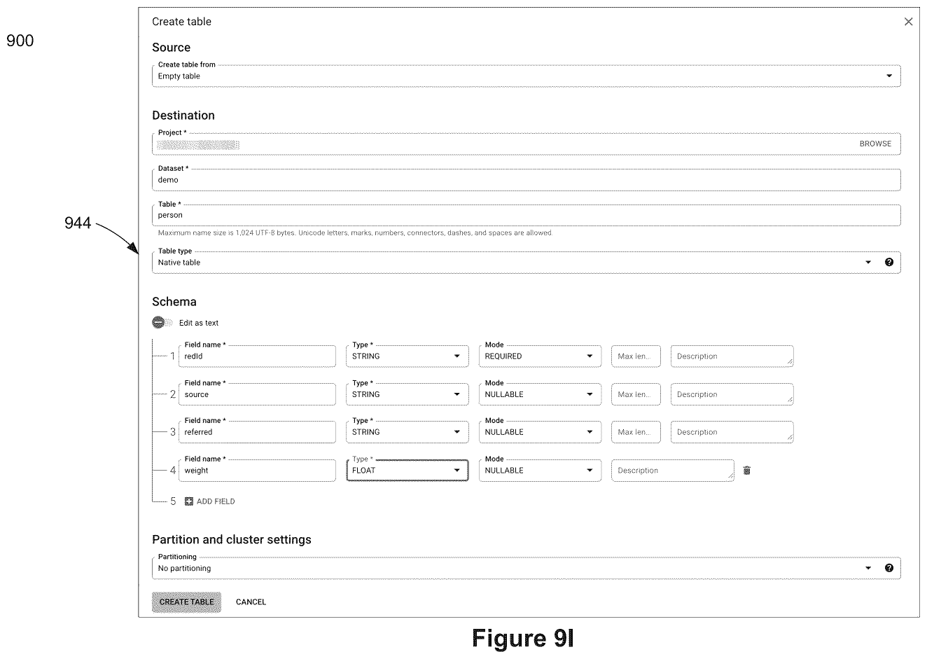

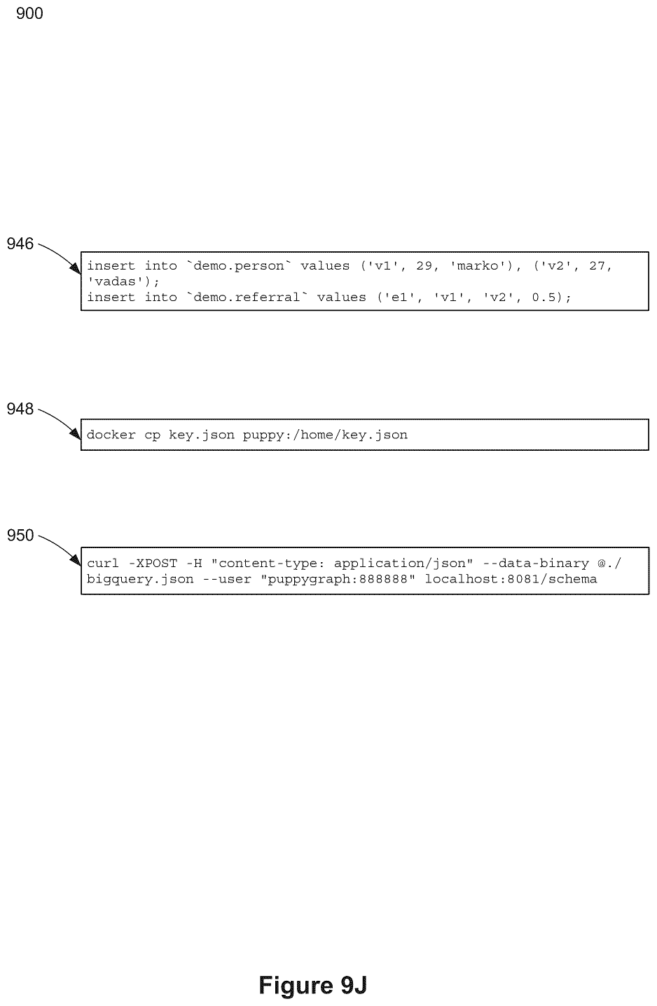

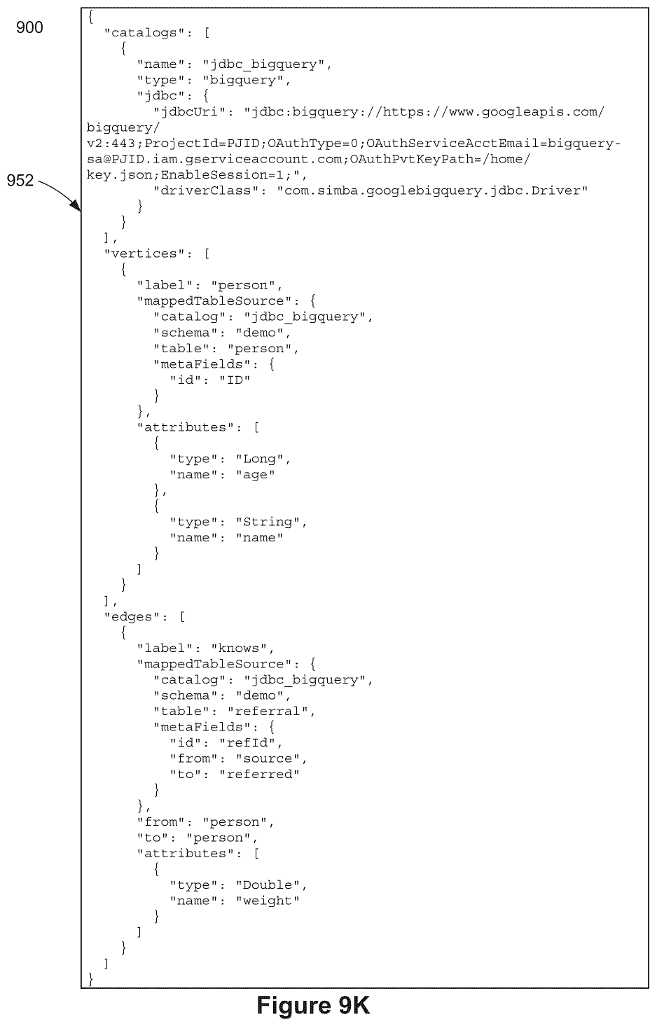

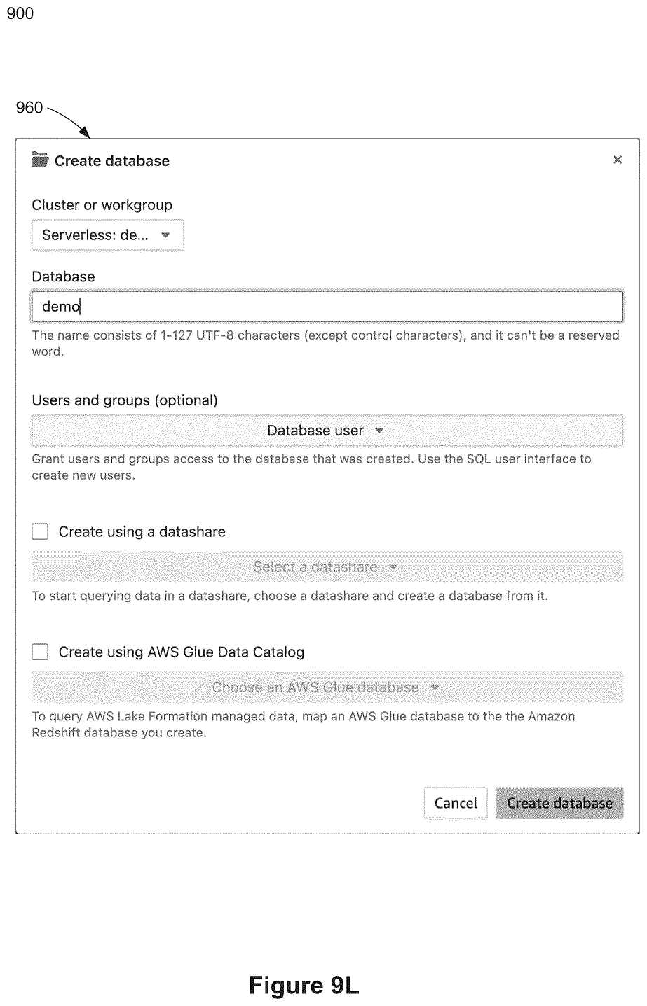

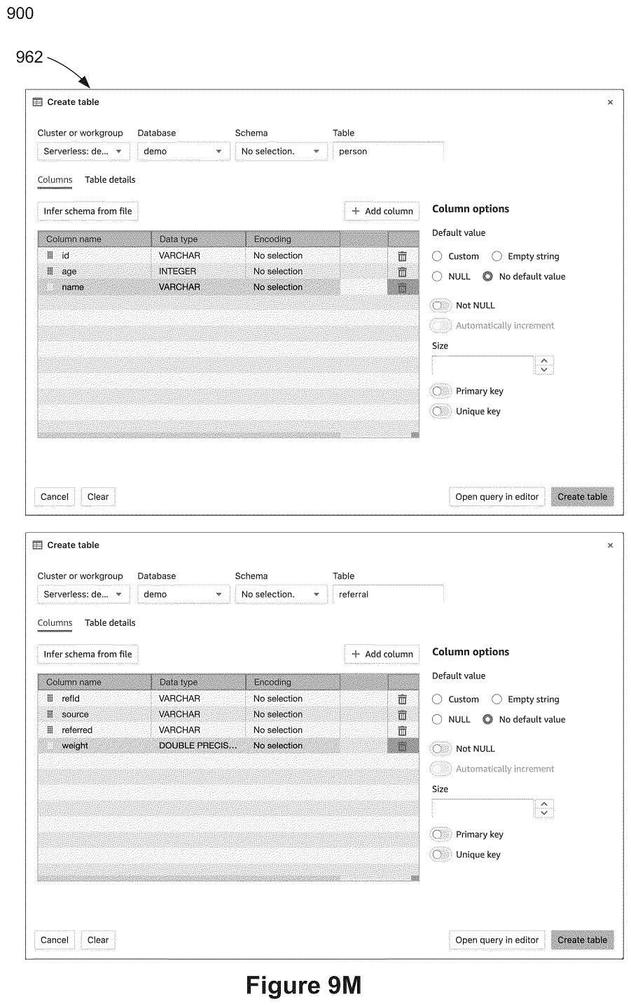

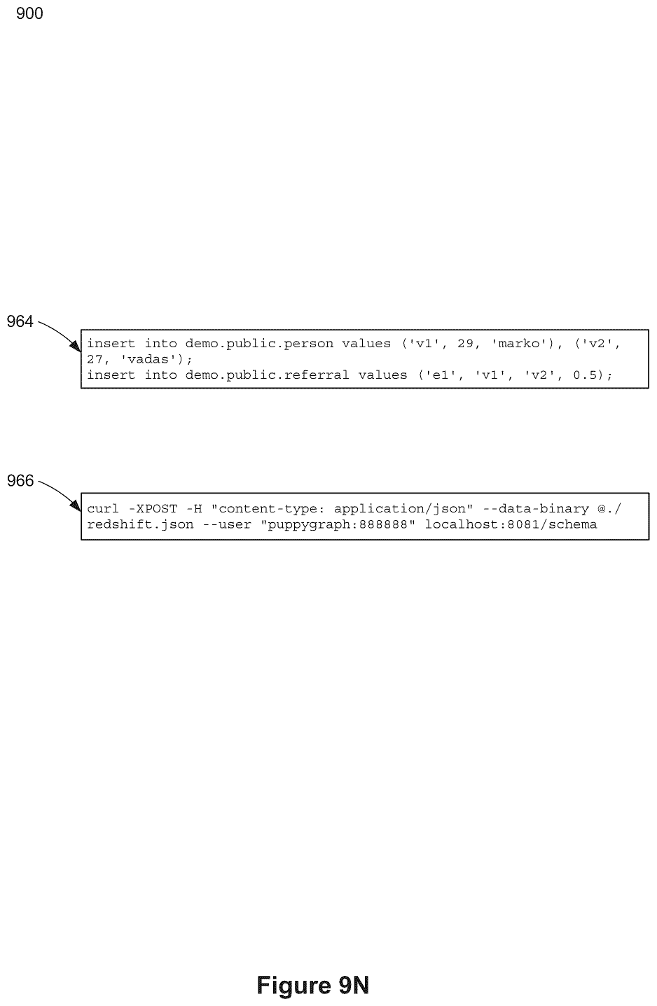

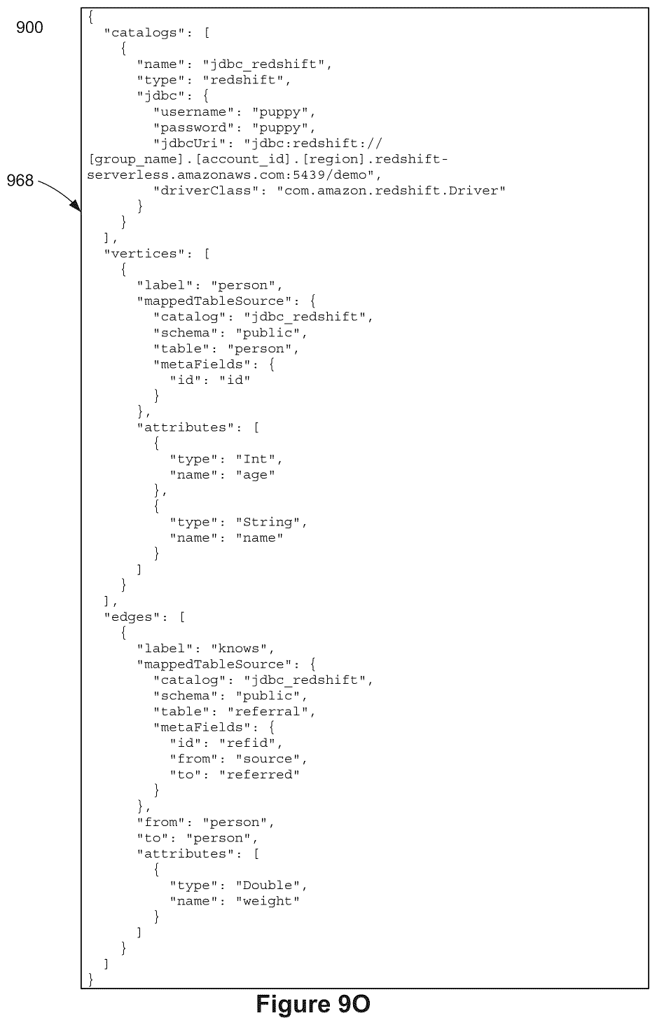

In some embodiments, a to-be-queried database is built in accordance with a data architecture that includes at least one of relational database, data warehouse, data lake, or other forms. For instance, as shown in FIG. 3, the one or more to-be-queried databases 312 include various kinds: Apache Hive 312-1, Apache Iceberg 312-2, Apache Hudi 312-3, Delta Lake 312-4, and MySQL/Postgre SQL 312-5. In another instance, the to-be-queried database is a relational database, e.g., MySQL, PostgreSQL, DuckDB, BigQuery, or Redshift (described below in reference to FIGS. 9A-90). In yet another instance, the to-be-queried database is a data lake, e.g., Apache Iceberg, Apache Hudi, Delta Lake, or Apache Hive (described below in reference to FIGS. 8A-8J).

In some embodiments, a to-be-queried database defines a graph relationship between target entities in a tabular form. For instance, the to-be-queried database stores tabular forms that include the graph relationship of the target entities, e.g., person-knows-person (described below in reference to FIGS. 4A, 7B and 8A).

In some embodiments, a to-be-queried database is compatible with SQL. In particular, the to-be-queried database can be a SQL database. For instance, as shown in FIG. 3, Apache Hive 312-1 is compatible with SQL and MySQL/Postgre SQL 312-5 is a SQL database. The graph analytics engine 302 is configured to traverse Apache Hive 312-1 and MySQL/Postgre SQL 312-5 using the graph query created by the platform 310 through the execution nodes 308-1 and 308-5, respectively.

In some embodiments, a to-be-queried database includes a non-SQL (NoSQL) database.

Data Query with a JSON File

The graph analytics engine includes an auxiliary component for a query (e.g., a non-graph query and/or a graph query). The auxiliary component is a schema that defines a hierarchy of target entities. The hierarchy reflects a graph relationship of the target entities within a to-be-queried database. In particular, the auxiliary component includes vertices and edges that are associated with the to-be-queried database. Each edge links two vertices. After receiving the query (e.g., a graph query), the graph analytics engine is configured to map the query to a logical data plan in accordance with the defined hierarchy of the target entities being stored in the auxiliary component (described above in reference to FIG. 3). In some embodiments, the graph query is received from a platform, e.g., software, network, user interface, open-source project (described above in reference to FIG. 3).

Specifically, to create the auxiliary component for querying a tabular to-be-queried database, a user first obtains table catalogs, table schemas, and table attributes, based on a graph relationship between target entities within the tabular to-be-queried database. Next, the user defines vertices and edges in the form of arrays based on the table catalogs, table schemas, and table attributes, where each edge links two vertices. The vertices and edges reflect a hierarchy of the target entities within the tabular to-be-queried database, and include information of the table catalogs, table schemas, and table attributes. Then, the user generates the auxiliary component based on the vertices and edges in the form of arrays.

FIGS. 4A-4C illustrate an example transaction trace graph query 400 based on the graph analytics engine for a to-be-queried tabular database 401, in accordance with some embodiments. The example transaction trace graph query 400 is to obtain whom a User 00001 transfers to through a one-hop route or a two-hop route. More details of graph analytics engine architectures are described above in references to FIGS. 1-3. When querying transaction traces, a user first generates a JavaScript Object Notation (JSON) file 450 in accordance with graph relationships between target entities within the to-be-queried tabular database 401. Next, the user creates a graph query script (e.g., graph query statements) written in a graph query language. Then, the user queries the to-be-queried tabular database 401 using the JSON file 450 and the graph query script via the graph analytics engine.

FIG. 4A illustrates the to-be-queried tabular database 401 for transactions traces. The to-be-queried tabular database 401 includes three catalogs: a UserProfile catalog 402, an Account catalog 404, and a Transaction catalog 406. Specifically, the UserProfile catalog 402 includes (i) three records corresponding to three users (e.g., Users 00001, 00002, and 00003), and (ii) eight attributes (e.g., UserId, FirstName, LastName, Address, ZipCode, Gender, PhoneNumber, and Birthday). The Account catalog 404 includes (i) six records corresponding to six accounts (e.g., Accounts 0000001, 0000002, 0000003, 0000004, 0000005, and 0000006), and (ii) six attributes (e.g., AccountNumber, Balance, CreatedDate, User, BranchName, and AccountAgent). The Transaction catalog 406 includes (i) five records corresponding to five transactions (e.g., Transactions 0000000001, 0000000002, 0000000003, 0000000004, 0000000005), and (ii) six attributes (e.g., TransactionId, SenderAccount, ReceiverAccount, TransactionTimestamp, and Amount). The three catalogs 402, 404, and 406 are stored in a tabular format.

FIG. 4B illustrates the JSON file 450 associated with the to-be-queried tabular database 401 for transactions traces. The JSON file 450 for transaction traces defines a hierarchy of the target entities. As discussed, the example transaction trace graph query 400 is to obtain whom a User 00001 transfers to through a one-hop route or a two-hop route. As a result, the target entities of the example transaction trace graph query 400 can include several attributes of the UserProfile catalog 402 (e.g., UserId, Address, and Birthday), several attributes of the Account catalog 404 (e.g., AccountNumber and User), and several attributes of the Transaction catalog 406 (e.g., TransactionId, SenderAccount ReceiverAccount, and Amount). In particular, the JSON file 450 includes a “vertices” array 452 that defines vertices and a “edges” array 454 that defines edges. The “vertices” array 452 includes an “user” object 456 and an “account” object 458. The “user” object 456 further includes respective attributes (e.g., “User Id,” “Address,” “Birthday,” and “User”) listed in the catalogs 402, 404, and 406. Similarly, the “account” object 458 further includes respective attributes (e.g., “AccountNumber”) listed in the catalogs 402, 404, and 406. On the other hand, the “edges” array 454 includes an “user has account” object 460 and an “transaction” object 462. The “user has account” object 460 further includes attributes (e.g., “User” and “AccountNumber”) listed in the catalogs 402, 404, and 406. Similarly, the “transaction” object 462 further includes attributes (e.g., “TransactionId,” “SenderAccount,” “ReceiverAccount,”, and “Amount”) listed in the catalogs 402, 404, and 406.

FIG. 4C illustrates example graph query statements 480 and 482 for transaction traces. The example graph query statement 480 and the example graph query statement 482 are to obtain whom a User 00001 transfers to through a one-hop route and a two-hop route, respectively.

In the example graph query statement 480, a step of .hasLabel(“user”) obtains a first set of vertices with a label of “user” (e.g., the “user” object 456), and a step of .hasId(“00001”) further filters the first set of vertices to obtain a second set of vertices that includes a specified “UserId” of “00001.” Next, .out(“user has account”) traverses edges with a label of “user has account” (e.g., the “user has account” object 460) from the second set of vertices and reach a third set of vertices through the edges with the label of “user has account.” Then, a step of .out(“transaction”) continues to traverse edges with the label of “transaction” from the third set of vertices and reach a fourth set of vertices through the edges with the label of “transaction.”

The example graph query statement 482 is similar to the example graph query statement 480, except that the example graph query statement 482 includes a step of .repeat and with .time(2). The step of .repeat repeats .out(“transaction”) twice by traversing one level deeper from the fourth set of vertices.

In some embodiments, traversing a to-be-queried database using a query through the graph analytics engine includes obtaining catalogs, schemas, and attributes, based on a graph relationship between target entities. Traversing the to-be-queried database using the query through the graph analytics engine includes defining a plurality of vertices and a plurality of edges in form of arrays, based on the catalogs, schemas, and attributes. Traversing the to-be-queried database using the query through the graph analytics engine further includes generating an auxiliary component, based on the plurality of vertices and the plurality of edges. For instance, as shown in FIGS. 4A-4B, the user obtains the table catalogs, table schemas, and table attributes from the to-be-queried tabular database 401 and defines the vertices 452 and edges 454 in the form of arrays. The user further generates the JSON file 450 based on the vertices 452 and edges 454.

In some embodiments, an auxiliary component is a human-readable file. For instance, as shown in FIG. 4B, the JSON file 450 is a human-readable file. Further, in some embodiments, the human-readable file is in a standard text-based format, including at least one of JavaScript Object Notation (JSON), Human-Optimized Config Object Notation (HOCON), Extensible Markup Language (XML), or other forms.

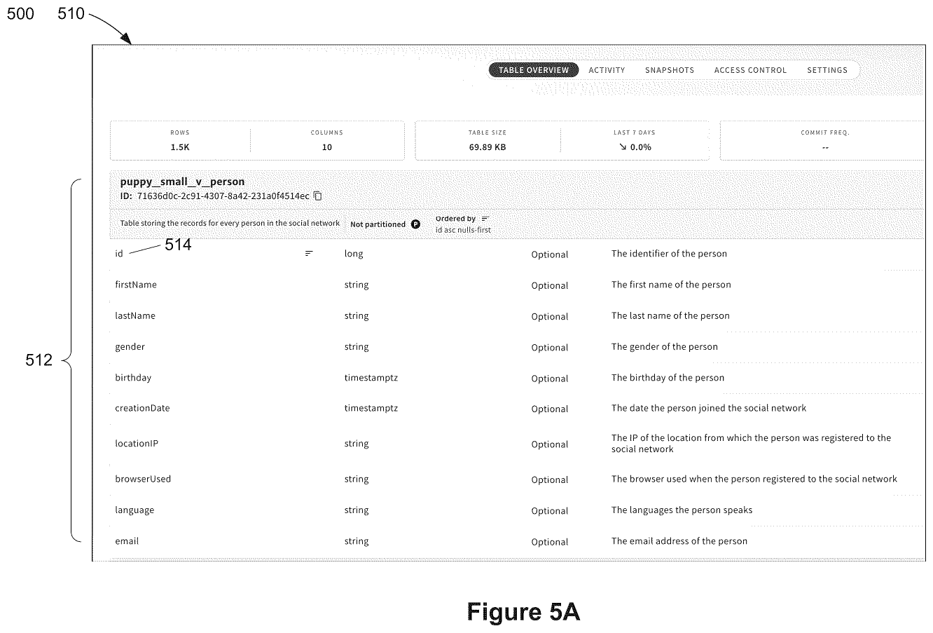

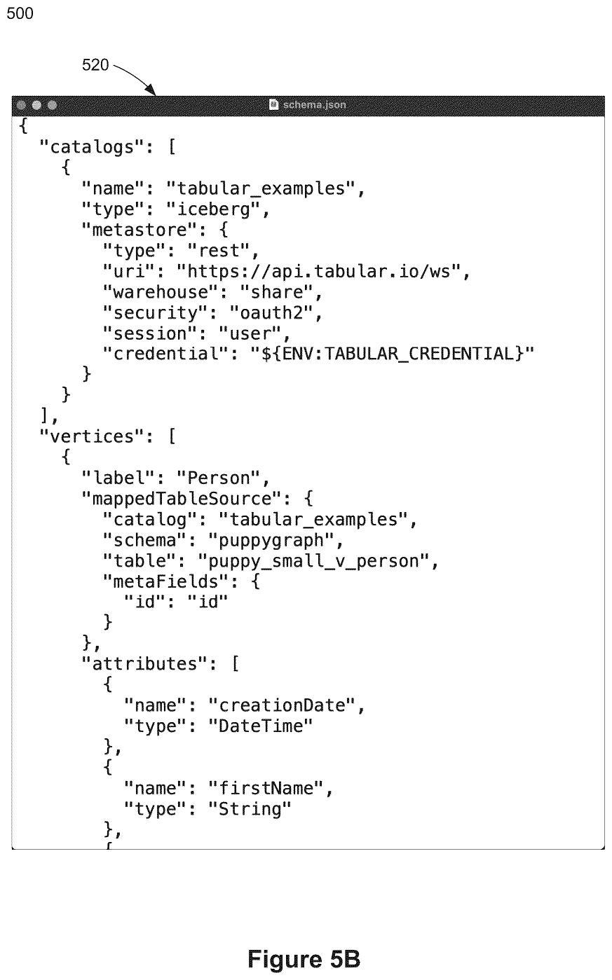

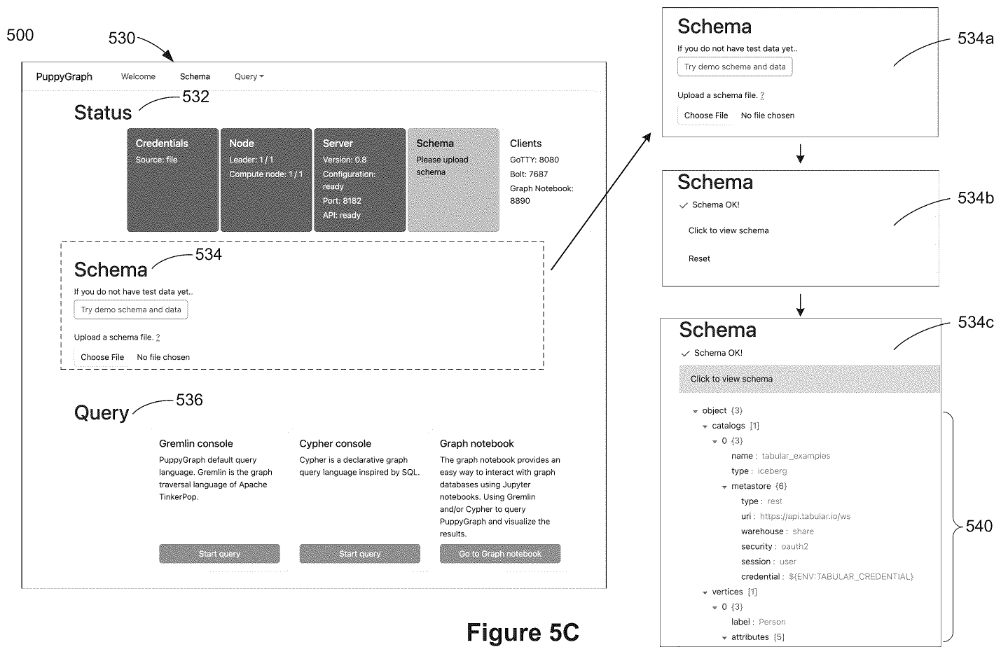

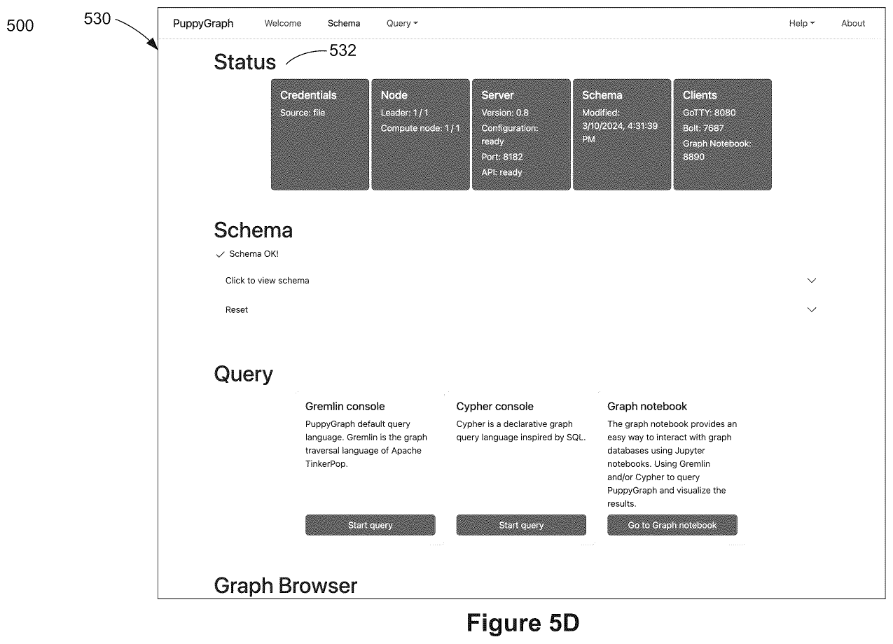

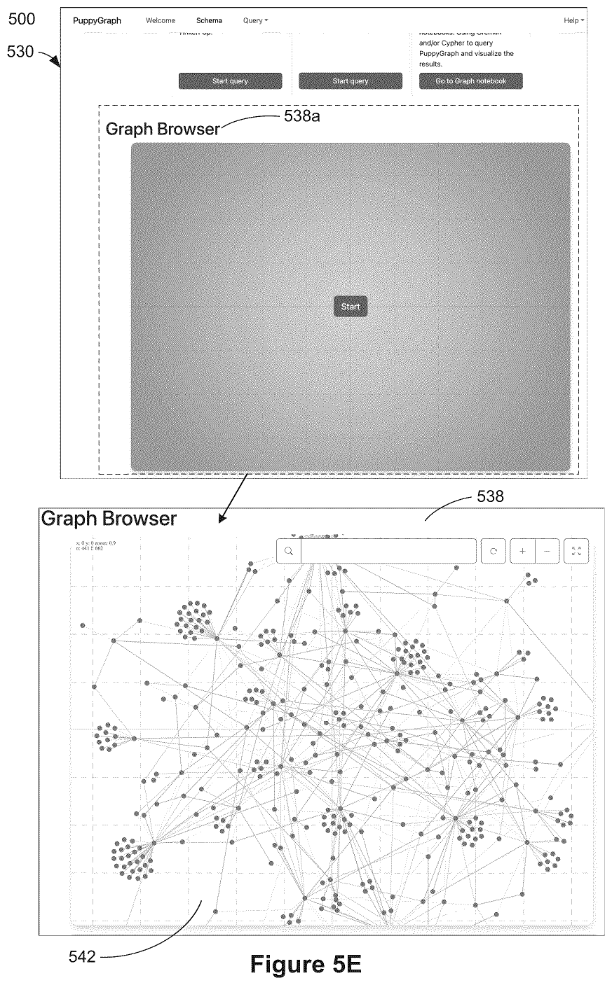

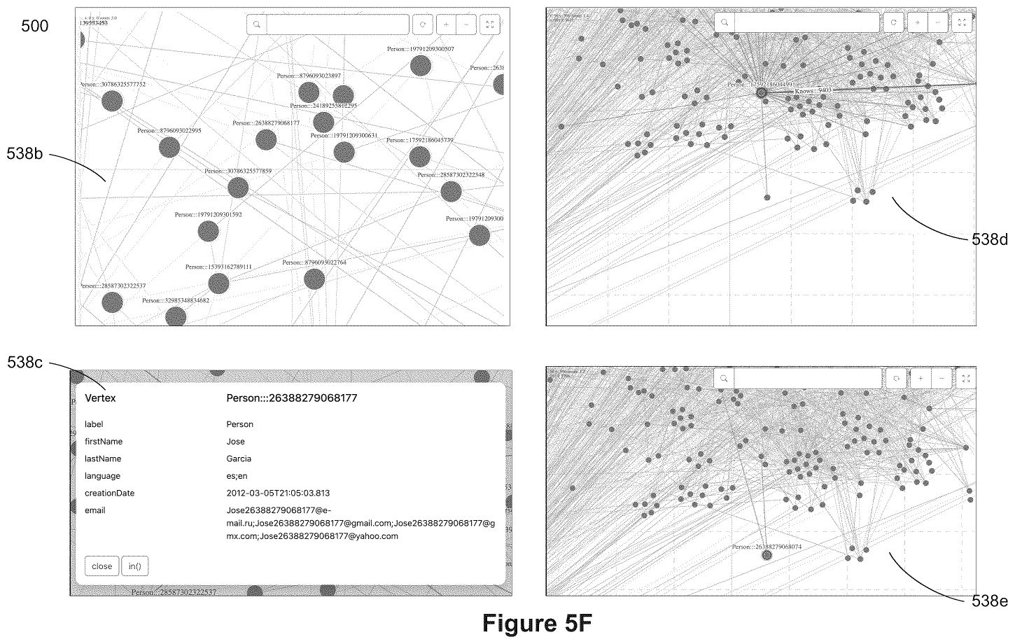

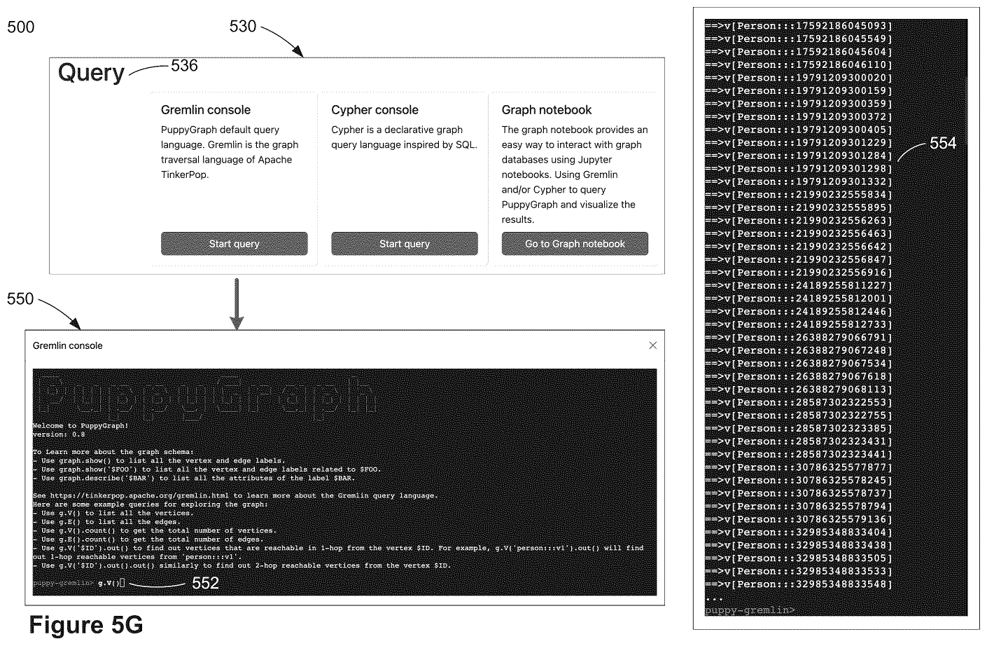

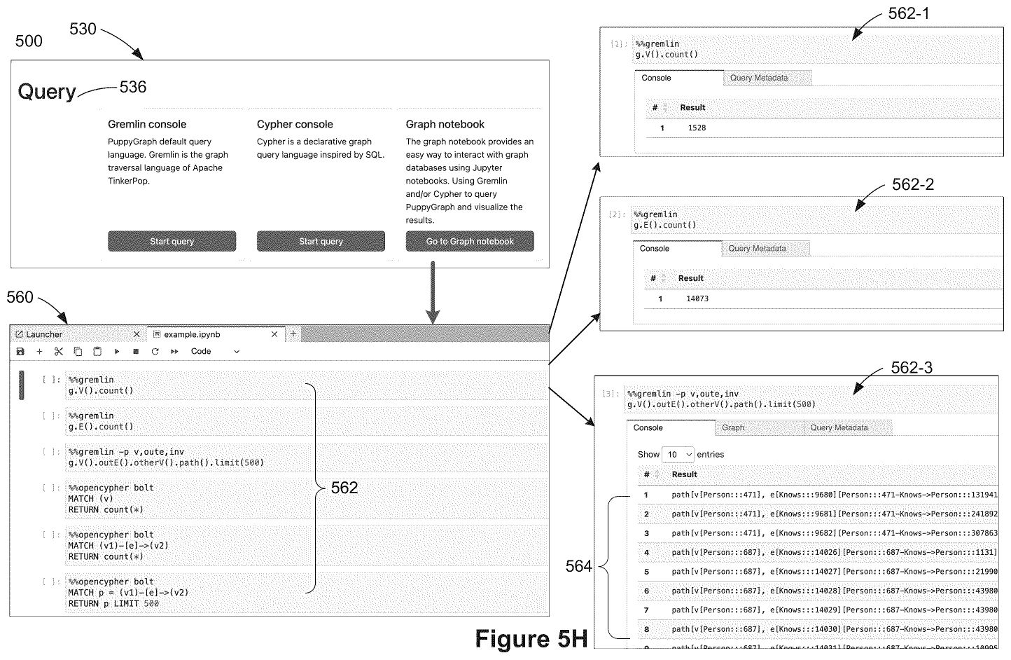

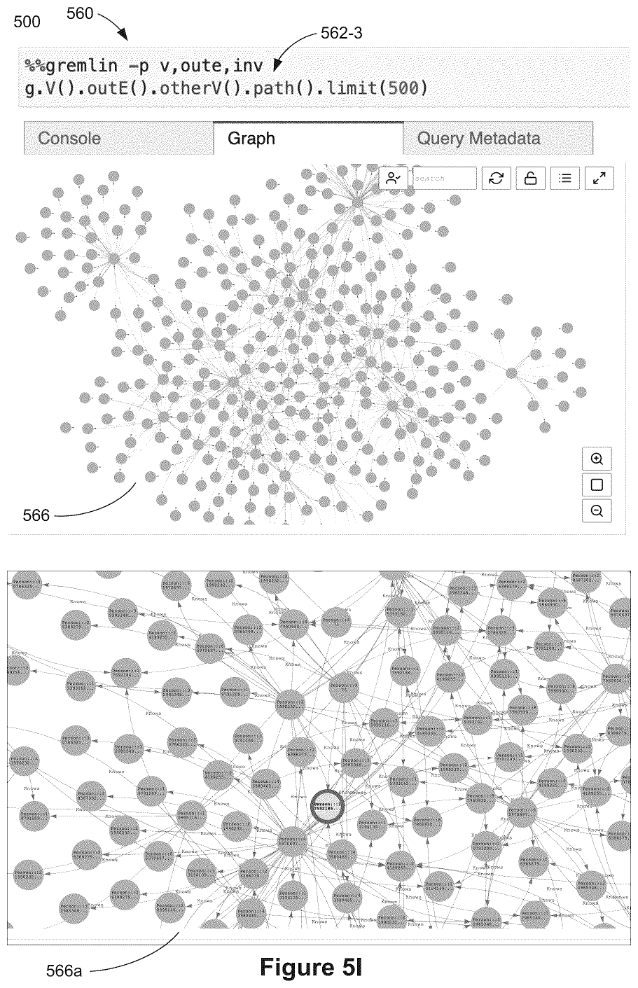

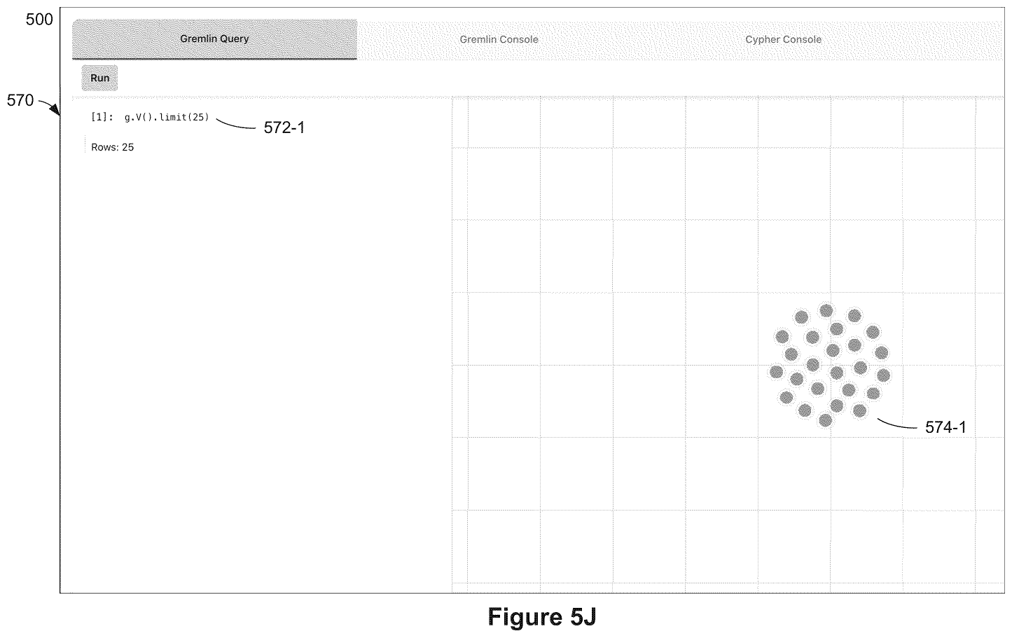

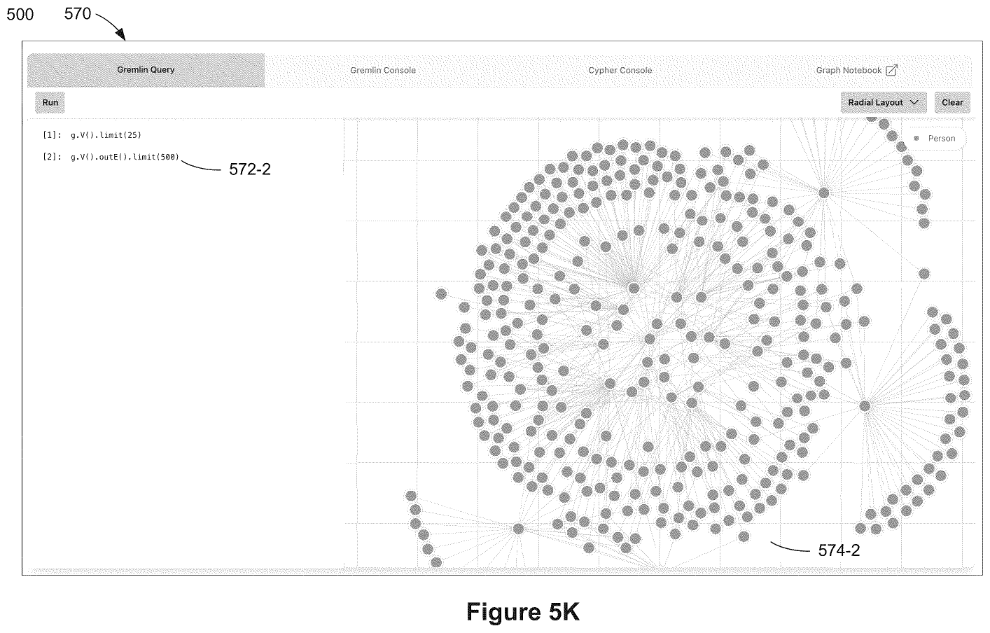

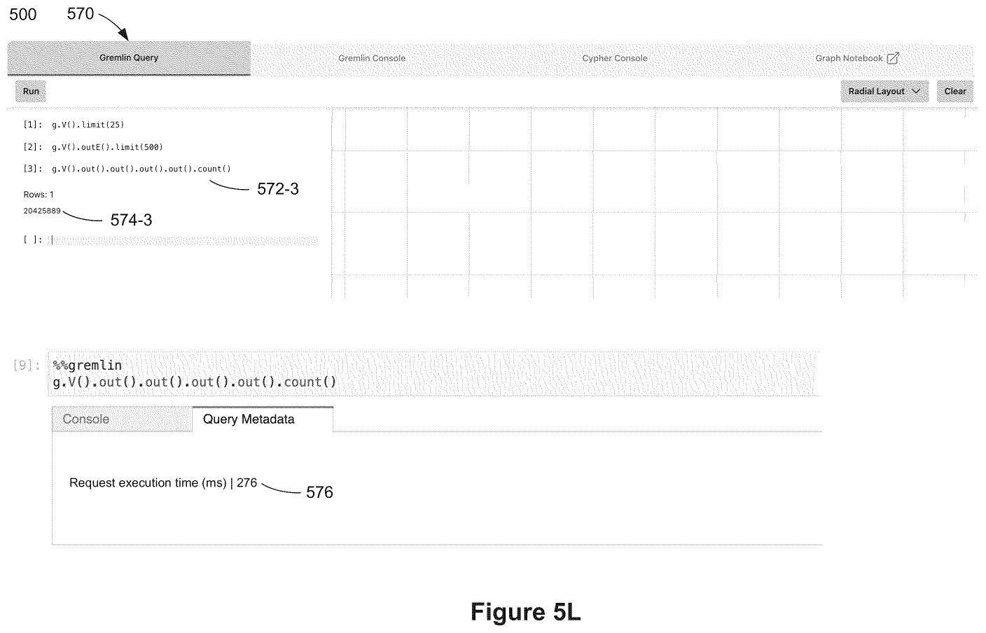

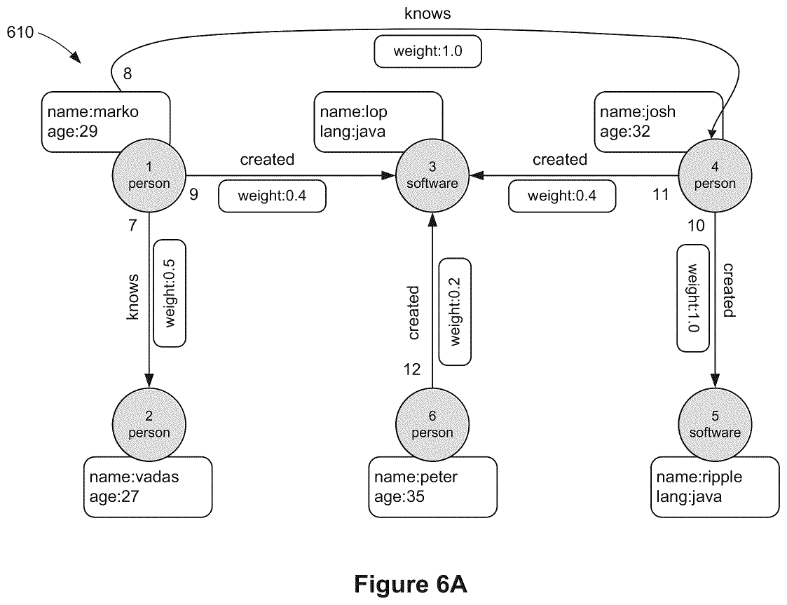

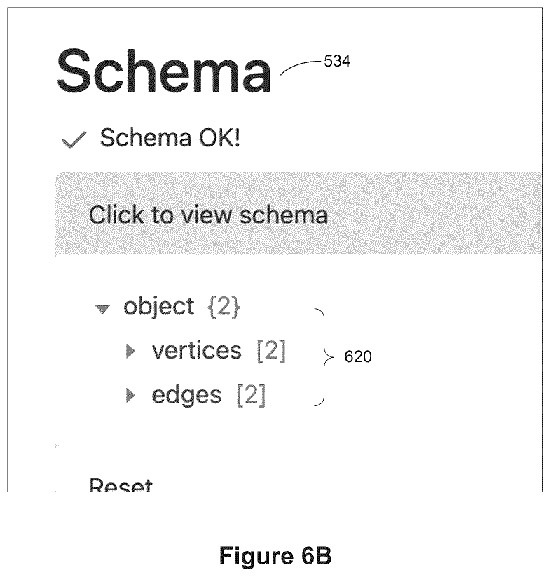

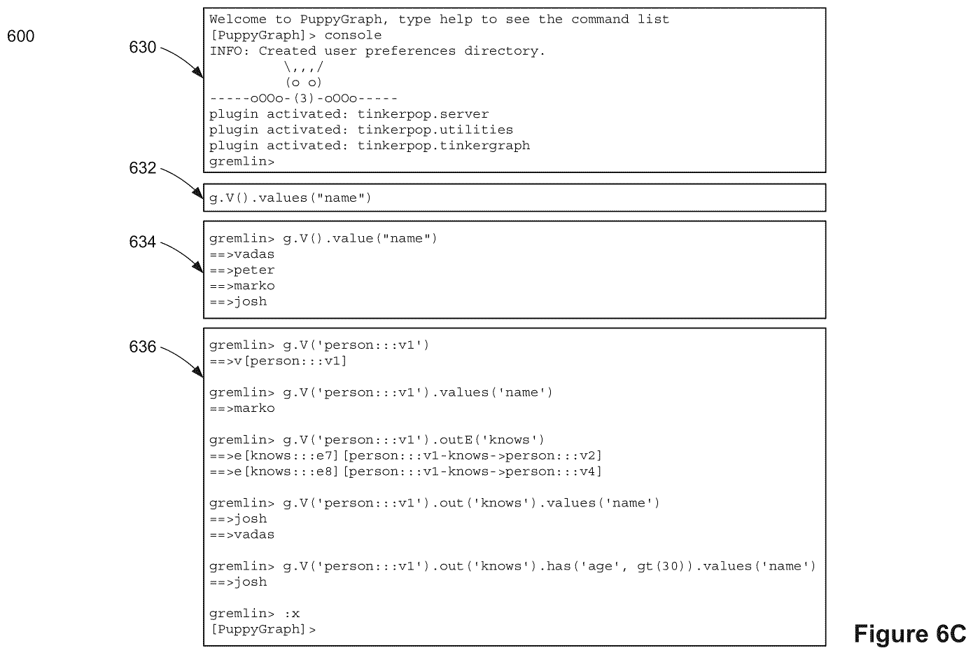

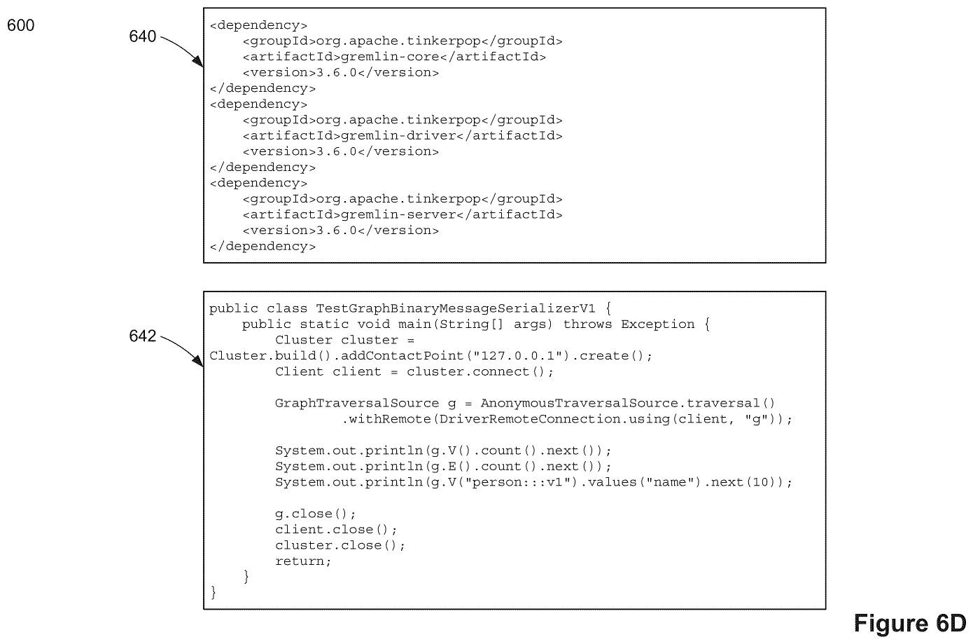

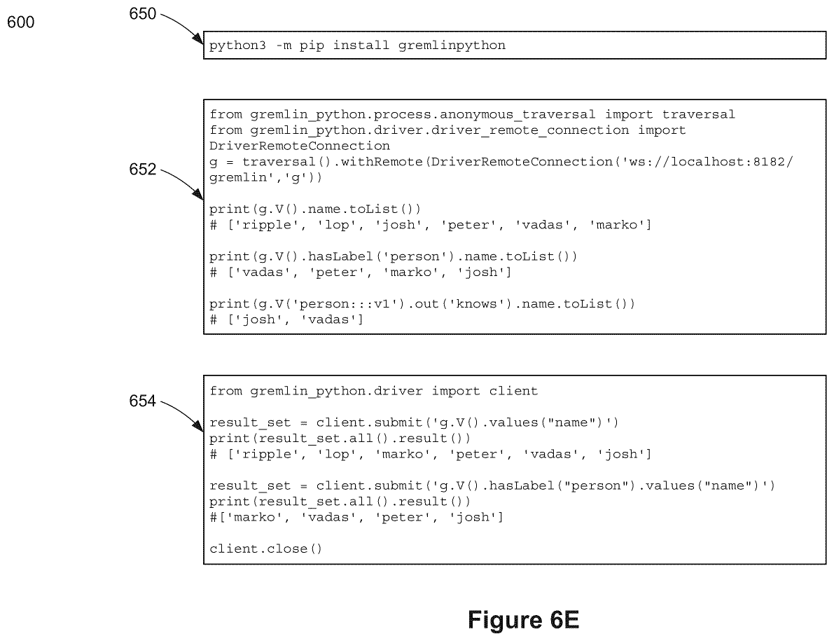

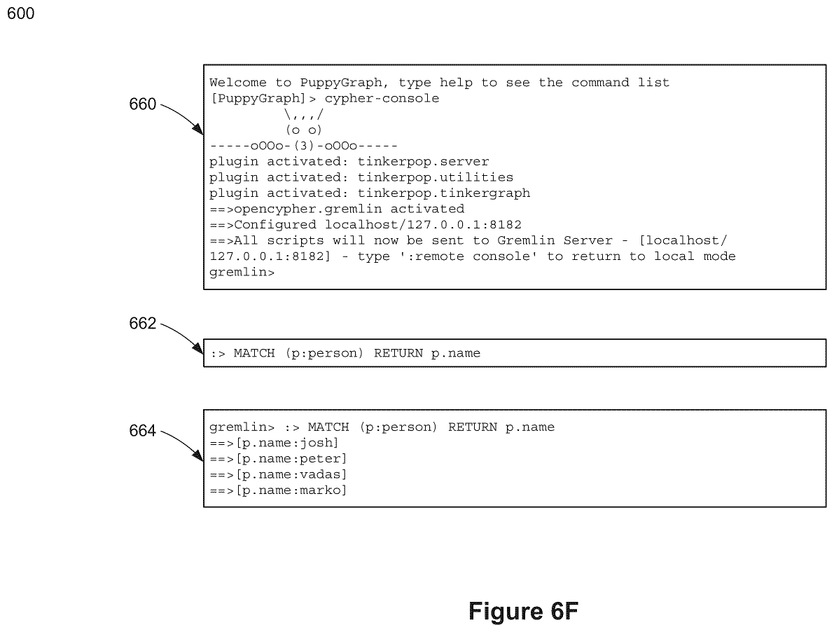

In some embodiments, a respective edge linking two adjacent vertices of a plurality of vertices is directed or undirected. The respective edge that is directed represents an asymmetric relation between the two adjacent vertices, while the respective edge that is undirected represents a symmetric relation between two adjacent vertices. For instance, as shown in the Transaction catalog 406 of FIG. 4A, edges associated with transactions between accounts can be directed (e.g., the first record of the Transaction catalog 406 shows a transaction from a SenderAccount of 0000001 to a ReceiverAccount 0000002). In another instance, edges associated with a scenario that person knows person can be undirected (described below in reference to FIGS. 5A-5L). Further, in some embodiments, the respective edge linking two adjacent vertices of the plurality of vertices includes a weight component. For instance, a query can be defined to find paths along respective edges with a certain sum of weights or a largest sum of weights (described below in reference to FIG. 6A).

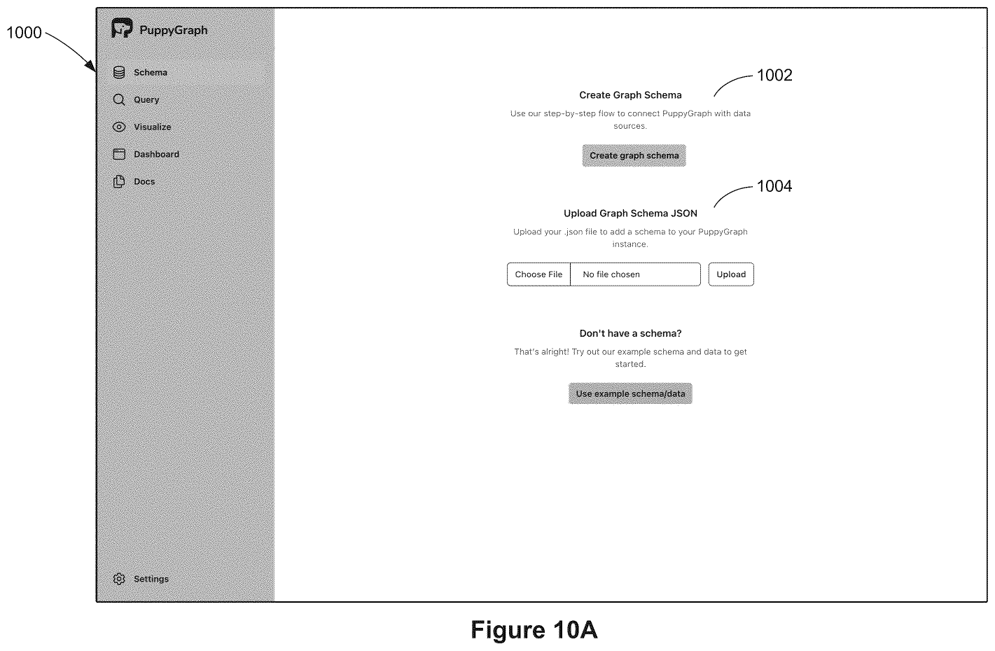

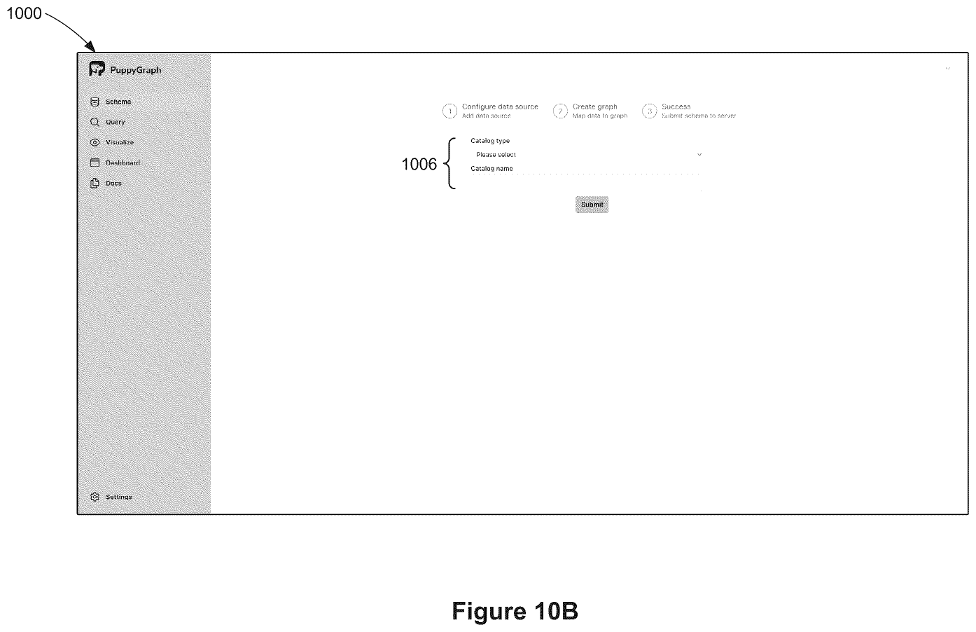

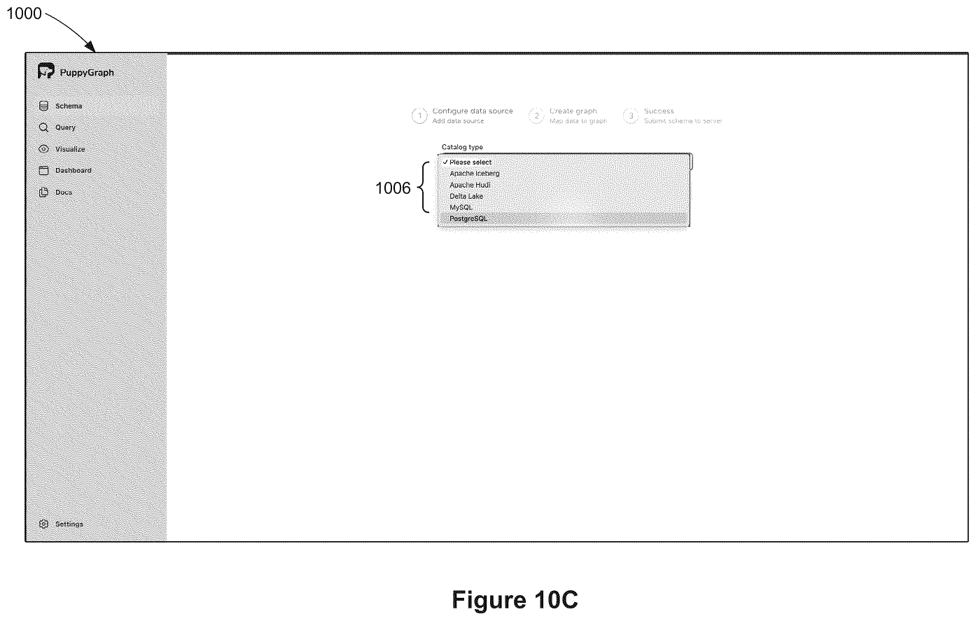

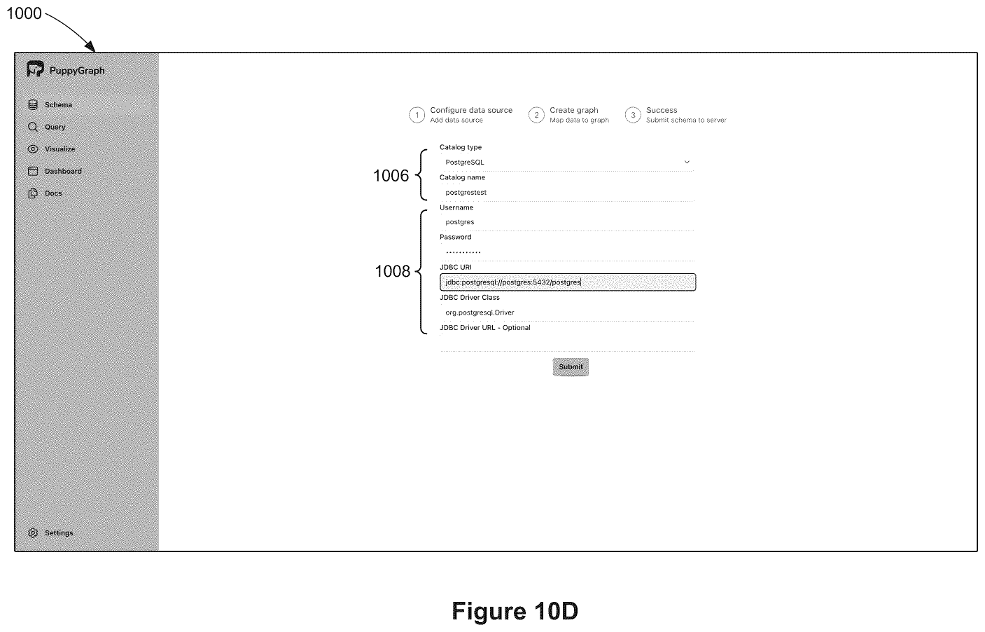

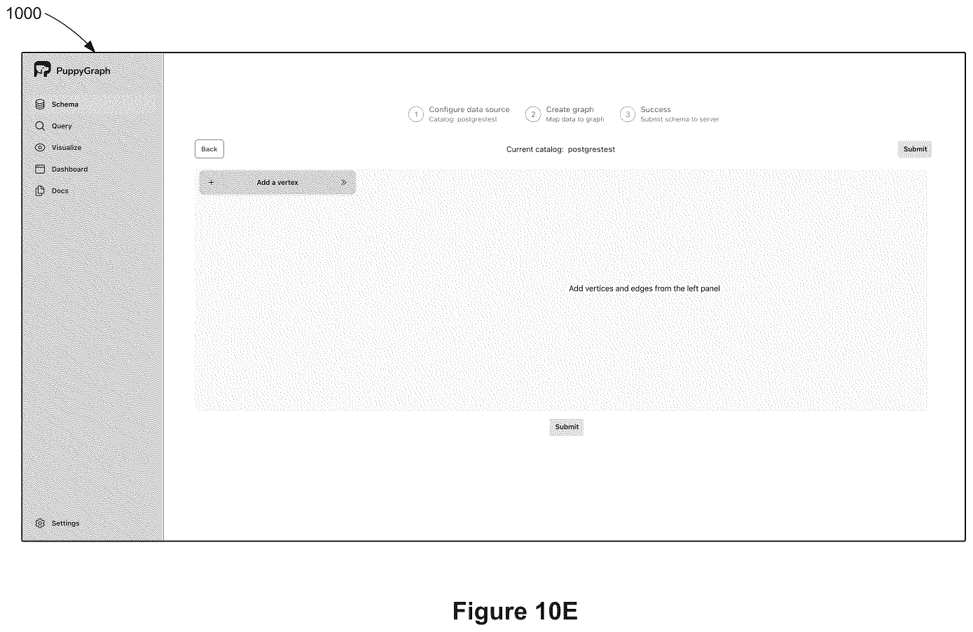

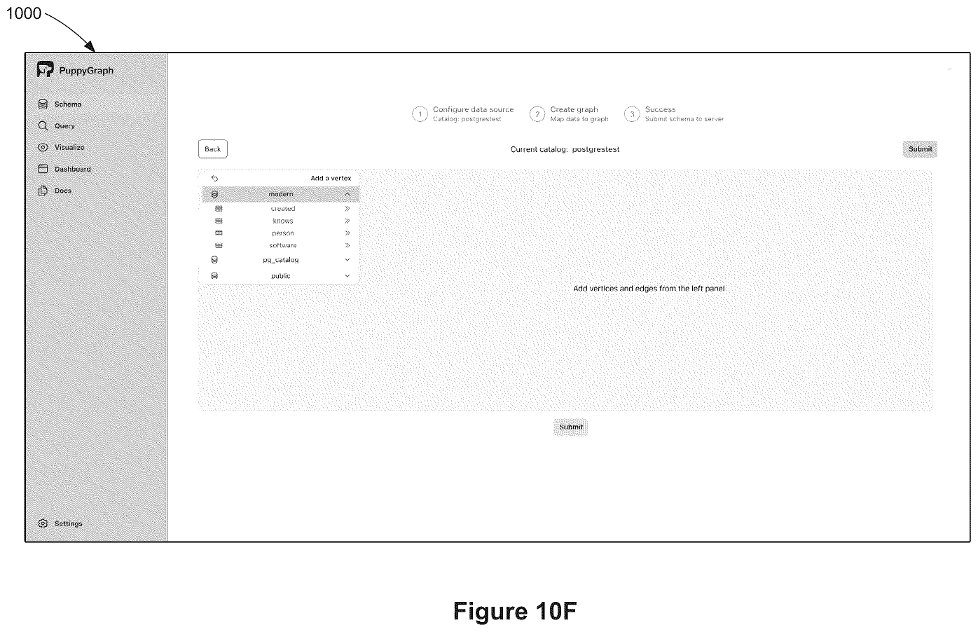

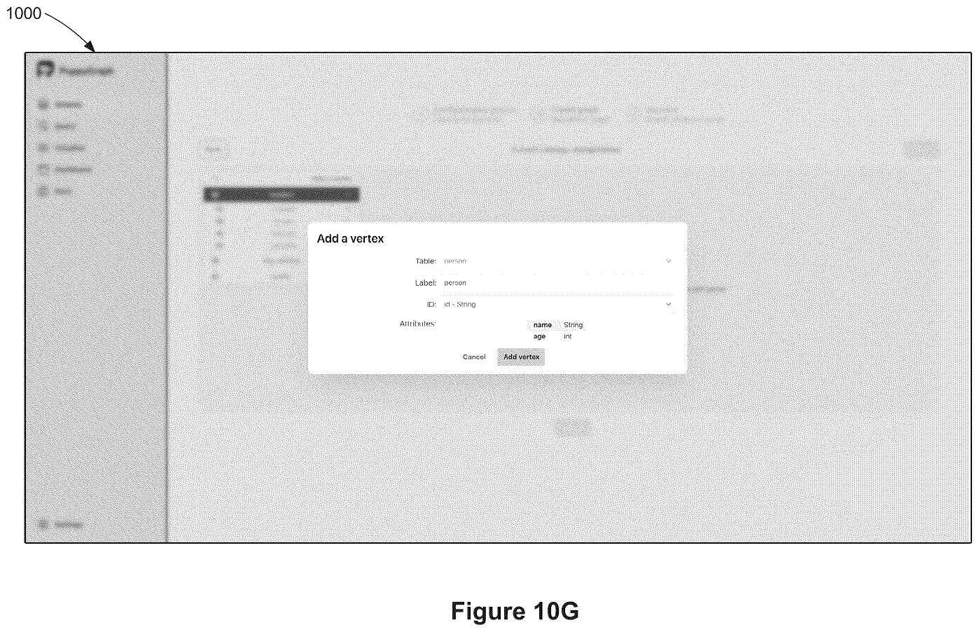

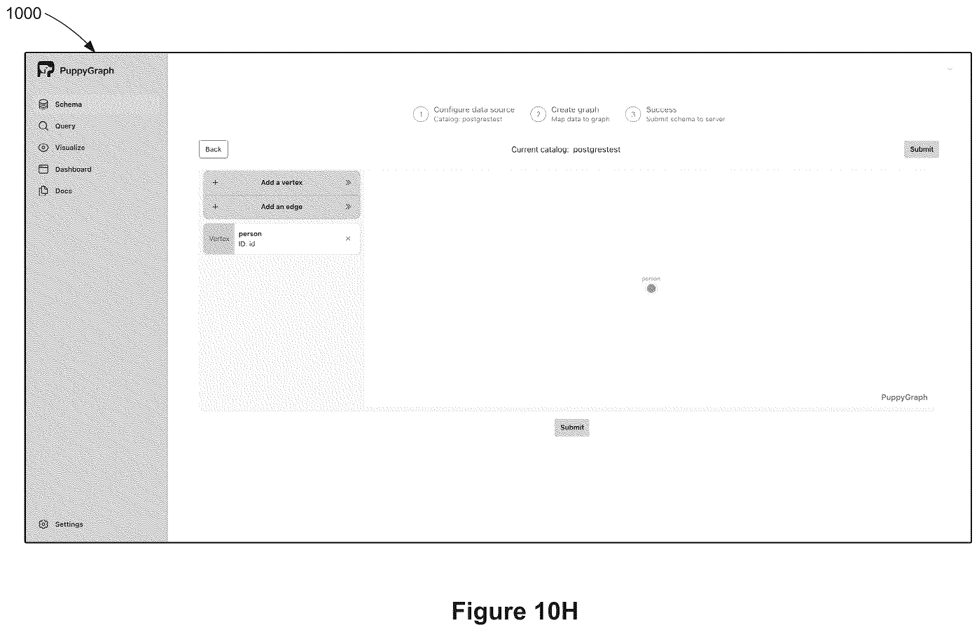

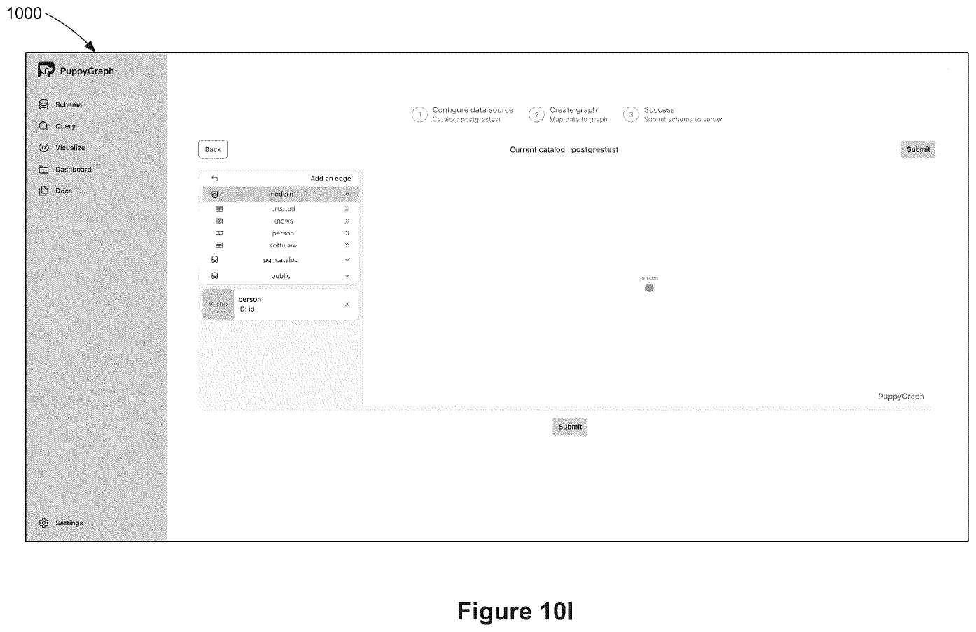

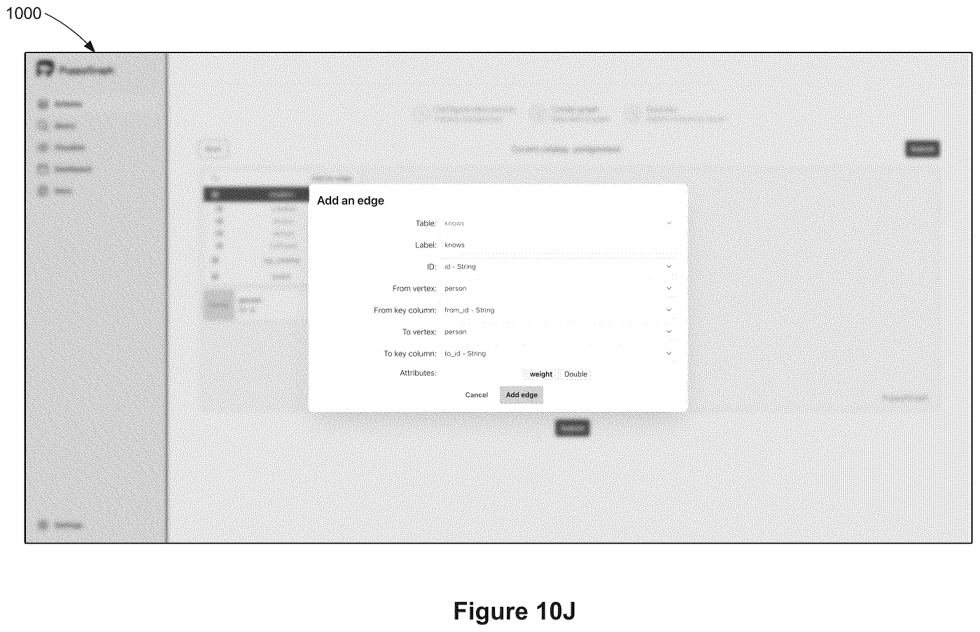

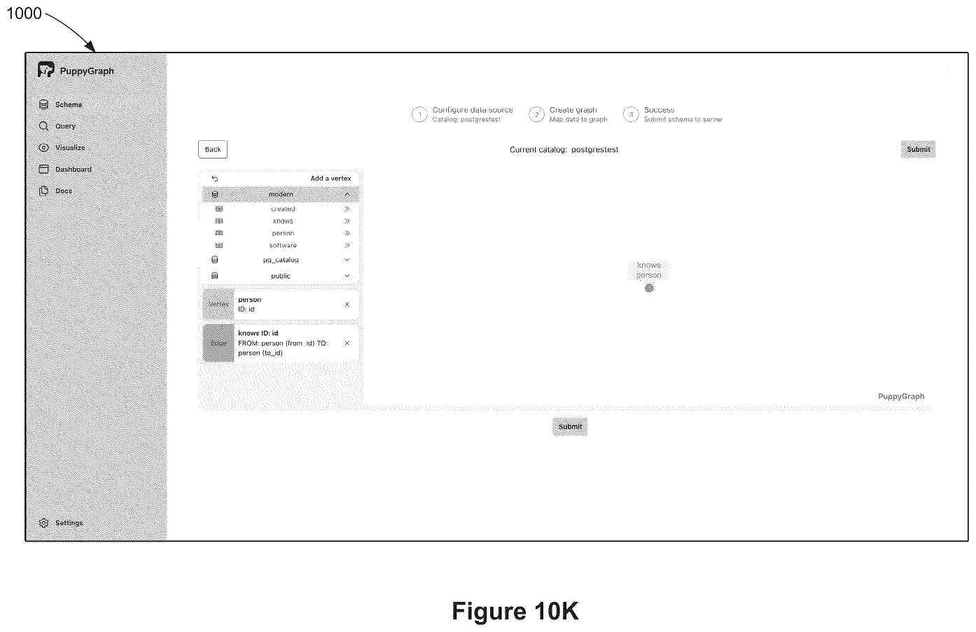

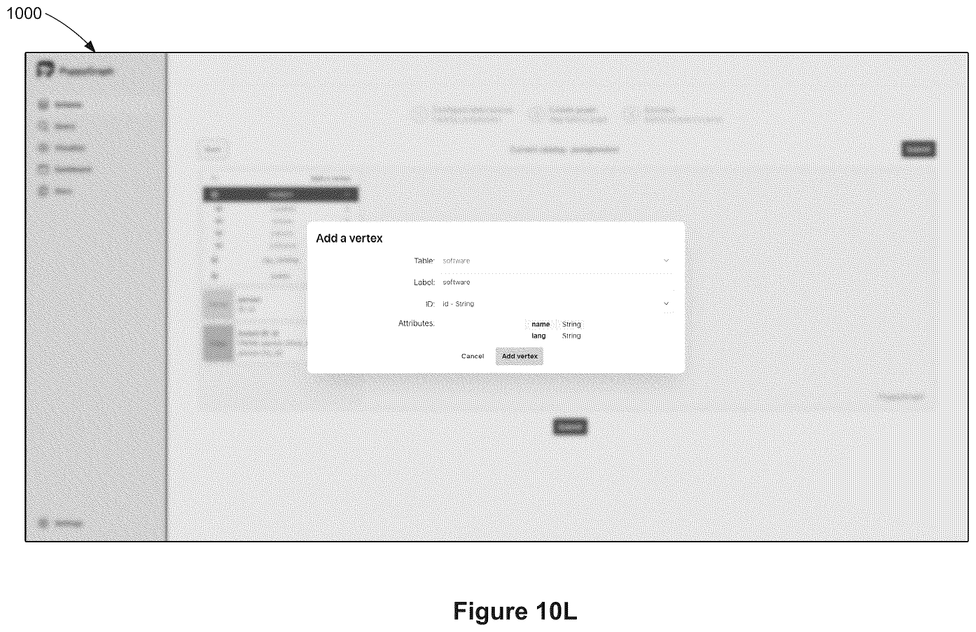

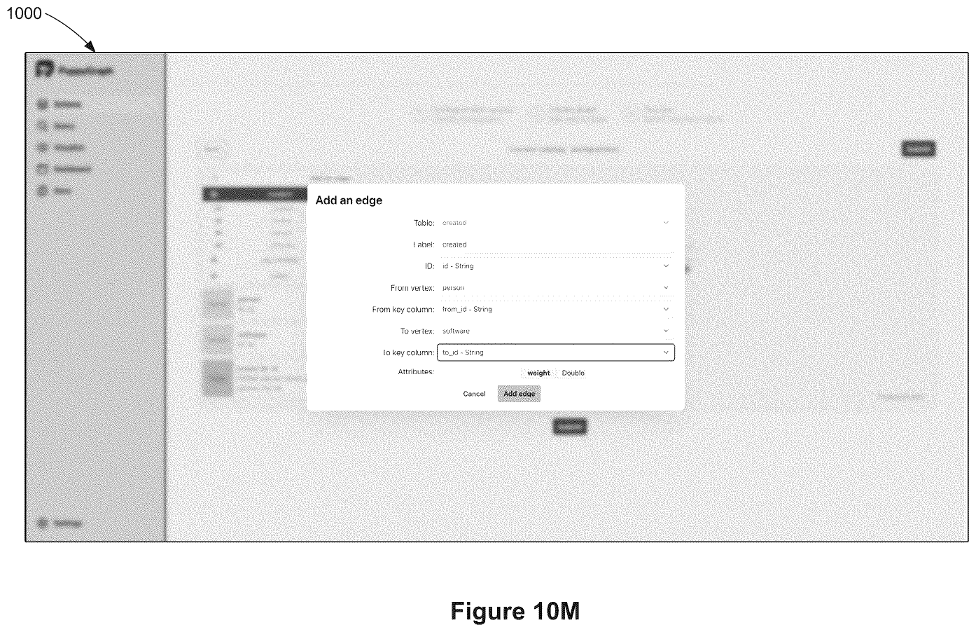

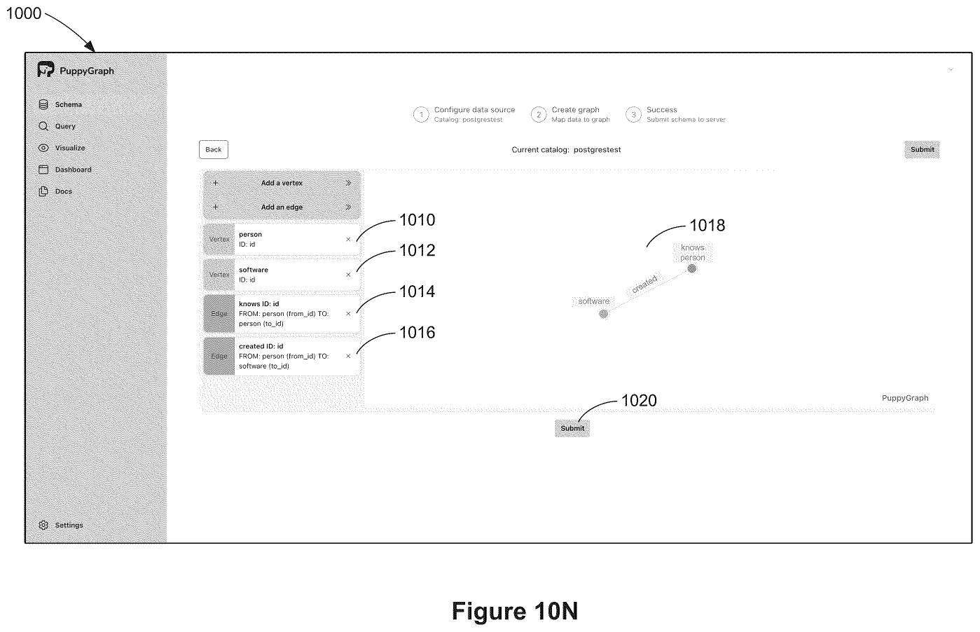

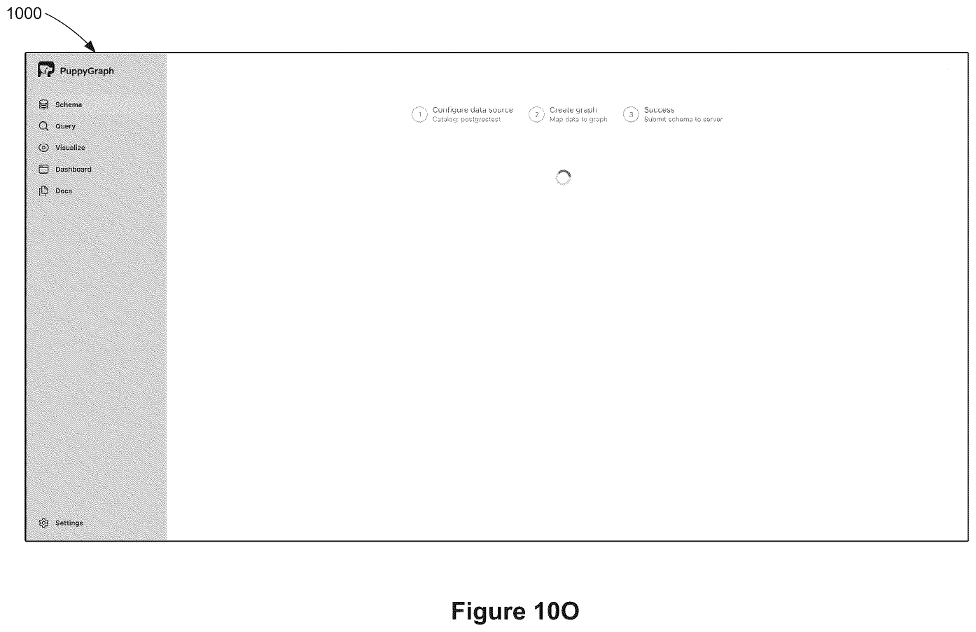

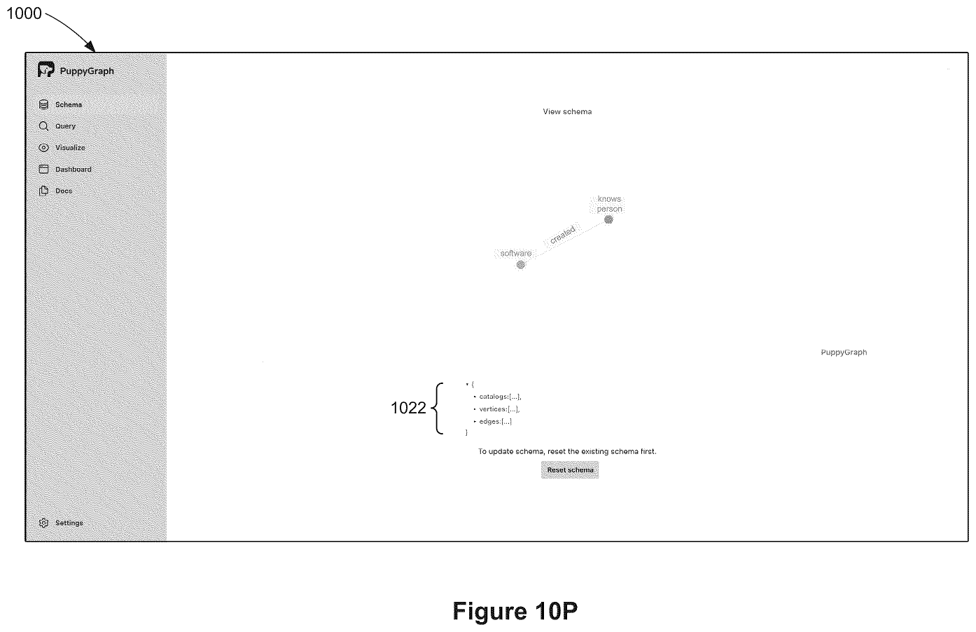

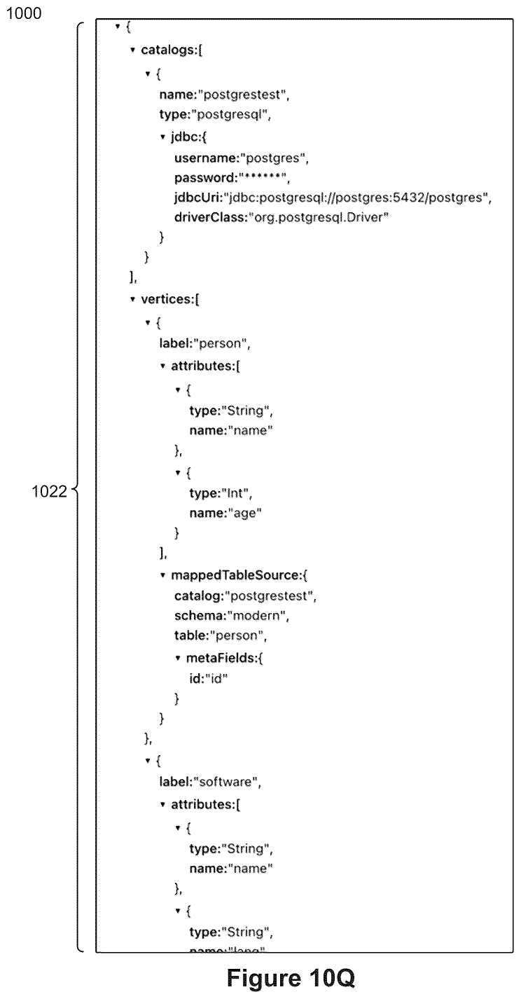

In some embodiments, an auxiliary component is created through a user interface associated with the auxiliary component (described below in reference to FIGS. 10A-10Q).

### Management User Interface of Graph Analytics Engine

FIGS. 5A-5L illustrate a series of graph query steps 500 associated with an example puppy_small_v_person graph query that is performed based on a management user interface (UI) 530 of the graph analytics engine, in accordance with some embodiments. The management UI 530 of the graph analytics engine also generates graph-based representations of output entries from the example puppy_small_v_person graph query. In some embodiments, the management UI 530 of the graph analytics engine supports both graph queries and non-graph queries.

FIG. 5A illustrates creating a to-be-queried puppy_small_v_person tabular database 512 (e.g., a tabular table named “puppy_small_v_person”) using a first tabular database UI 510 (e.g., applications, open-source projects, etc.). As shown in the first tabular database UI 510, the to-be-queried puppy_small_v_person tabular database 512 includes table schemas 514 associated with target entities of the to-be-queried puppy_small_v_person tabular database 512.

FIG. 5B illustrates a JSON file 520 corresponding to the example puppy_small_v_person graph query based on the to-be-queried puppy_small_v_person tabular database 512. The JSON file 520 (e.g., “schema.JSON”) defines a hierarchy of the target entities of the to-be-queried puppy_small_v_person tabular database 512.

FIG. 5C illustrates uploading the JSON file 520 to the graph analytics engine through the management UI 530 of the graph analytics engine. In some embodiments, the graph analytics engine is stored on a server. The management UI 530 of the graph analytics engine includes a status section 532, a schema section 534, and a query section 536. The status section 532 shows a current status of an associated schema file (e.g., a JSON file). The schema section 534 processes the associated schema file (e.g., a JSON file). The query section 536 illustrates example resources (e.g., consoles, open-source projects, etc.) that are used to create graph queries in graph query languages.

As shown in a first zoomed view 534a of the schema section 534, a user selects the JSON file 520 (e.g., “schema.JSON”) and uploads it. Then, the server performs a process (e.g., a check) on the uploaded JSON file 520 to obtain processed information of the JSON file 520. After the process is complete, the schema section 534 presents “Scheme OK!” as shown in a second zoomed view 534b of the schema section 534. The schema section 534 also provides an option for the user to inspect the uploaded JSON file 520 by clicking “Click to view schema.” Then, as shown in a third zoomed view 534c of the schema section 534, a drop-down list 540 then emerges and provides the processed information of the JSON file 520 related to catalogs, vertices, and edges.

FIG. 5D illustrates the status section 532 after the process on the JSON file 520 is complete.

FIG. 5E illustrates generating graph representations of the vertices and edges. The management UI 530 of the graph analytics engine includes a graph browser section 538. To visualize the vertices and edges, the user clicks “Start” to generate a graph-based representation 542 (e.g., a network graph) of the vertices and edges, as shown in a first zoomed view 538a of the graph browser section 538.

FIG. 5F illustrates a second to a fifth zoomed views 538b-538e of the graph browser section 538 that further show the graph-based representation 542 of the vertices and edges. The user may zoom in a portion of the graph-based representation 542, as shown in the second zoomed view 538b of the graph browser section 538. The user may click on vertices to check their attributes, as shown in the third zoomed view 538c of the graph browser section 538. The user may also explore the graph-based representation 542 along different edges, and obtain respective neighboring vertices and different paths between the respective neighboring vertices, as shown in the fourth and fifth zoomed views 538d-538e of the graph browser section 538.

FIG. 5G illustrates performing a set of example graph query statements 552 of the example puppy_small_v_person graph query. The user enters a first console UI 550 by clicking “Start query” associated with the first console UI 550 in the query section 536 of the management UI 530 of the graph analytics engine. Then, the user provides the set of example graph query statements to obtain output entries. For instance, the user can type g. V ( ) and obtain a list 554 of vertices for “Persons”.

FIG. 5H illustrates performing a set of example graph query statements 562 of the example puppy_small_v_person graph query. The user enters a second console UI 560 by clicking “Go to Graph notebook” associated with the second console UI 560 in the query section 536 of the management UI 530 of the graph analytics engine. As shown in the second console UI 560, the set of example graph query statements 562 includes a graph query 562-1 for obtaining a count of the vertices, a graph query 562-3 for obtaining a count of the edges, and a graph query 562-3 for obtaining paths between persons. Output entries of the graph queries 562-1 to 562-3 can be printed out (e.g., a print-out 564 of the output entries of the graph query 562-3 for obtaining paths between persons).

FIG. 5I illustrates virtualizing the output entries of the graph query 562-3 for obtaining paths between persons in the second console UI 560. A visualization is realized in an example graph-based representation 566 (e.g., a network graph) of the output entries of the graph query 562-3 for obtaining paths between persons. A zoomed view 566a of the example graph-based representation 566 provides more details of the output entries of the graph query 562-3 for obtaining paths between persons.

FIGS. 5J-5L illustrate virtualizing output entries of graph queries from a third set of example graph query statements 572 of the example puppy_small_v_person graph query through a first visualization UI 570. FIG. 5J illustrates a graph query 572-1 of the third set of example graph query statements 572 that randomly picks 25 vertices and a corresponding graph-based representation 574-1 of the picked 25 vertices. Similarly, in FIG. 5K, the user submits a graph query 572-2 of the third set of example graph query statements 572 that randomly picks 500 edges and then creates a corresponding graph-based representation 574-2 of the picked 500 edges. Moreover, respective attributes and neighbors of edges can be visualized by leveraging functions of the first visualization UI 570. FIG. 5L illustrates a graph query 572-3 of the third set of example graph query statements 572 for obtaining a count 574-3 of four-hop paths. As shown in FIG. 5L, the count 574-3 of the four-hop paths is 20,425,889, which is computed within a total execution time 576 less than 300 milliseconds.

In some embodiments, generating a graph-based representation of a plurality of output entries includes obtaining a respective graph relationship of the plurality of output entries. Generating the graph-based representation of the plurality of output entries further includes optimizing the respective graph relationship of the plurality of output entries for scalability. Generating the graph-based representation of the plurality of output entries further includes visualizing the optimized respective graph relationship of the plurality of output entries. For instance, as shown in FIGS. 5I-5L, the graph-based representations of the output entries from the graph queries (e.g., 562 and 572) can be optimized and scaled based on different UI functions (e.g., scripts, embedded UI features).

In some embodiments, receiving a graph query, traversing a to-be-queried database, and generating a graph-based representation of output entries are performed via an application or a user interface. For instance, as shown in FIGS. 5A-5L, the example puppy_small_v_person graph query is performed based on the management UI 530 of the graph analytics engine. In particular, the management UI 530 of the graph analytics engine can be built as a cloud-native application. To facilitate graph-based representations of output entries from graph queries, additional graphical features can be incorporated within the management UI 530 of the graph analytics engine.

### Data Query Using Graph Analytics Engine

FIGS. 6A-6F illustrate a series of graph query steps 600 associated with an example person_knows_person graph query that is performed based on the management UI 530 of the graph analytics engine, in accordance with some embodiments.

A user can access the graph analytics engine in a browser page with the URL http://<hostname>:8081. For instance, a locally deployed graph analytics engine is available at http://localhost:8081.

The user logins the graph analytics engine with a default username and a default password. Then, the user refreshes the browser page to restart the graph analytics engine. After logging in with the username and password, the user sees the management UI 530 of the graph analytics engine (in reference to FIGS. 5C-5E). As discussed, the management UI 530 of the graph analytics engine includes the status section 532, the schema section 534, the query section 536, and the graph browser section 538.

The user first creates a graph (e.g., a to-be-queried database) and loads it into the graph analytics engine. In some embodiments, the graph can be stored within internal data sources (e.g., local drivers) or external data sources (e.g., data lakes or databases). FIG. 6A illustrates an example person-knows-person graph 610 for the example person_knows_person graph query. In some embodiments, a respective edge that links two adjacent vertices is directed or undirected (e.g., an asymmetric or symmetric relation between two adjacent vertices). In some embodiments, the respective edge that links two adjacent vertices includes a weight component. For instance, as shown in FIG. 6A, an edge linking vertices “person 1” and “person 2” includes a weight of 0.5.

Next, the user creates a schema (e.g., a JSON file) that defines a hierarchy of target entities within the graph. After creating the schema, the user views the schema on the management UI 530 of the graph analytics engine, as shown in FIG. 6B. FIG. 6B illustrates a drop-down list 620 in the schema section 534. The drop-down list 620 provides that the graph has two vertex types and two edge types.

Then, the user queries the graph using graph query languages (e.g., Gremlin and Cypher). To query the graph using Gremlin, the user may use an embedded Gremlin console (in reference to FIG. 5G) in the graph analytics engine. FIG. 6C illustrates a start 630 of the embedded Gremlin console, a sample query 632 asking for all names of the vertices in the graph, an output 634 of the sample query 632. FIG. 6C further illustrates additional example queries and their corresponding outputs 636. The user may alternatively use Java Client. FIG. 6D illustrates dependencies 640 to be added into Java dependency for connecting with Java Client. FIG. 6D further illustrates an example connection with Gremlin Server 642. In addition, the user may alternatively use Python Client. FIG. 6E illustrates a portion 650 of a script for connecting official gremlin-python client and a query to a local Gremlin server 652 using a native driver. It is optional to submit a query directly via Python Client such that the query string is consistent with the one used in the embedded Gremlin console, as shown in an example script 654 of FIG. 6E.

Instead of Gremlin, the user can query the graph using Cypher. The user may use an embedded Cypher console (e.g., clicking “Start Query” under a “Cypher console” subsection of the query section 536 in reference to FIG. 5C) provided by the graph analytics engine. FIG. 6F illustrates a start 660 of the embedded Cypher console, a sample query 662 asking for all names of the vertices in the graph, an output 664 of the sample query 662.

Graph Analytics Engine with Locally Deployed Apache Iceberg

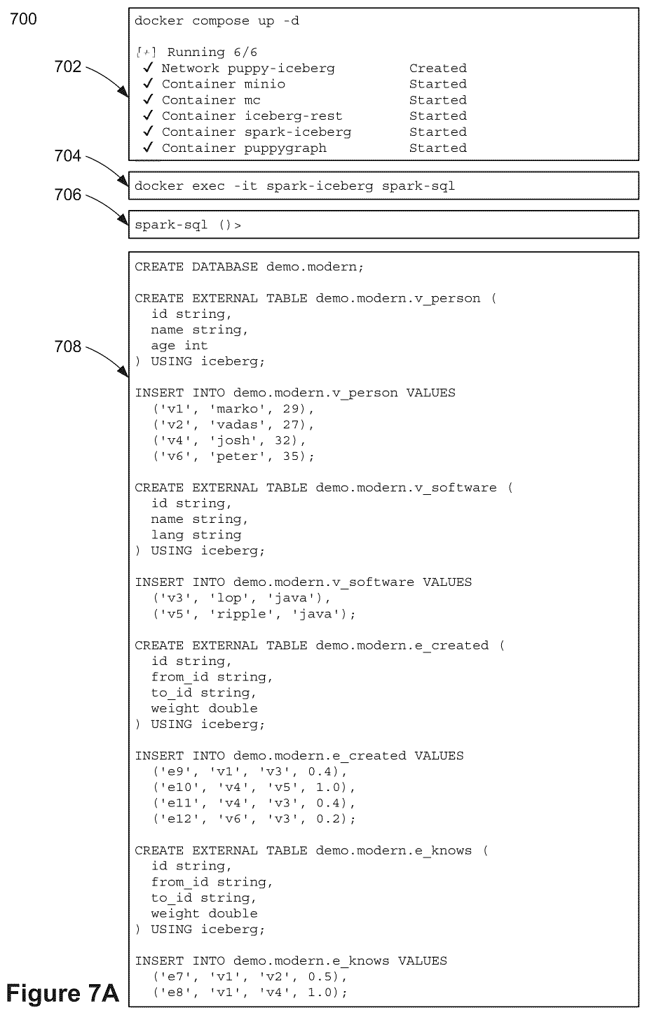

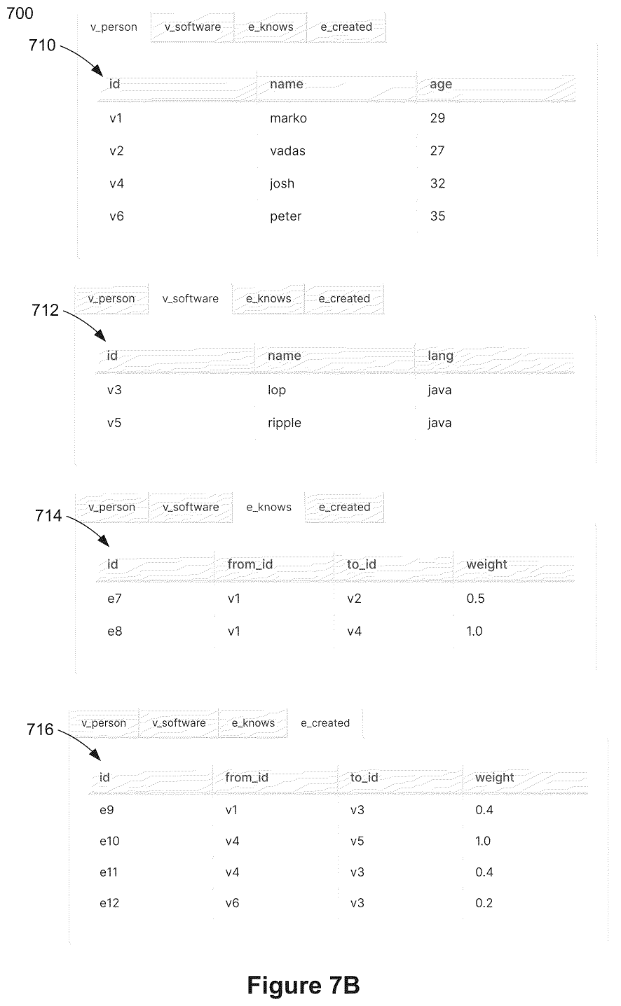

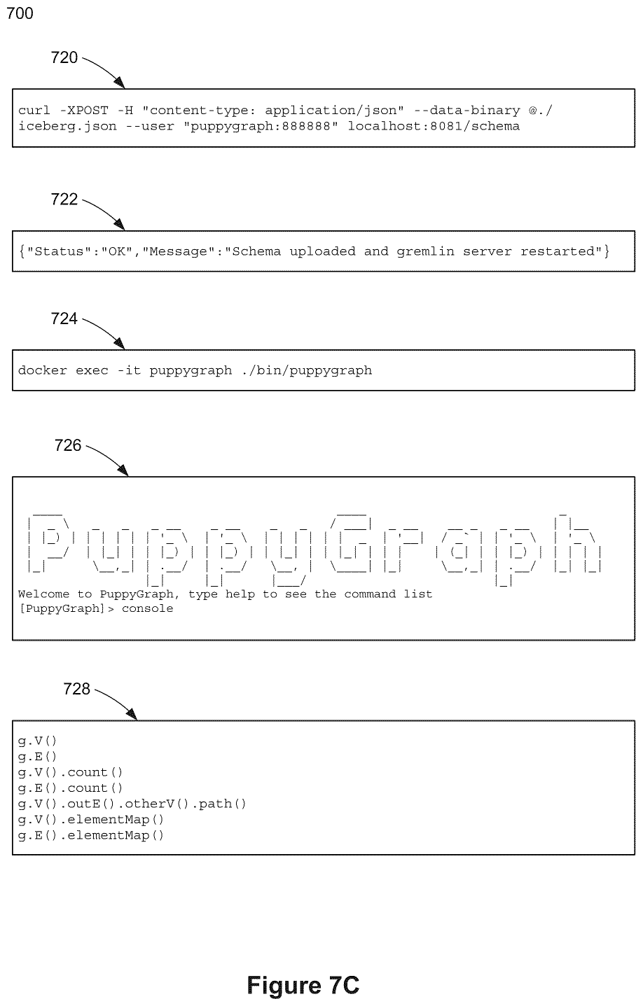

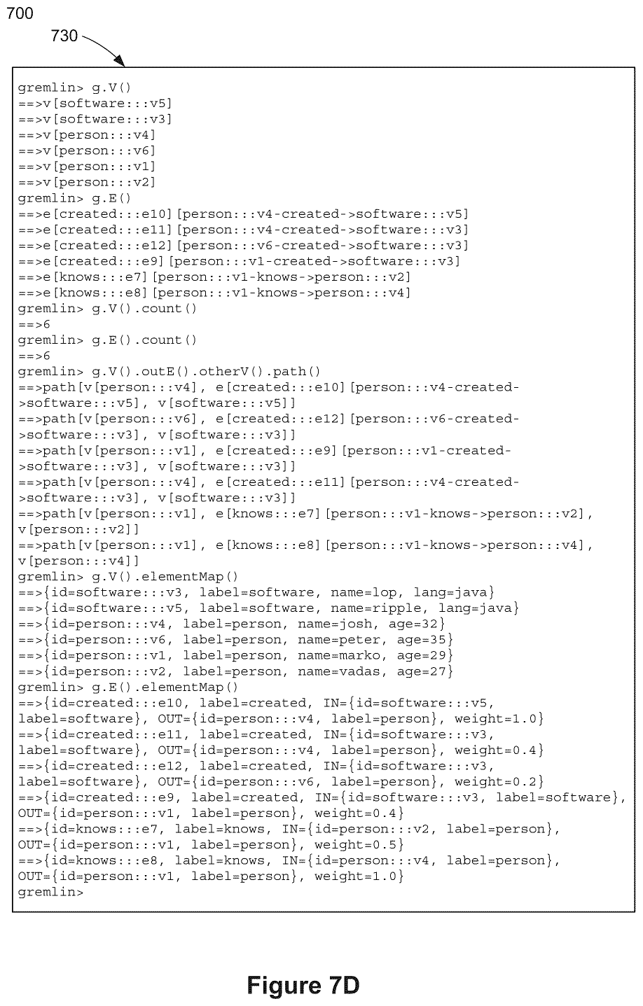

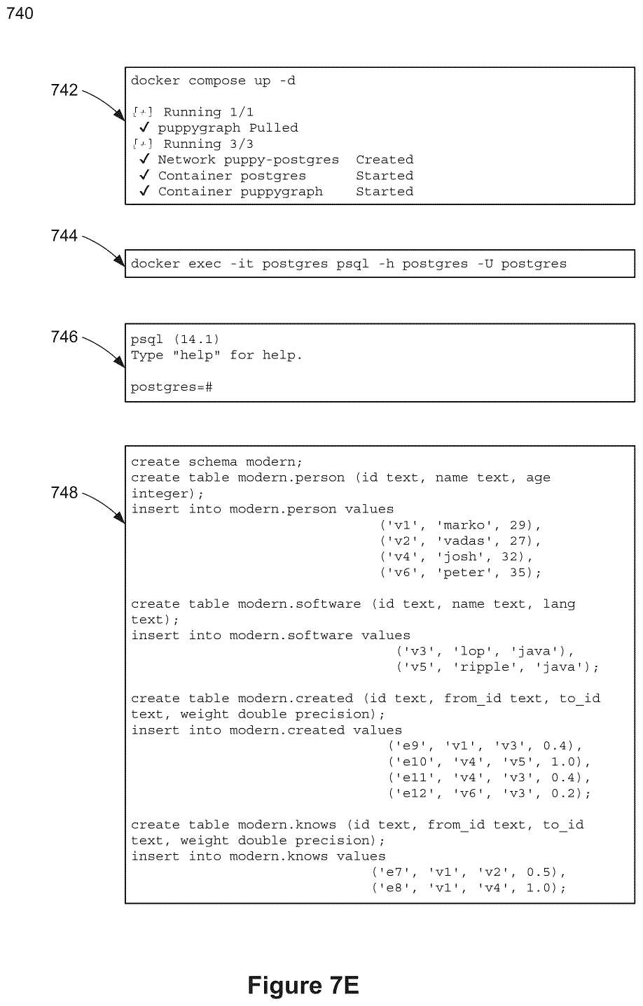

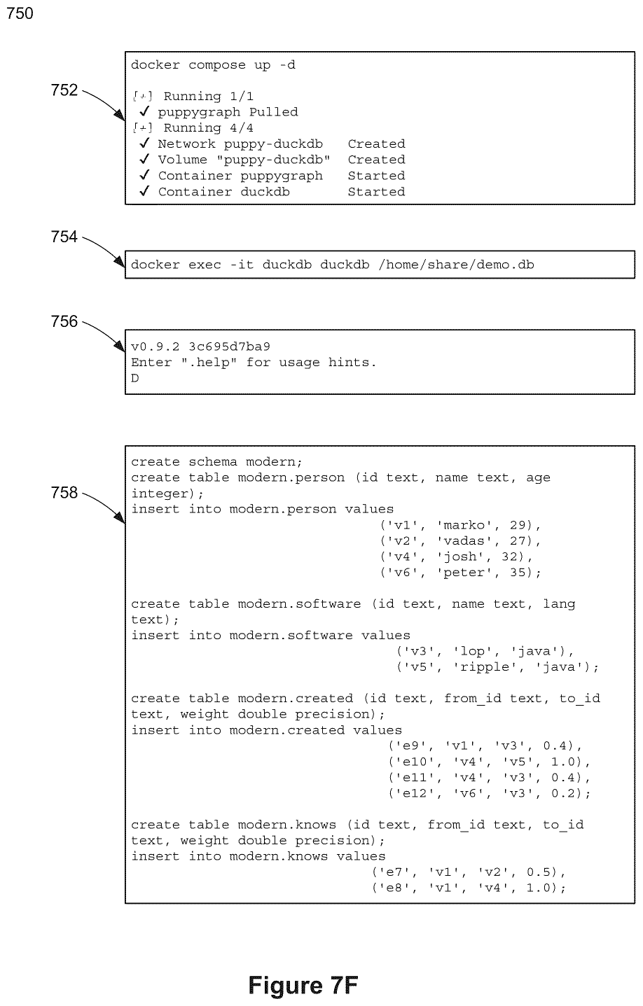

FIGS. 7A-7D illustrate an example graph query 700 using the graph analytics engine with locally deployed Apache Iceberg, in accordance with some embodiments. The example graph query 700 is based on the example person-knows-person graph 610 for the example person_knows_person graph query in reference to FIG. 6A.

A user creates a file docker-compose.yaml with content “docker-compose.yaml.” The user then runs command 702 to start Iceberg and graph analytics engine services, as illustrated in FIG. 7A.

To prepare data on Iceberg, the user runs command 704 to start a Spark-SQL shell 706 to access Iceberg for creating database, as illustrated in FIG. 7A. The user then executes SQL statements 708 in the Spark-SQL shell, as illustrated in FIG. 7A, to create tables and insert data. The SQL statements 708 create Iceberg tables (e.g., a “v_person” table 710, a “v software” table 712, a “e_knows” table 714, and a “e_created” table 716″).

Then, the user defines a schema in accordance with the created Iceberg tables. The user creates a graph schema file iceberg.json with content “iceberg.json” based on the example person-knows-person graph 610. The user runs command 720 to upload the graph schema file iceberg.json, as illustrated in FIG. 7C. A response 722 shows that the graph schema file iceberg.json is uploaded, as illustrated in FIG. 7C.

After the graph schema file iceberg.json is uploaded, the user queries the example person-knows-person graph 610 through a web-based Gremlin console embedded in the graph analytics engine. To access a command-line interface (CLI) of the graph analytics engine, the user runs command 724, as illustrated in FIG. 7C. In the CLI of the graph analytics engine, the user types “console” to start the embedded Gremlin console 726, as illustrated in FIG. 7C.

The user then queries the example person-knows-person graph 610 using Gremlin query language. For instance, the user creates graph queries 728, as shown in FIG. 7C, and obtains output entries 730, as shown in FIG. 7D.

Graph Analytics Engine with Locally Deployed PostgreSQL

FIG. 7E illustrates an example graph query 740 using the graph analytics engine with locally deployed PostgreSQL, in accordance with some embodiments. The example graph query 740 is based on the example person-knows-person graph 610 for the example person_knows_person graph query in reference to FIG. 6A. A major portion of the example graph query 740 with the locally deployed PostgreSQL is substantially similar to the example graph query 700 with the locally deployed Apache Iceberg.

A user creates a file docker-compose.yaml with content “docker-compose.yaml.” The user then runs command 742 to start Postgres and graph analytics engine services, as illustrated in FIG. 7E.

To prepare data on Iceberg, the user runs command 744 to start a PostgreSQL shell 746 to access PostgreSQL for creating database, as illustrated in FIG. 7E. The user then executes SQL statements 748 in the PostgreSQL shell, as illustrated in FIG. 7E, to create tables and insert data. The SQL statements 748 create PostgreSQL tables (e.g., similar to Iceberg tables in reference to FIG. 7B).

Then, the user defines a graph schema file in accordance with the created PostgreSQL tables, upload graph schema file to the graph analytics engine, and queries the example person-knows-person graph 610 using Gremlin query language.

Graph Analytics Engine with Locally Deployed DuckDB

FIG. 7F illustrates an example graph query 750 using the graph analytics engine with locally deployed DuckDB, in accordance with some embodiments. The example graph query 750 is based on the example person-knows-person graph 610 for the example person_knows_person graph query in reference to FIG. 6A. Similarly, the example graph query 750 with locally deployed DuckDB involves steps that closely resemble those for the locally deployed PostgreSQL and Apache Iceberg.

A user creates a file docker-compose.yaml with content “docker-compose.yaml.” The user then runs command 752 to start DuckDB and graph analytics engine services, as illustrated in FIG. 7F.

To prepare data on Iceberg, the user runs command 754 to create a database file/home/share/demo.db and start a DuckDB shell 756 to access DuckDB for creating database, as illustrated in FIG. 7F. The user then executes SQL statements 758 in the DuckDB shell, as illustrated in FIG. 7F, to create tables and insert data. The SQL statements 758 create DuckDB tables (e.g., similar to Iceberg tables in reference to FIG. 7B).

Then, the user defines a graph schema file in accordance with the created DuckDB tables, upload graph schema file to the graph analytics engine, and queries the example person-knows-person graph 610 using Gremlin query language.

### Query Data Lakes

FIGS. 8A-8J illustrate an example graph query 800 using the graph analytics engine with data lakes, in accordance with some embodiments.

A user can query data by connecting to the data lakes, which include Apache Iceberg, Apache Hudi, Delta Lake, and Apache Hive.

In the example graph query 800 with the data lakes, the user creates example person-referral tables (e.g., a person table 802 and a referral table 804) in the data lakes, as shown in FIG. 8A.

### Query Data Lakes: Apache Iceberg

The user runs shell command 810 to start a Spark SQL shell for data preparation. A spark-sql executable is in a bin folder of a Spark directory, as illustrated in FIG. 8B. The shell command 810 assumes data are stored on Hadoop Distributed File System (HDFS) at 172.31.19.123:9000 and that Hive Metastore is at 172.31.31.125:9083. Then, the user runs Spark-SQL statements 812 to create the example person-referral tables 802 and 804 in Iceberg database onhdfs and insert data, as illustrated in FIG. 8B. A catalog name puppy_iceberg is specified in the shell command 810. In some embodiments, running the shell command 810 and the Spark-SQL statements 812 is optional.

The user then defines a graph before querying the graph by creating a schema file iceberg.json 816, as shown in FIG. 8C. The schema file iceberg.json 816 requires:
A catalog object named catalog_test defines an Iceberg data source. The hiveMetastoreUrl field matches the Hive Metastore URL.
Labels of vertices and edges may not be the same as names of tables in Iceberg. A mappedTableSource object in each vertex or edge type specifies a schema and/or database name onhdfs and a table name referral.
The mappedTableSource object also refers to columns (e.g., attributes) in the tables.
   An id field refers to a column storing identities for vertices ID and edges refId.
   Fields from and to refer to two columns in the tables as ends of edges. Values of these two columns match the id field of the vertices. In the example graph query 800 with the data lakes, each row in the referral table models an edge in the graph from source to referred.

Once the schema file iceberg.json 816 is created, the user uploads it to the graph analytics engine with shell command 814, as shown in FIG. 8B.

### Query Data Lakes: Apache Hudi

The user runs shell command 830 to start a SparkSQL instance for data preparation, as illustrated in FIG. 8D. The shell command 830 assumes delta lake data are stored on HDFS at 172.31.19.123:9000 and that Hive Metastore is at 172.31.31.125:9083. Then, the user runs SparkSQL query 832 to create the example person-referral tables 802 and 804 in delta lake database hudi_onhdfs and insert data, as illustrated in FIG. 8D. A catalog name puppy_delta is specified in the shell command 830. In some embodiments, running the shell command 830 and the SparkSQL query 832 is optional.

The user then defines a graph before querying the graph by creating a schema file hudi.json 836, as illustrated in FIG. 8E. The schema file hudi.json 836 requires:
A catalog object named catalog_test specifies remote data source in Apache Hudi. A hiveMetastoreUrl field has the same value as the one used to create data.
Labels of vertices and edges may not be the same as names of tables in Apache Hudi. A mappedTableSource object in each vertex or edge type specifies a schema and/or database name onhdfs and a table name referral.
The mappedTableSource object remarks meta columns (e.g., attributes) in the tables. For instance, fields from and to refer to two columns that form endpoints of the edges.

Once the schema file hudi.json 836 is created, the user uploads it to the graph analytics engine with shell command 834, as shown in FIG. 8D.

### Query Data Lakes: Delta Lake

The user runs shell command 850 to start a SparkSQL instance for data preparation, as illustrated in FIG. 8F. The shell command 850 assumes delta lake data are stored on HDFS at 172.31.19.123:9000 and that Hive Metastore is at 172.31.31.125:9083. Then, the user runs SparkSQL query 852 to create the example person-referral tables 802 and 804 in Delta Lake database onhdfs and insert data, as illustrated in FIG. 8F. A catalog name puppy_delta is specified in the shell command 850. In some embodiments, running the shell 850 and the SparkSQL query 852 is optional.

The user then defines a graph before querying the graph by creating a schema file deltalake.json 856, as illustrated in FIG. 8G. The schema file deltalake.json 856 requires:
A catalog object named catalog_test specifies remote data source in Delta Lake. A hiveMetastoreUrl field has the same value as the one used to create data.
Labels of vertices and edges may not be the same as names of tables in Delta Lake. A mappedTableSource object in each vertex or edge type specifies a schema and/or database name onhdfs and a table name referral.
The mappedTableSource object marks meta columns (e.g., attributes) in the tables. For instance, fields from and to refer to two columns that form endpoints of the edges.

Once the schema file deltalake.json 856 is created, the user uploads it to the graph analytics engine with shell command 854, as shown in FIG. 8F.

### Query Data Lakes: Apache Hive

The user runs command 870 to use Hive beeline client to connect to Hive Server, as illustrated in FIG. 8H. A Hive home path is /opt/hive. If the Hive Server is not at a localhost, the user changes URL accordingly. Then, the user creates tables by statements 872 in Hive beeline console, as illustrated in FIG. 8H. In some embodiments, running the command 870 and the statements 872 is optional.

The user then defines a graph before querying the graph by creating a schema file hive_hdfs.json 878, as illustrated in FIG. 8I. The schema file hive_hdfs.json defines a Hive Catalog 874, as illustrated in FIG. 8H. The schema file hive_hdfs.json 878 requires:
The name hive_hdfs defines a reference within the hive_hdfs.json schema. The name hive_hdfs is used by definition of vertices and edges.
A type of the Hive Catalog is hive, and a metastore type of the Hive Catalog is HMS.
A metastore.hiveMetastoreUrl specifies URL of a Hive Metastore Service. The user can change a hostname accordingly if the Hive Metastore Service is not deployed at the localhost.

Once the schema file hive_hdfs.json 878 is created, the user uploads it to the graph analytics engine with shell command 876, as shown in FIG. 8H.

In some embodiments, the graph analytics engine supports querying Iceberg, Hudi, and Delta Lake with metastore (e.g., Hive metastore, AWS Glue) and with storage (e.g., HDFS, AWS S3, MinIO).

To query the data based on the data lakes (e.g., Apache Iceberg, Apache Hudi, Delta Lake, and Apache Hive) discussed above, the user connects to the graph analytics engine at http://localhost:8081 and start the embedded Gremlin console UI 550 (e.g., in reference to FIG. 5G) through the management UI 530 of the graph analytics engine.

After connecting to the embedded Gremlin Console, the user starts to query the graph. For instance, the user submits an example graph query 880 for checking names of people known by a person and subsequently receives corresponding output entries 882, as shown in FIG. 8J.

### Query Relational Databases

FIGS. 9A-90 illustrates an example graph query 900 using the graph analytics engine with relational databases, in accordance with some embodiments.

A user can query data by connecting to the relational databases, which include MySQL, PostgreSQL, DuckDB, BigQuery, and Redshift.

In the example graph query 900 with the relational databases, the user creates example person-referral tables (e.g., a person table 802 and a referral table 804 in reference to FIG. 8A) in the relational databases.

### Querying Relational Databases: MySQL

The user starts a MySQL container through Docker by command 910, as illustrated in FIG. 9A, and writes data to MySQL. An IP address of a machine that runs the MySQL container is assumed to be 172.31.19.123. After waiting for the MySQL container to start, the user connects through MySQL client 912, as illustrated in FIG. 9A. Then, the user creates a database and a data table by statements 914, as illustrated in FIG. 9A, and writes the data to MySQL. In some embodiments, running the command 910 and the statements 914 is optional.

The user then defines a schema file mysql.json 918 before querying the table, as illustrated in FIG. 9B. The schema file mysql.json 918 requires:
A catalog jdbc_mysql is added to specify remote data source in MySQL.
   Set type to mysql.
   Set driverClass to com.mysql.jdbc. Driver for MySQL v5.x and earlier. Alternatively, set driverClass to com.mysql.cj.jdbc. Driver for MySQL v6.x and later.
   Set driverUrl to provide a URL where the graph analytics engine finds the MySQL driver.
Labels of vertices and edges may not be the same as names of tables in MySQL. A mappedTableSource object in each vertex or edge type specifies a schema name graph and a table name referral.
The mappedTableSource object remarks meta columns (e.g., attributes) in the tables. For instance, fields from and to refer to two columns that form endpoints of the edges.

Once the schema file mysql.json 918 is created, the user uploads it to the graph analytics engine at localhost with shell command 916, as shown in FIG. 9A.

### Querying Relational Databases: PostgreSQL

The user starts a PostgreSQL container through Docker by command 920, as illustrated in FIG. 9C, and writes data to PostgreSQL. An IP address of a machine that runs the PostgreSQL container is assumed to be 172.31.19.123. After waiting for the PostgreSQL container to start, the user connects through PostgreSQL client 922, as illustrated in FIG. 9C. Then, the user creates a database and a data table by statements 924, as illustrated in FIG. 9C, and writes the data to PostgreSQL. In some embodiments, running the command 920 and the statements 924 is optional.

The user then defines a schema file postgres.json 928 before querying the table, as illustrated in FIG. 9D. The schema file postgres.json 928 requires:
A catalog jdbc_postgres is added to specify remote data source in postgreSQL.
   Set type to postgresql.
   Set driverClass to org.postgresql.Driver.
   Set driverUrl to provide a URL where the graph analytics engine finds the PostgreSQL driver.
Labels of vertices and edges may not be the same as names of tables in PostgreSQL. A mappedTableSource object in each vertex or edge type specifies a schema name public and a table name referral.
The mappedTableSource object marks meta columns (e.g., attributes) in the tables. For instance, fields from and to refer to two columns that form endpoints of the edges.

Once the schema file mysql.json 928 is created, the user uploads it to the graph analytics engine at localhost with shell command 926, as shown in FIG. 9C.

### Querying Relational Databases: DuckDB

The user starts a DuckDB container through Docker by command 930, as illustrated in FIG. 9E, and writes data to DuckDB. After waiting for the DuckDB container to start, the user runs command 932 to start DuckDB interactive shell, as illustrated in FIG. 9E. Then, the user creates a database and a data table by statements 934, as illustrated in FIG. 9E, and writes the data to DuckDB. After writing the data to DuckDB, the user stops the DuckDB interactive shell by typing.exit to close the DuckDB client. This is to avoid a conflict with other programs (e.g., the graph analytics engine). In some embodiments, running the commands 930 and 932 and the statements 934 is optional.

The user then defines a schema file duckdb.json 938 before querying the table, as illustrated in FIG. 9F. The schema file duckdb.json 938 requires:
A catalog jdbc_duckdb is added to specify remote data source in DuckDB.
   Set type to duckdb.
   Set driverClass to org.duckdb.DuckDBDriver.
   Set driverUrl to provide a URL where the graph analytics engine finds the DuckDB driver.
Labels of vertices and edges may not be the same as names of tables in DuckDB. A mappedTableSource object in each vertex or edge type specifies a schema name graph and a table name referral.
The mappedTableSource object marks meta columns (e.g., attributes) in the tables. For instance, fields from and to refer to two columns that form endpoints of the edges.

Once the schema file duckdb.json 938 is created, the user uploads it to the graph analytics engine at localhost with shell command 936, as shown in FIG. 9E.

### Querying Relational Databases: BigQuery

For creating tables and inserting data to BigQuery, the user performs steps below as shown in screenshots (e.g., 940, 942, and 944) of FIGS. 9G-9I.
Create a dataset with multiple-region support in (e.g., the screenshot 940).
Create tables using a web console (e.g., the screenshots 942 and 944).
   After that, the user opens a query table and executes SQL statements 946, as illustrated in FIG. 9J. In some embodiments, performing steps shown in FIGS. 9G-9I and executing SQL statements 946 are optional. In some embodiments, a BigQuery Authentication is required.

Next, the user starts the graph analytics engine container named puppy through a key key.json command 948, as illustrated in FIG. 9J.

Then, the user defines a schema file bigquery.json 952 before querying the table, as illustrated in FIG. 9K. The schema file bigquery.json 952 requires:
A catalog jdbc_bigquery is added to specify remote data source in BigQuery.
   Set type to bigquery.
   Set driverClass to com.simba.googlebigquery.jdbc.Driver.
   Set driverUrl to provide a URL where the graph analytics engine finds the DuckDB driver.
jdbcUri needs to be set in accordance with the user's service account configuration.
   Set ProjectId=PJID. PJID for service account project id.
   Set OAuthServiceAcctEmail=for service account id.
   Set OAuthPvtKeyPath=for a key file path in the docker container (e.g., /home/key.json).
Labels of vertices and edges may not be the same as names of tables in BigQuery. A mappedTableSource object in each vertex or edge type specifies a schema name demo and a table name referral.
The mappedTableSource object marks meta columns (e.g., attributes) in the tables. For instance, fields from and to refer to two columns that form endpoints of the edges.

Once the schema file bigquery.json 952 is created, the user uploads it to the graph analytics engine at localhost with shell command 950, as shown in FIG. 9J.

### Querying Relational Databases: RedShift

For creating tables and inserting data to RedShift, the user follows steps below as shown in screenshots (e.g., 960 and 962) in FIGS. 9L-9M.
Create a database with a query editor (e.g., the screenshot 960).
Create tables in the database (e.g., the screenshot 962).
   After that, the user executes SQL statements 964 to insert data into the tables, as illustrated in FIG. 9N. In some embodiments, performing steps shown in FIGS. 9L-9M and executing SQL statements 964 are optional.

Then, the user defines a schema file redshift.json 968 before querying the table, as illustrated in FIG. 9O. The schema file redshift.json 968 requires:
A catalog jdbc_redshift is added to specify remote data source in RedShift.
Replace username and password.
Replace jdbcUri with the user's JDBC URL.
Labels of vertices and edges may not be the same as names of tables in RedShift. A mappedTableSource object in each vertex or edge type specifies a schema name public and a table name referral.
The mappedTableSource object marks meta columns (e.g., attributes) in the tables. For instance, fields from and to refer to two columns that form endpoints of the edges.

Once the schema file redshift.json 968 is created, the user uploads it to the graph analytics engine at localhost with shell command 966, as shown in FIG. 9N.

To query the data based on the relational databases (e.g., MySQL, PostgreSQL, DuckDB, BigQuery, and Redshift) discussed above, the user connects to the graph analytics engine at http://localhost:8081 and start the embedded Gremlin console UI 550 (e.g., in reference to FIG. 5G) through the management UI 530 of the graph analytics engine.

After connecting to the embedded Gremlin Console, the user starts to query the graph. For instance, the user submits an example graph query 880 for checking names of people known by a person and subsequently receives corresponding output entries 882, as shown in FIG. 8J.

### Schema Creation User Interfaces

FIGS. 10A-10Q illustrate a series of screenshots of an example schema creation UI 1000 for creating an example person_knows_person_UI graph schema 1022, in accordance with some implementations. The example schema creation UI 1000 allows a user to create graph schemas (e.g., JSON files) by UI features provided by the example schema creation UI 1000 such that there is no need for the user to upload separate JSON files.

FIG. 10A illustrates a “Create Graph Schema” section 1002 and a “Upload Graph Schema JSON” section 1004 within the example schema creation UI 1000. The user can choose the “Create Graph Schema” section 1002 to initiate a schema creation process using UI features provided by the example schema creation UI 1000.

FIGS. 10B-10D illustrate the user's selection of respective catalog information 1006 and respective to-be-queried database information 1008 in accordance with the example person_knows_person_UI graph schema.

FIGS. 10E-10N illustrate a series of steps of creating respective vertices (e.g., 1010 and 1012) and respective edges (1014 and 1016) of the example person_knows_person_UI graph schema. In addition, FIG. 10N illustrates a respective graph representation of the respective vertices (e.g., 1010 and 1012) and respective edges (1014 and 1016). The user clicks “Submit” 1020 to start processing the respective vertices (e.g., 1010 and 1012) and respective edges (1014 and 1016) for generating a respective graph schema, as shown in FIGS. 10N-10O.

FIGS. 10P-10Q illustrate the example person_knows_person_UI graph schema 1022 generated by the example schema creation UI 1000 in accordance with the respective vertices (e.g., 1010 and 1012) and respective edges (1014 and 1016).

### Automated Graph Schema Generation

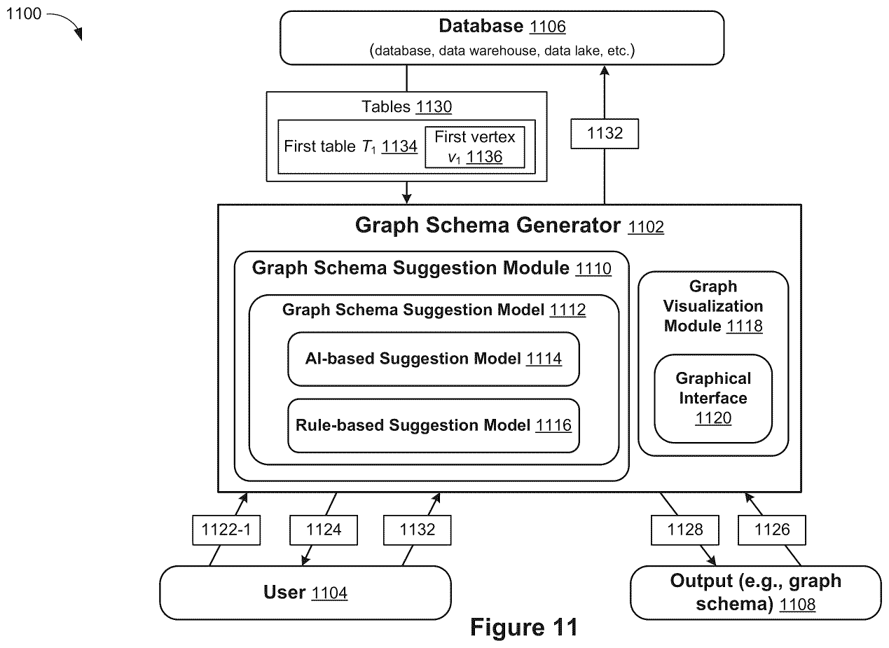

FIG. 11 illustrates an example schema generation system 1100 that performs automated graph schema generation, in accordance with some embodiments. The example schema generation system 1100 includes a graph schema generator 1102 configured to interact with a user 1104 and a database 1106 and automatically generate an output 1108 (e.g., a graph schema in a JSON file). The graph schema generator 1102 includes a graph schema suggestion module 1110 that executes a graph schema suggestion model 1112 (e.g., a computational model) configured to generate suggestion(s) that identifies new vertices and/or new edges as potential candidates for generating graph schemas. In some embodiments, the graph schema suggestion model 1112 includes an AI-based suggestion model 1114 and a rule-based suggestion model 1116. The AI-based suggestion model 1114 implements AI techniques (e.g., machine learning models, LLMs, etc.), and the rule-based suggestion model 1116 implements predefined rules and heuristics (e.g., joining test rules, dependency rules, validation rules, matching rules, conditional join rules, etc.). In some embodiments, the graph schema generator 1102 includes a graph visualization module 1118 (e.g., a schema graph visualization tool) that executes a graphical interface 1120 for displaying visual graph-based representations of graph schemas. The graph visualization module 1118 helps users understand and refine graph schemas by displaying potential candidates of vertices and/or edges based on the suggestion(s). In some embodiments, the database 1106 includes a relational database, a data warehouse, and/or a data lake, each of which having data table(s), metadata, and/or other essential inputs. In some embodiments, the database 1106 includes documents, specifications, reports, and/or other types of files, each of which having data table(s) and/or other essential inputs. The more detailed and canonical the documents are, the more accurate the suggestion(s) will be. In some embodiments, graph schemas are utilized in a variety of applications, such as data analysis and knowledge representation. In some embodiments, the graph schema generator 1102 is configured to generate the auxiliary component 303, the graph schema file(s), and/or other graph schema(s) described above in reference to FIGS. 1-10Q. In some embodiments, in a graph schema, vertices define individual objects (e.g., data points), and edges defines connections/relationships between vertices.

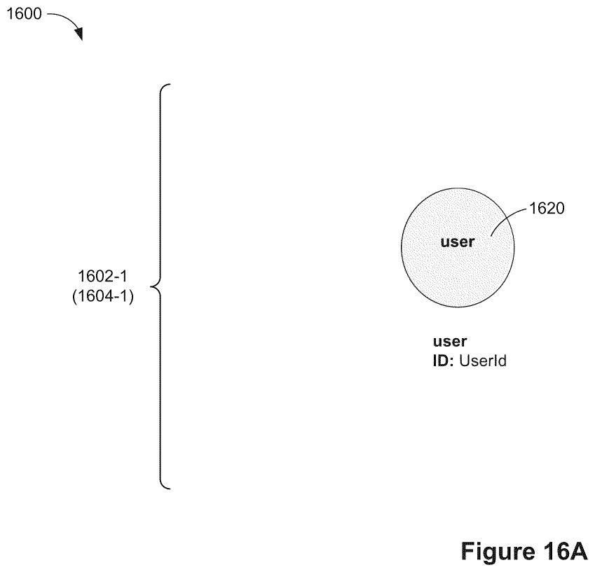

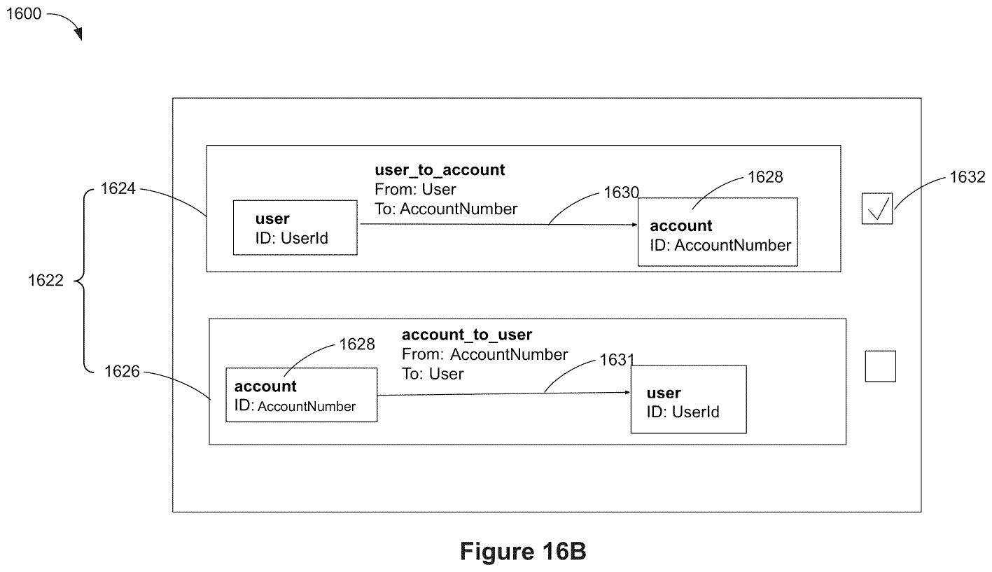

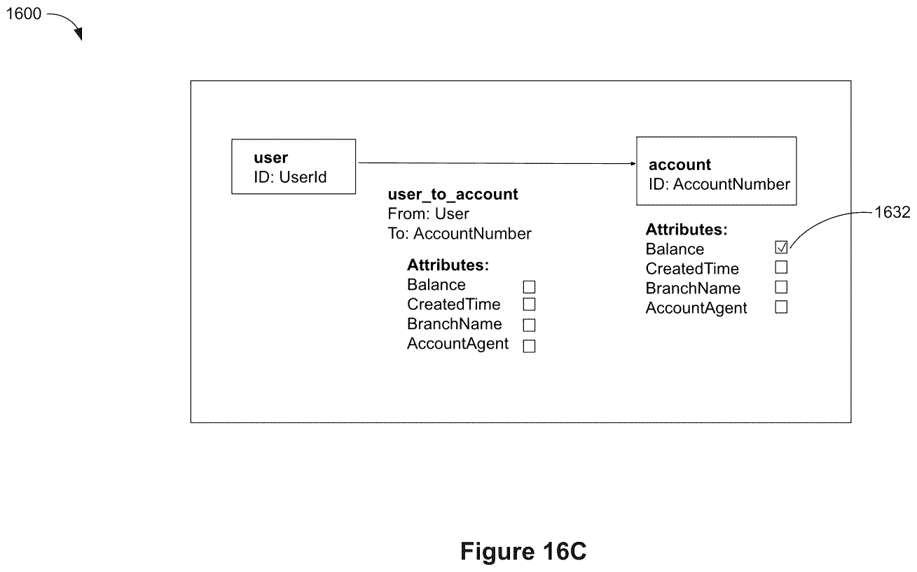

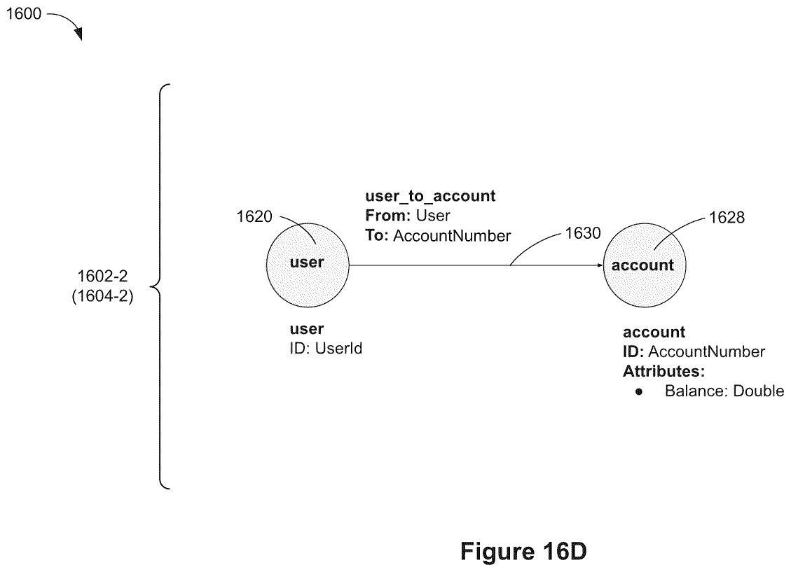

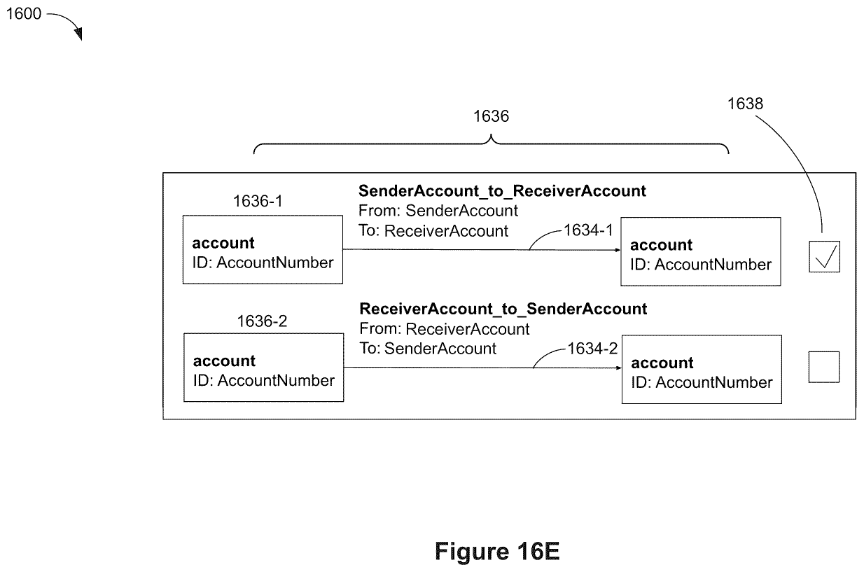

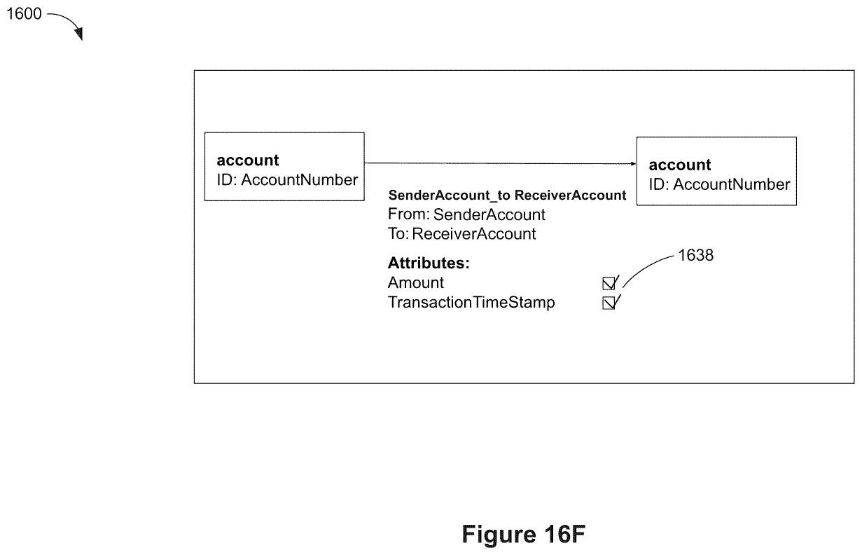

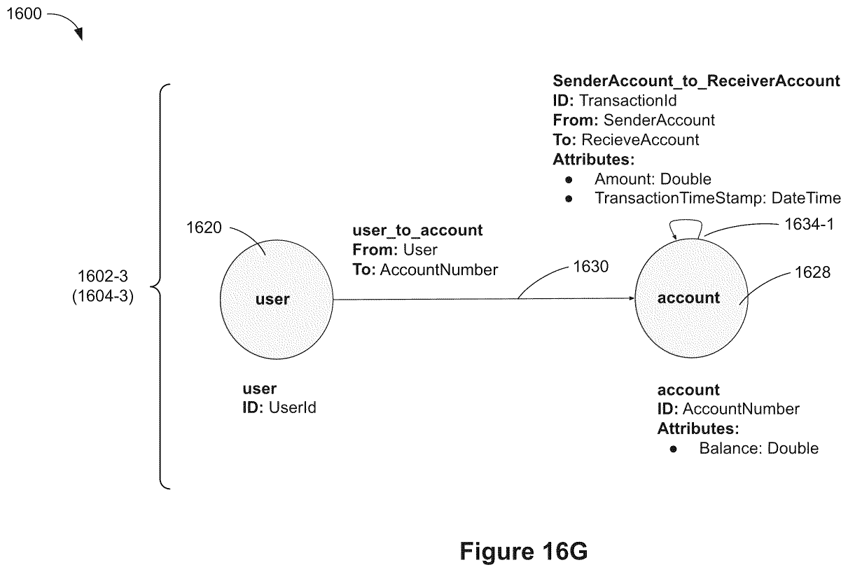

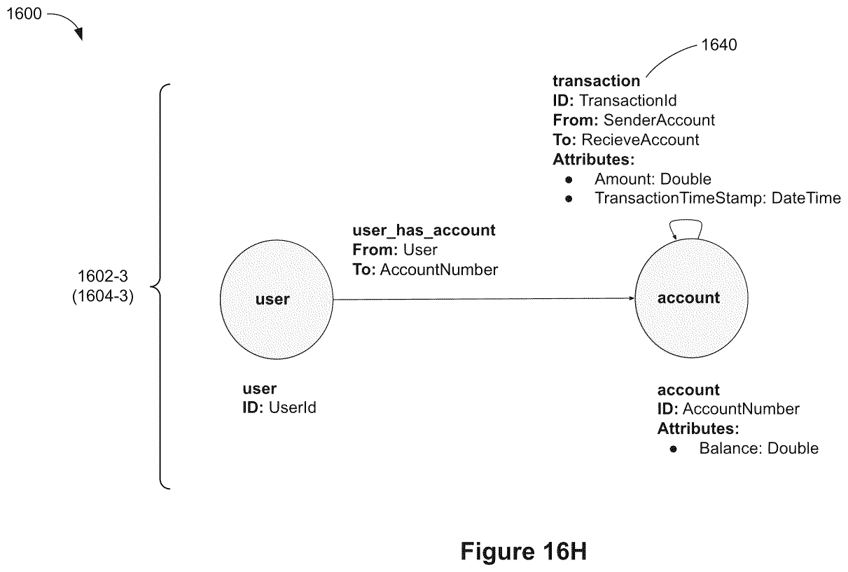

In some embodiments, the example schema generation system 1100 automatically generates graph schema(s) based on input(s) from the user 1104 and data tables received from the database 1106. The graph schema generator 1102 receives a graph schema 1126 (e.g., a partial graph schema that defines a subset of vertices and edges associated with data tables) that includes vertices and edges associated with a plurality of data tables 1130 (e.g., relational data tables) of the database 1106. The graph schema 1126 includes at least a first vertex v₁ 1136 from a first data table T₁ 1134 of the plurality of data tables 1130. The graph schema generator 1102 further automatically generates, based on the plurality of data tables 1130 and the graph schema 1126, one or more suggestions 1124 using the graph schema suggestion model 1112. The one or more suggestions 1124 identifies at least one of the group consisting of one or more vertices and one or more edges. The one or more suggestions 1124 includes a respective suggestion that identifies a respective subset of the at least one of the group consisting of the one or more vertices and the one or more edges. The one or more vertices are distinct from the first vertex v₁ 1136. For example, the one or more suggestions 1124 identifies new vertices and/or new edges, which are not currently present in the graph schema 1126, as potential candidates to be added into the graph schema 1126. In another example, the one or more suggestions 1124 (e.g., S₁, S₂, S₃, . . . , Sₖ; k is an integer greater than 1) identify the one or more vertices (e.g., v₁, v₂, v₃, . . . , vₘ; m is an integer greater than 1) and/or the one or more edges (e.g., e₁, e₂, e₃, . . . , eₙ; n is an integer greater than 1). The respective suggestion (e.g., S₂) of the one or more suggestions 1124 identifies the vertex v₂ and/or the edge e₂, which is the respective subset of the one or more vertices (e.g., v₁, v₂, v₃, . . . , vₙ) and/or the one or more edges (e.g., e₁, e₂, e₃, . . . , eₘ). The graph schema generator 1102 further receives a first user input 1122-1 from the user 1104. In particular, the first user input 1122-1 is a selection of the respective suggestion from the one or more suggestions 1124 (e.g., the user 1104 selects the respective suggestion from the one or more suggestions 1124). For example, the user 1104 reviews and refines the one or more suggestions 1124 for the graph schema 1126. The user 1104 further provides the first user input 1122-1 as feedback to the graph schema generator 1102 by confirming new vertices and/or new edges, which are not currently present in the graph schema 1126. In particular, the first user input 1122-1 helps to fine-tune the graph schema 1126 according to specific requirements and insights of the user 1104. The graph schema generator 1102 further updates, based on the first user input 1122-1 (e.g., the selection of the respective suggestion), the graph schema 1126. The graph schema generator 1102 further outputs the updated graph schema 1128 (e.g., creating a JSON file). In some embodiments, the one or more suggestions 1124 include a plurality of suggestions. Each suggestion of the plurality of suggestions identify one or more vertices (e.g., v₁, v₂, v₃, . . . , vₘ; m is an integer greater than 1) and/or one or more edges (e.g., e₁, e₂, e₃, . . . , eₙ; n is an integer greater than 1). In some embodiments, when the one or more vertices and/or the one or more edges identified by the one or more suggestions 1124 are unwanted (e.g., as later shown FIG. 16E, a subset of a plurality of suggestions 1636 is unwanted by the user 1104), the user 1104 creates the first user input 1122-1 to select a respective suggestion from the plurality of suggestions 1636, thereby eliminating the unwanted suggestion(s) from the updated graph schema 1128. In some embodiments, when the one or more vertices and/or the one or more edges identified by the one or more suggestions 1124 are invalid (e.g., disconnected vertex, redundant edge, edge with undefined vertices, etc.), the user 1104 creates the first user input 1122-1 to remove the one or more suggestions 1124, prompting the graph schema generator 1102 to regenerate suggestions, thereby ensuring the accuracy and relevance of graph schema(s) (e.g., graph schema 1126, updated graph schema 1128). In some embodiments, suggestion(s) generated by the rule-based suggestion model 1116 of the graph schema suggestion model 1112 is unlikely to create invalid vertex/vertices and/or edge(s). For example, invalid vertex/vertices and/or edge(s) are rejected and filtered out based on predefined rules and heuristics of the rule-based suggestion model 1116.

In some embodiments, the plurality of data tables 1130 are randomly selected from original data tables (e.g., data tables used for generating graph schemas and performing graph queries) stored in the database 1106 to form a subset (e.g., a segment) of the original data tables. For example, when the original data tables are significantly large (e.g., several gigabytes (GBs) in size), the graph schema generator 1102 is configured to partially select a subset of the original data tables, thereby reducing memory usage and increasing processing efficiency. In some embodiments, the plurality of data tables 1130 include metadata of original data tables (e.g., data tables used for generating graph schemas and performing graph queries) stored in the database 1106. In some circumstances, when the original data tables stored in the database 1106 are significantly large (e.g., several gigabytes (GBs) in size), the graph schema generator 1102 is configured to receive the metadata instead of the entire original data tables, thereby reducing memory usage and increasing processing efficiency. In some embodiments, the metadata of the original data tables stored in the database 1106 include maximum and/or minimum value(s) of each column of the original data tables. The maximum and/or minimum value(s) can be used to quickly retrieve the metadata from the database 1106. In some circumstances, the maximum and/or minimum value(s) of each column of the original data tables are predetermined.

In some embodiments, updating the graph schema 1126 includes adding the respective subset of the at least one of the group consisting of the one or more vertices (e.g., v₁, v₂, v₃, . . . , vₘ; m is an integer greater than 1) and the one or more edges (e.g., e₁, e₂, e₃, . . . , eₙ; n is an integer greater than 1) into the graph schema 1126. For example, the respective suggestion (e.g., S₂) of the one or more suggestions 1124 identifies the vertex v₂ and/or the edge e₂, which is the respective subset of the one or more vertices (e.g., v₁, v₂, v₃, . . . , vₙ) and/or the one or more edges (e.g., e₁, e₂, e₃, . . . , eₘ). The graph schema generator 1102 adds the vertex v₂ and/or the edge e₂ that are identified by the respective suggestion into the graph schema 1126 to form the updated graph schema 1128.

In some embodiments, a user request (e.g., pressing/clicking a button on a graphical user interface, speaking a command to a microphone, selecting an option from a dropdown menu, tapping an icon on a touchscreen device, etc.) is required to initiate the automated graph schema generation. The graph schema generator 1102 receives a user request 1132 from the user 1104 for accessing data tables. The graph schema generator 1102 further sends the user request 1132 to the database 1106. In response to the user request 1132, the database 1106 sends the plurality of data tables 1130 to the graph schema generator 1102.

In some embodiments, the graph visualization module 1118 displays, via the graphical interface 1120, the one or more suggestions 1124 for the user 1104 to select a respective suggestion for expanding vertices and edges and updating the graph schema 1126. In some embodiments, the graph visualization module 1118 displays, via the graphical interface 1120 and based on at least one of the graph schema 1126 or the updated graph schema 1128, a graph-based representation to the user 1104. In some embodiments, the user 1104 determines, based on the graph-based representation of the graph schema 1126 or the updated graph schema 1128, that a respective suggestion for expanding a vertex or an edge is invalid (e.g., disconnected vertex, redundant edge, edge with undefined vertices, etc.). In this circumstance, the user 1104 interrupts the graph schema generator 1102 and manually fixes the graph schema 1126 or the updated graph schema 1128. As discussed above, in some embodiments, suggestion(s) generated by the rule-based suggestion model 1116 of the graph schema suggestion model 1112 is unlikely to create invalid vertex/vertices and/or edge(s). For example, invalid vertex/vertices and/or edge(s) are rejected and filtered out based on predefined rules and heuristics of the rule-based suggestion model 1116.

In some embodiments, the operations (e.g., receiving the plurality of data tables 1130, receiving the graph schema 1126, generating the one or more suggestions 1124, the receiving the first user input 1122-1, updating the graph schema 1126, and outputting the updated graph schema 1128) executed by the graph schema generator 1102 are performed via an application or a user interface. For example, as later shown in FIGS. 16A-16H, a user interface allows the user 1104 to provide user inputs in response to suggestions generated by the graph schema generator 1102. In some embodiments, the application and/or the user interface are communicatively coupled to external resources through APIs.

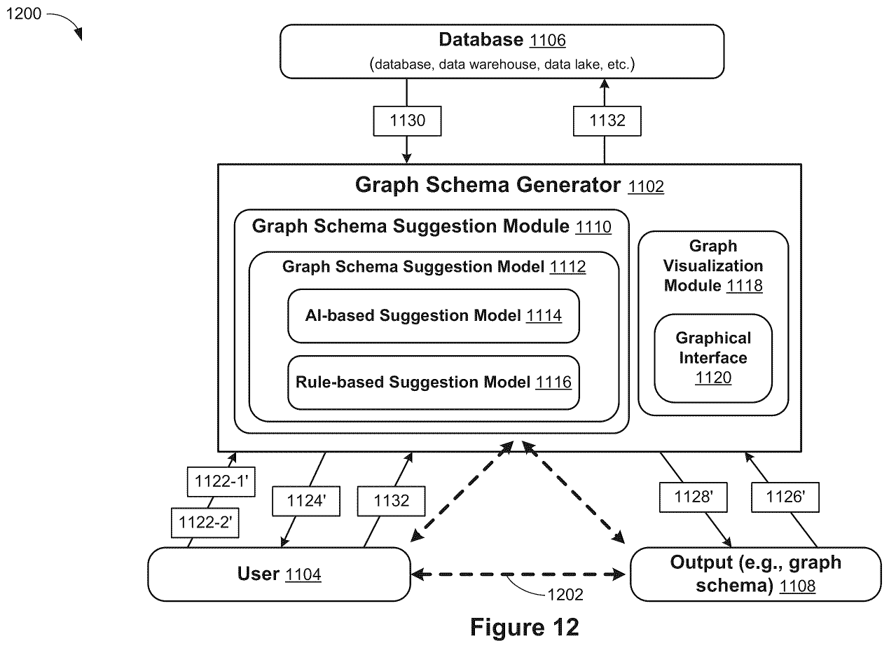

FIG. 12 illustrates an example schema generation system 1200 that iteratively expands vertices and edges of a graph schema based on automated graph schema generation, in accordance with some embodiments. The example schema generation system 1200 includes a plurality of iterations 1202 to expand vertices and edges associated with a graph schema. In particular, the graph schema generator 1102 expands the graph schema by adding vertices and their associated edges. The plurality of iterations 1202 proceed as new edges and vertices are suggested, evaluated, and incorporated into the graph schema. In some embodiments, the iterative process ensures that the graph schema meets required criteria (e.g., scalability, redundancy minimization, normalization, etc.) and is optimized for various applications (e.g., fraud detection, recommendation system, social network analysis, supply chain management, bioinformatics, etc.). In some embodiments, the graph schema generator 1102 is configured to generate the auxiliary component 303, the graph schema file(s), and/or other graph schema(s) described above in reference to FIGS. 1-10Q.

More specifically, in some embodiments, the graph schema generator 1102 iteratively receives a respective graph schema 1126′ (e.g., a partial graph schema that defines a subset of vertices and edges associated with the plurality of data tables 1130). The graph schema generator 1102 further automatically generates a respective suggestion 1124′ that identifies respective vertex/vertices and/or respective edge(s). The graph schema generator 1102 further receives a respective first user input 1122-1′. In particular, the respective first user input 1122-1′ is a user selection of the respective suggestion 1124′ to confirm the respective vertex/vertices and/or respective edge(s) be added into the respective graph schema 1126′. The graph schema generator 1102 further updates the respective graph schema 1126′ for the plurality of iterations 1202 to expand vertices and edges associated with the respective graph schema 1126′. Each iteration of the plurality of iterations 1202 corresponds to a respective updated graph schema 1128′, where each edge links two vertices.

In some embodiments, the graph schema suggestion model 1112 (e.g., a computational model) of the graph schema suggestion module 1110 includes a plurality of models (e.g., the AI-based suggestion model 1114 and the rule-based suggestion model 1116). In each iteration of the plurality of iterations 1202, the graph schema generator 1102 receives a respective second user input 1122-2′ for selecting a respective model (e.g., the AI-based suggestion model 1114 or the rule-based suggestion model 1116) from the plurality of models. In response to the respective second user input 1122-2′, the graph schema generator 1102 automatically generates, based on the plurality of data tables 1130 and the respective graph schema 1126′, the respective suggestion 1124′ using the respective model. For example, during one iteration of the plurality of iterations 1202, the user 1104 decides to switch from the AI-based suggestion model 1114 to the rule-based suggestion model 1116 after reviewing a visual graph-based representation of the respective graph schema 1126′. In response to the respective second user input 1122-2′ that indicates the determination of the user 1104, the graph schema generator 1102 executes the rule-based suggestion model 1116 instead of the AI-based suggestion model 1114 to automatically generate the respective suggestion 1124′.

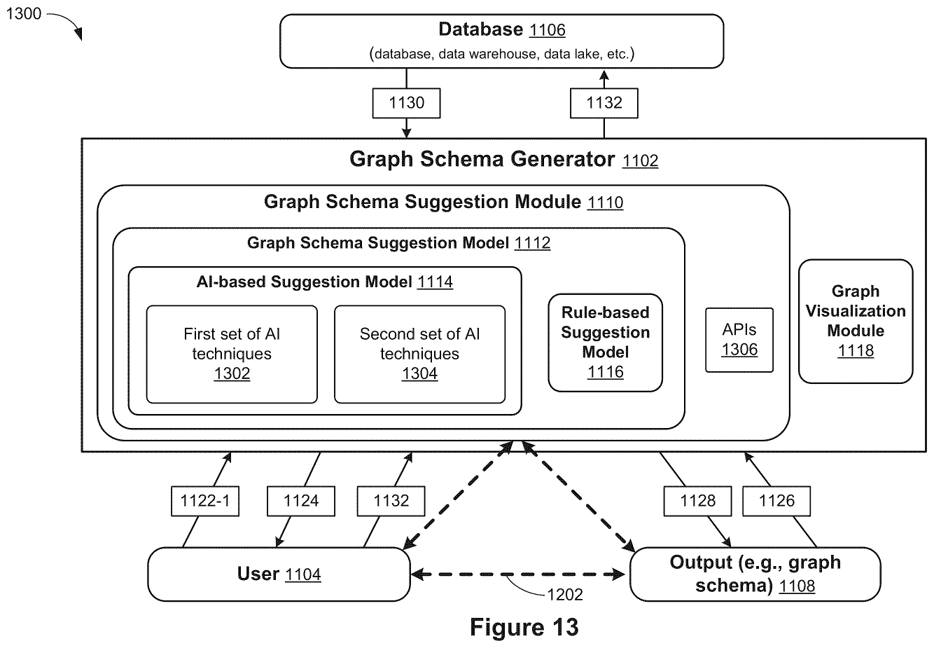

FIG. 13 illustrates an example schema generation system 1300 that includes an AI-based suggestion model 1114 with various functionalities for generating suggestions associated with a graph schema, in accordance with some embodiments. The AI-based suggestion model 1114 is configured to generate the one or more suggestions 1124 associated with the graph schema 1126 using various AI techniques. The AI-based suggestion model 1114 of the example schema generation system 1300 includes a first set of AI techniques 1302 and a second set of AI techniques 1304. In some embodiments, the graph schema generator 1102 is configured to generate the auxiliary component 303, the graph schema file(s), and/or other graph schema(s) described above in reference to FIGS. 1-10Q.

More specifically, in some embodiments, the first set of AI techniques 1302 is configured to execute multimodal large language models (e.g., MLLMs). In particular, the MLLMs are fine-tuned to improve accuracy and relevance for generating the one or more suggestions 1124. In some embodiments, the MLLMs implement AI techniques, such as retrieval-augmented generation and prompt engineering, to integrate capabilities of multiple modalities, thereby enhancing the ability of the AI-based suggestion model 1114 to process the data tables 1130 and generate more precise and comprehensive suggestions. In some embodiments, the graph schema suggestion model 1112 of the graph schema generator 1102 includes APIs 1306 communicatively coupled to external computation resources (e.g., external MLLMs). In particular, the AI-based suggestion model 1114 is configured to access the external computation resources via the APIs 1306. In some embodiments, developing custom-built MLLMs is a preferred option as it allows for capabilities such as fine-tuning. In some embodiments, executing external computation resources (e.g., external MLLMs) via the APIs 1306 is a preferred option because of cost efficiency.

More specifically, in some embodiments, the second set of AI techniques 1304 is configured to execute various supplementary algorithms to generate the one or more suggestions 1124. In some embodiments, the supplementary algorithms include a natural language processing (NLP) (e.g., relationship extraction, knowledge graph construction) configured to identify and map relationships within the data tables 130. In some embodiments, the supplementary algorithms further include a keyword-based search technique configured to extract relevant information and context from the data tables 130. In some embodiments, the supplementary algorithms of the second set of AI techniques 1304 work in conjunction with the MLLMs of the first set of AI techniques 1302 to provide a robust and multi-faceted approach to generate the one or more suggestions 1124.

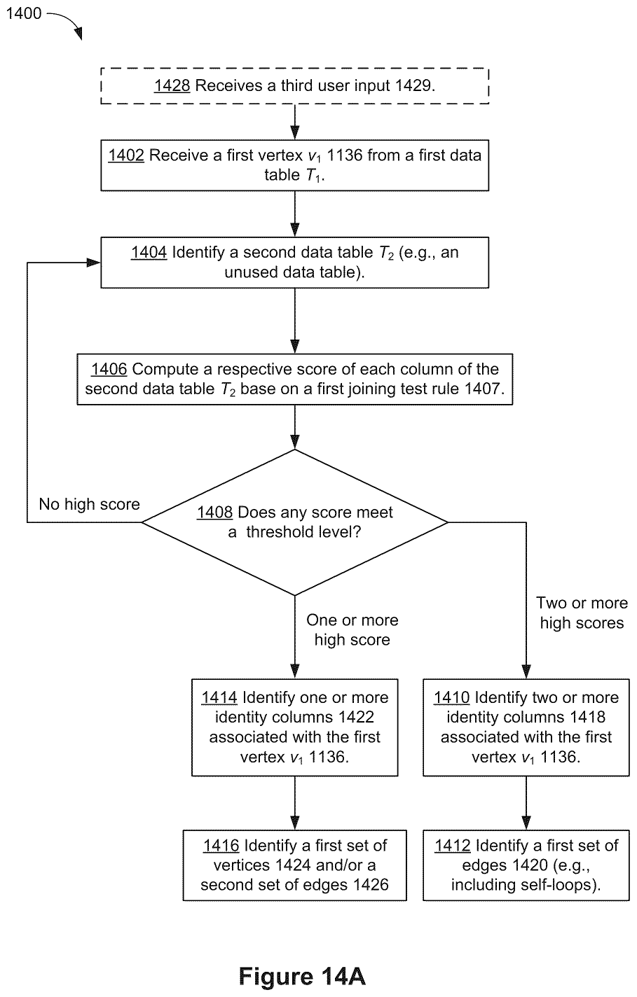

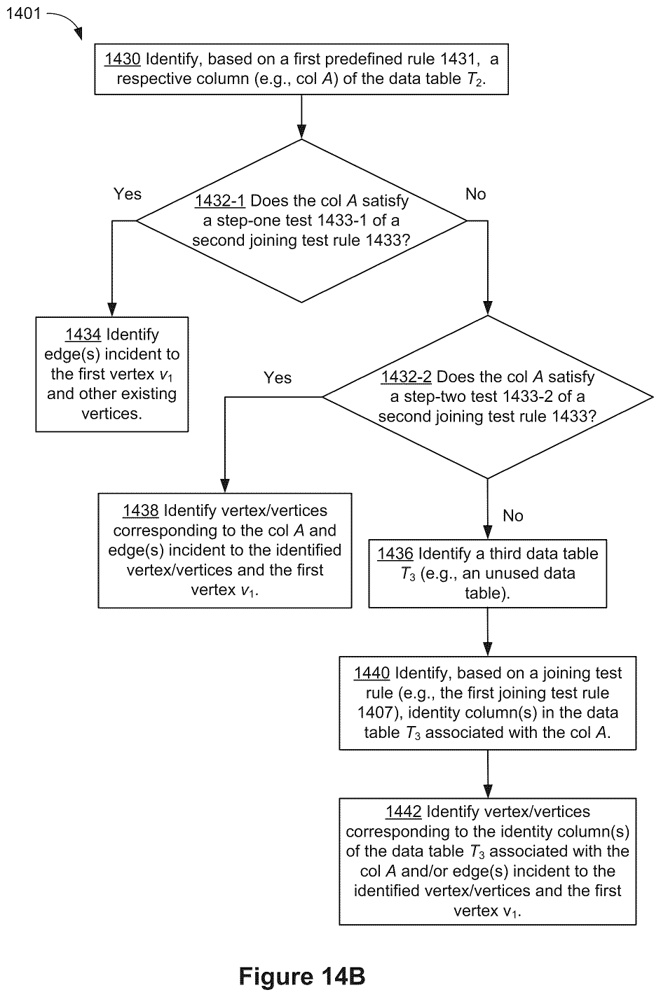

FIG. 14A is a flow chart 1400 of the rule-based suggestion model 1116 that expands vertices and edges associated with a graph schema, in accordance with some embodiments. In particular, the flow chart 1400 illustrates the plurality of iterations 1202 to automatically generate the one or more suggestions 1124 to the user 1104 and update the graph schema 1126 by adding new vertices and edges based on the first user input 1122-1. In some embodiments, the rule-based suggestion model 1116 implements a plurality of predefined rules (e.g., joining test rules, dependency rules, validation rules, matching rules, conditional join rules, etc.). In some embodiments, the plurality of predefined rules of the rule-based suggestion model 1116 includes a first joining test rule 1407 that determines whether records, attributes, and/or fields of different tables meet criteria (e.g., matching criteria) when joined or compared. In particular, the first joining test rule 1407 includes comparing data types, comparing column names, and tests of joining for tables.

In some embodiments, the rule-based suggestion model 1116 receives (operation 1402) the first vertex v₁ 1136 from the first data table T₁ 1134 of the plurality of data tables 1130. The rule-based suggestion model 1116 further identifies (operation 1404) a second data table T₂ (e.g., an unused data table) of the plurality of data tables 1130. The second data table T₂ is distinct from the first data table T₁ 1134. The rule-based suggestion model 1116 further receives columns of the second data table T₂, which are critical components for identifying relationships between vertices and edges. The rule-based suggestion model 1116 further computes (operation 1406), for each column of the second data table T₂ and based on the first joining test rule 1407, a respective score (e.g., based on points, percentages, or other types of scoring mechanisms). The rule-based suggestion model 1116 further determines (operation 1408) whether a respective score for each column of the second data table T₂ meets a threshold level (e.g., a point level, a percentage level, or other types of threshold levels). In particular, the rule-based suggestion model 1116 determines whether a respective column of the second data table T₂ is an identity column associated with the first vertex v₁ 1136. In accordance with a determination that the second data table T₂ includes no column having scores that meet the threshold level, the rule-based suggestion model 1116 identifies no identity column associated with the first vertex v₁ 1136. In particular, the rule-based suggestion model 1116 takes no further action on the second data table T₂ and identifies (operation 1404) another table (e.g., another unused data table) of the plurality of data tables 1130, distinct from the first data table T₁ and the second data table T₂. Moreover, in accordance with a determination that the second data table T₂ includes two or more columns having scores that meet the threshold level, the rule-based suggestion model 1116 identifies (operation 1410) two or more identity columns 1418 associated with the first vertex v₁ 1136. The rule-based suggestion model 1116 further identifies (operation 1412), based on at least the two or more identity columns 1418 of the second data table T₂, a first set of edges 1420 (e.g., including self-loops) for the first vertex v₁ 1136 to automatically form a first suggestion corresponding to the identified first set of edges 1420. In some embodiments, the first set of edges 1420 includes self-loop(s) (e.g., edge 1634-1 in reference to FIG. 16G). For example, when two identity columns of the second data table T₂ are associated with the first vertex v₁ 1136, the graph schema generator 1102 determines that these two identity columns form a self-loop based on the first vertex v₁ 1136. Further, in accordance with a determination that the second data table T₂ includes one or more columns having scores that meet the threshold level, the rule-based suggestion model 1116 identifies (operation 1414) one or more identity columns 1422 associated with the first vertex v₁ 1136. The rule-based suggestion model 1116 further identifies (operation 1416), based on at least the one or more identity columns 1422 columns of the second data table T₂, a first set of vertices 1424 and/or a second set of edges 1426 to automatically form a second suggestion corresponding to the identified first set of vertices 1424 and/or second set of edges 1426. The first set of vertices 1424 is distinct from the first vertex v₁ 1136.

In some embodiments, the rule-based suggestion model 1116 determines whether the identified first set of vertices 1424 and/or second set of edges 1426 are already in the graph schema 1126. In accordance with a determination that the identified first set of vertices 1424 and/or second set of edges 1426 are not in the graph schema 1126, the rule-based suggestion model 1116 adds the first set of vertices 1424 and/or the second set of edges 1426 to the first vertex v₁ 1136. In some embodiments, an identity column (e.g., an identity column of the second data table T₂ associated with the first vertex v₁ 1136) refers to a unique identifier or a primary key for each record or row within a data table of the polarity of the data tables 1130. The unique identifier is distinct and easily retrievable.

In some embodiments, the rule-based suggestion model 1116 of the graph schema generator 1102 receives (operation 1428) a third user input 1429 for identifying an initial vertex (e.g., the first vertex v₁) from the plurality of data tables 1130. In response to the third user input 1429, the graph schema generator 1102 automatically generates the graph schema 1126 including the initial vertex (e.g., the first vertex v₁). Receiving the third user input 1429 is to ensure that the graph schema 1126 includes at least one vertex for iterative expansion of vertices and edges. In some embodiments, receiving the third user input 1429 is optional.

FIG. 14B is a flow chart 1401 of the rule-based suggestion model 1116 that further illustrates the operation 1416 of the flow chart 1400, in accordance with some embodiments. In particular, the flow chart 1401 illustrates a process of identifying the first set of vertices 1424 and/or the second set of edges 1426 to be added into the graph schema 1126. In some embodiments, the plurality of predefined rules of the rule-based suggestion model 1116 includes a first predefined rule 1431 and a second joining test rule 1433. The first predefined rule 1431 determines whether a respective column has a predefined data type or name. Stated another way, in some embodiments, the first predefined rule 1431 determines whether a respective column is an identity column that indicates a vertex, not an edge. The second joining test rule 1433 determines whether records, attributes, and/or fields of different tables meet criteria (e.g., matching criteria) when joined or compared. In particular, the second joining test rule 1433 includes comparing columns of a data table with existing vertex identities and comparing data types and names. In some embodiments, the second joining test rule 1433 includes a step-one test 1433-1 and a step-two test 1433-2 (discussed below).

In some embodiments, the rule-based suggestion model 1116 identifies (operation 1430), based the first predefined rule 1431, a respective column (e.g., a column A) of the second data table T₂. The column A is distinct from the one or more identity columns (e.g., identified in the operation 1414). The rule-based suggestion model 1116 further determines (operation 1432-1) whether the column A satisfies the step-one test 1433-1 (e.g., by comparing data types and/or names of a vertex (e.g., v₂) based on the column A with existing vertex/vertices including the first vertex v₁ 1136 in the graph schema 1126) of the second joining test rule 1433. In accordance with a determination that the column A satisfies the step-one test 1433-1 of the second joining test rule 1433, the rule-based suggestion model 1116 further identifies (operation 1434) edge(s), which is incident to (e.g., associated with) the first vertex v₁ 1136 and other existing vertices in the graph schema 1126, to automatically form a suggestion (e.g., the second suggestion) corresponding to the identified edge(s). In this circumstance, the edge(s) (e.g., identified through the operation 1434) for the graph schema 1126 is identified based on the second data table T₂. In some embodiments, the edge(s) identified through the operation 1434 is part of the second set of edges 1426. In accordance with a determination that the column A does not satisfy the step-one test 1433-1 of the second joining test rule 1433, the rule-based suggestion model 1116 further determines (operation 1432-2) whether the column A satisfies the step-two test 1433-2 of the second joining test rule 1433. In particular, the step-two test 1433-2 of the second joining test rule 1433 determines whether a suggestion for a vertex (e.g., v₂) corresponding to the column A can be formed based on the second data table T₂. In accordance with a determination that the column A satisfies the step-two test 1433-2 of the second joining test rule 1433, the rule-based suggestion model 1116 further identifies (operation 1438) vertex/vertices corresponding to the column A and edge(s) incident to (e.g., associated with) the identified vertex/vertices and the first vertex v₁ to automatically form a suggestion (e.g., the second suggestion). In this circumstance, the vertex/vertices and edge(s) (e.g., identified through the operation 1438) for the graph schema 1126 are identified based on the second data table T₂. In accordance with a determination that the column A does not satisfy the step-two test 1433-2 of the second joining test rule 1433, the rule-based suggestion model 1116 further identifies (operation 1436) a third data table T₃ (e.g., an unused data table) of the plurality of data tables 1130. Specifically, in some embodiments, the rule-based suggestion model 1116 enumerates all data tables of the plurality of data tables 1130 (e.g., by checking metadata of each data table of the plurality of data tables 1130 except the first data table T₁ and the second data table T₂) to identify the third data table T₃. The rule-based suggestion model 1116 further identifies (operation 1440), based on a joining test rule (e.g., the first joining test rule 1407), identity column(s) (e.g., different from the one or more identity columns 1422) of the third data table T₃ associated with the column A. The rule-based suggestion model 1116 further identifies (operation 1442) vertex/vertices corresponding to the identity column(s) of the third data table T₃ associated with the column A and edges incident to (e.g., associated with) the identified vertex/vertices and the first vertex v₁ to automatically form a suggestion (e.g., the second suggestion). In this circumstance, the vertex/vertices and/or edge(s) (e.g., identified through the operation 1442) for the graph schema 1126 are identified based on the third data table T₃. In some embodiments, the vertex/vertices and/or edge(s) identified through the operation 1442 are part of the first set of vertices 1424 and/or the second set of edges 1426. In some embodiments, the vertex/vertices and edge(s) identified through the operation 1438 are part of the first set of vertices 1424 and/or the second set of edges 1426. In some embodiments, the flow chart 1401 is repeated for remaining columns (e.g., including the column A) of the second data table T₂ that are distinct from the one or more identity columns 1422. This is to ensure that all potential relationships within the second data table T₂ are explored to update the graph schema 1126. In some embodiments, in operations 1436 and/or 1438, the rule-based suggestion model 1116 enumerates all data tables and/or all metadata of the plurality of data tables 1130. In some embodiment, the rule-based suggestion model 1116 subsequently or concurrently performs operation 1436 even when the column A satisfies the step-two test 1433-2 of the second joining test rule 1433, such that the rule-based suggestion model 1116 enumerates all data tables and/or all metadata of the plurality of data tables 1130.

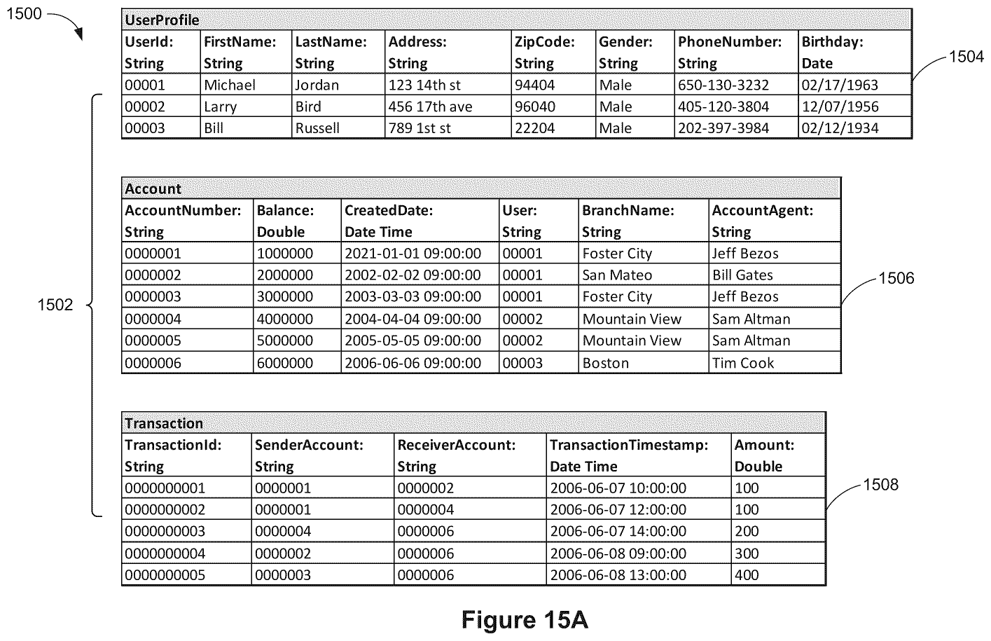

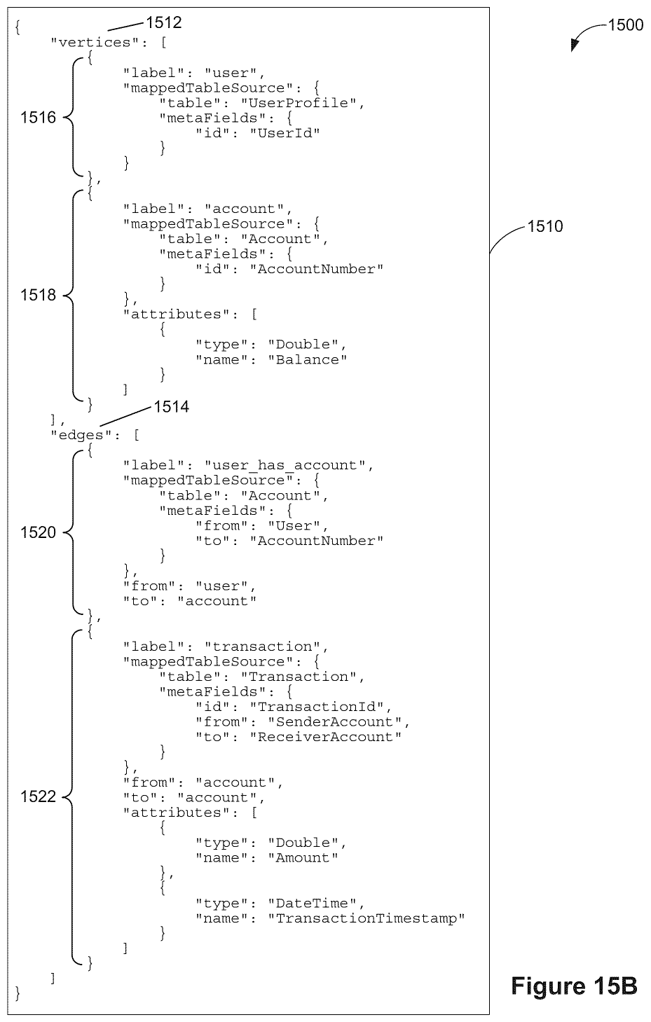

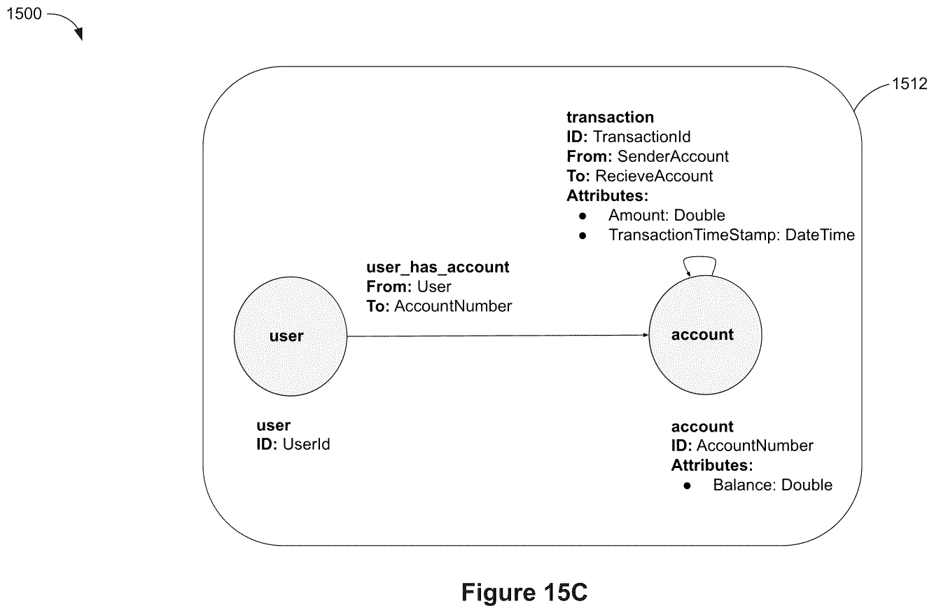

FIGS. 15A-15C illustrate an example transaction trace 1500 used for generating schema graphs, in accordance with some embodiments. In particular, FIG. 15A illustrates a plurality of transaction trace data tables 1502 from a relational database, FIG. 15B illustrates a graph schema 1510 associated with the plurality of transaction trace data tables 1502, and FIG. 15C illustrates a visual graph-based representation 1512 of the graph schema 1510. In some embodiments, the visual graph-based representation 1512 illustrates relationships between entities defined in the graph schema 1510.

In some embodiments, the plurality of transaction trace data tables 1502 includes three data tables: a UserProfile data table 1504, an Account data table 1506, and a Transaction data table 1508. Specifically, the UserProfile data table 1504 includes (i) three records corresponding to three users (e.g., Users 00001, 00002, and 00003, as account holders), and (ii) eight columns with different data types (e.g., UserId [String], FirstName [String], LastName [String], Address [String], ZipCode [String], Gender [String], PhoneNumber [String], and Birthday [Date], as information associated with the account holders). The Account data table 1506 includes (i) six records corresponding to six accounts (e.g., Accounts 0000001, 0000002, 0000003, 0000004, 0000005, and 0000006, as account numbers), and (ii) six columns with different data types (e.g., AccountNumber [String], Balance [Double], CreatedDate [DateTime], User [String], BranchName [String], and AccountAgent [String], as information associated with the account numbers). The Transaction data table 1508 includes (i) five records corresponding to five transactions (e.g., Transactions 0000000001, 0000000002, 0000000003, 0000000004, and 0000000005, as transaction numbers), and (ii) five columns with data types (e.g., TransactionId [String], SenderAccount [String], ReceiverAccount [String], TransactionTimestamp [DateTime], and Amount [Double], as information associated with the transaction numbers). In some embodiments, the UserProfile data table 1504, the Account data table 1506, and the Transaction data table 1508 are stored in a tabular format.

In some embodiments, the graph schema 1510 is a JSON file defining a hierarchy of target entities. The target entities of the example transaction trace 1500 include selected attributes from the UserProfile data table 1504, the Account data table 1506, and the Transaction data table 1508. Specifically, the graph schema 1510 includes a “vertices” array 1512 that defines vertices and an “edges” array 1514 that defines edges. The “vertices” array 1512 includes a “user” object 1516 and an “account” object 1518. The “user” object 1516 has an identity that corresponds to the UserId column of the UserProfile data table 1504 and does not include attributes. The “account” object 1518 has an identity that corresponds to the AccountNumber column of the Account data table 1506 and includes a “Balance” attribute that corresponds to the Balance column of the Account data table 1506. The “edges” array 1514 defines relationships between vertices. The “edges” array 1514 includes a “user_has_account” object 1520 and a “transaction” object 1522. The “user_has_account” object 1520 represents relationships between the users (e.g., three users named Users 00001, 00002, and 00003) and their accounts. The “user_has_account” object 1520 includes a plurality of directions identifying respective transactions from respective users to respective accounts. The respective users and the respective accounts correspond to the User column and the AccountNumber column of the Account data table 1506, respectively. The “user_has_account” object 1520 does not include attributes. The “transaction” object 1522 represents transactions between accounts, defining respective directions from respective sender accounts to respective receiver accounts. The respective sender accounts and the respective receiver accounts correspond to the SenderAccount column and the ReceiverAccount column of the Transaction data table 1508. The “transaction” object 1522 includes an “Amount” attribute and a “TransactionTimestamp” attribute that corresponds to the Amount column and the TransactionTimestamp column of the Transaction data table 1508, respectively.

FIGS. 16A-16H illustrate an example schema generation 1600 using the example transaction trace 1500, in accordance with some embodiments. The example schema generation 1600 is performed using the rule-based suggestion model 1116. In particular, for a plurality of iterations, the rule-based suggestion model 1116 automatically and systematically generates suggestions to the user 1104 that identify new vertices and edges for a graph schema, and updates the graph schema based on the user input (e.g., the respective first user input 1122-1′) by expanding vertices and edges. In some embodiments, the schema generation process based on iterations ensures comprehensive and accurate representation of relationships between vertices and edges associated with data tables (e.g., the plurality of data tables 1130).

As shown in FIG. 16A, the rule-based suggestion model 1116 receives (e.g., the operation 1402) a first vertex “user” 1620 from the UserProfile data table 1504 of the plurality of transaction trace data tables 1502. The first vertex “user” 1620 corresponds to the UserId column of the UserProfile data table 1504. In particular, the graph schema generator 1102 automatically generates an initial graph schema 1602-1 including the first vertex “user” 1620 and displays, based on the initial graph schema 1602-1 and via the graphical interface 1120, an initial graph-based representation 1604-1. In some embodiments, the rule-based suggestion model 1116 receives (e.g., the operation 1428) a user input (e.g., the third user input 1429) for identifying the first vertex “user” 1620 from the plurality of transaction trace data tables 1502. In response to the user input, the graph schema generator 1102 automatically generates the initial graph schema 1602-1 including the first vertex “user” 1620. In some embodiments, receiving the first vertex “user” 1620 through the user input is to ensure that the graph schema 1126 includes at least one vertex for iterative expansion of vertices and edges associated with the plurality of transaction trace data tables 1502. In some embodiments, receiving the user input for identifying the first vertex “user” 1620 is optional.

Moreover, the rule-based suggestion model 1116 identifies (e.g., the operation 1404) the Transaction data table 1508 (e.g., an unused data table) of the plurality of transaction trace data tables 1502. The Transaction data table 1508 is distinct from the UserProfile data table 1504. In some embodiments, the Transaction data table 1508 is automatically identified (e.g., selected) by the rule-based suggestion model 1116 from the plurality of transaction trace data tables 1502. The rule-based suggestion model 1116 further computes (e.g., the operation 1406), for each column (e.g., TransactionId column, SenderAccount column, ReceiverAccount column, TransactionTimestamp column, and Amount column) of the Transaction data table 1508 and based on the first joining test rule 1407, a respective score (e.g., pass, no pass, etc.). The rule-based suggestion model 1116 further determines (e.g., the operation 1408) whether a respective score for each column of the Transaction data table 1508 meets a threshold level (e.g., a point level, a percentage level, or other types of threshold levels). No column of the Transaction data table 1508 achieves a high score to meet the threshold level, because the columns of the Transaction data table 1508 do not match the UserId column of the UserProfile data table 1504 associated with the first vertex “user” 1620 by comparing data types, column names, or strings. In accordance with a determination that the Transaction data table 1508 includes no column having scores that meet the threshold level, the rule-based suggestion model 1116 identifies no identity column associated with the vertex “user” 1620. The rule-based suggestion model 1116 takes no further action on the Transaction data table 1508.

Further, the rule-based suggestion model 1116 identifies (e.g., the operation 1404) the Account data table 1506 (e.g., another unused data table) of the plurality of transaction trace data tables 1502. The Account data table 1506 is distinct from the UserProfile data table 1504 and the Transaction data table 1508. In some embodiments, the Account data table 1506 is automatically identified (e.g., selected) by the rule-based suggestion model 1116 from the plurality of transaction trace data tables 1502. The rule-based suggestion model 1116 further computes (e.g., the operation 1406), for each column (e.g., AccountNumber, Balance, CreatedDate, User, BranchName, and AccountAgent) of the Account data table 1506 and based on the first joining test rule 1407, a respective score (e.g., pass, no pass, etc.). The rule-based suggestion model 1116 further determines (e.g., the operation 1408) whether a respective score for each column of the Account data table 1506 meet a threshold level (e.g., a point level, a percentage level, or other types of threshold levels). The User column achieves the highest score among scores of other columns, because only the User column passes rules (e.g., type checking, name checking, and/or other tests of joining with the User column of the UserProfile data table 1504) of the first joining test rule 1407. The remaining columns of the Account data table 1506 do not achieve scores meeting the threshold level. In accordance with a determination that the Account data table 1506 includes one column (e.g., the User column) having a respective score that meet the threshold level, the rule-based suggestion model 1116 identifies (e.g., the operation 1414) the User column as an identity column associated with the first vertex “user” 1620. The rule-based suggestion model 1116 further identifies (e.g., the operation 1416), based on at least the User column, vertex/vertices and/or edge(s) to automatically form a suggestion to the user 1104. The identified vertex/vertices is distinct from the first vertex “user” 1620.

More specifically, since only one identity column (e.g., the User column), the rule-based suggestion model 1116 moves to the operation 1430. The rule-based suggestion model 1116 identifies (e.g., the operation 1430), based on a first predefined rule (e.g., type of a column is numeric string), the AccountNumber column (e.g., “column A”) of the Account data table 1506. The AccountNumber column is distinct from the identity column (e.g., the User column). The rule-based suggestion model 1116 further determines (e.g., the operation 1432-1) whether the AccountNumber column satisfies the step-one test 1433-1 of the second joining test rule 1433 (e.g., by comparing data types and/or names of a vertex based on the AccountNumber column with existing vertex/vertices including the first vertex “user” 1620 in the initial graph schema 1602-1). The AccountNumber column does not satisfy the step-one test 1433-1 of the second joining test rule 1433, because it does not pass type checking, name checking, and/or other tests of joining with the existing identity column (e.g., the User column). The rule-based suggestion model 1116 further determines (e.g., the operation 1432-2) whether the AccountNumber column satisfies the step-two test 1433-2 of the second joining test rule 1433 (e.g., whether a suggestion for a vertex corresponding to the AccountNumber column can be formed based on the Account data table 1506). In accordance with a determination that the AccountNumber column satisfies the step-two test 1433-2 of the second joining test rule 1433, the rule-based suggestion model 1116 further identifies (e.g., the operation 1438) a vertex corresponding to the AccountNumber column and an edge incident to (e.g., associated with) the identified vertex and the first vertex “user” 1620 to form a suggestion. Subsequently or concurrently, the rule-based suggestion model 1116 further identifies (e.g., operation 1436) another unused data table from the plurality of transaction trace data tables 1502. For example, the Transaction data table 1508 is identified as an unused data table in the operation 1436 (e.g., the Transaction data table 1508 was used in the operations 1404, 1406, and 1408 for identifying identity column(s) based on the first vertex “user” 1620, but the Transaction data table 1508 has not been used in operations associated with the AccountNumber column (e.g., “column A”) of the Account data table 1506). The rule-based suggestion model 1116 further identifies (operation 1440), based on a joining test rule (e.g., the first joining test rule 1407), identity column(s) of the Transaction data table 1508 associated with the AccountNumber column. In accordance with a determination that the Transaction data table 1508 includes no identity column associated with the AccountNumber column, the rule-based suggestion model 1116 takes no further action on the Transaction data table 1508. For example, neither the SenderAccount column nor the ReceiveAccount column of the Transaction data table 1508 is an identity column, because each column includes redundant elements (e.g., Account 0000001 appears twice in the SenderAccount column, Account 0000006 appears three times in the ReceiveAccount column). In some embodiments, the operations 1430 and 1432 (e.g., operations 1432-1 and/or 1432-2) are repeated for the remaining columns (e.g., including the AccountNumber column) of the Account data table 1506 that are distinct from the User column. This is to ensure that all potential relationships within the Account data table 1506 are explored to update the initial graph schema 1602-1.

In some embodiments, as shown in FIG. 16B, the rule-based suggestion model 1116 automatically generates, based on the vertices corresponding to the User column, a plurality of suggestions 1622 including a “user_to_account” suggestion 1624 and an “account_to_user” suggestion 1626. The “user_to_account” suggestion 1624 identifies a vertex “account” 1628 (e.g., corresponding to the AccountNumber column of the Account data table 1506) and a “user_to_account” edge 1630 incident to the vertex “account” 1628 and the first vertex “user” 1620. Informative indicatives “From: User” and “To: AccountNumber” in the “user_to_account” suggestion 1624 indicate that the “user_to_account” suggestion 1624 provides an edge (e.g., the “user_to_account” edge 1630) making a connection from the first vertex “user” 1620 to the vertex “account” 1628. Similarly, the “account_to_user” suggestion 1626 identifies the vertex “account” 1628 and an “account_to_user” edge 1631 incident to the vertex “account” 1628 and the first vertex “user” 1620. Informative indicatives “From: AccountNumber” and “To: User” in the “account_to_user” suggestion 1626 indicate that the “account_to_user” suggestion 1626 provides an edge (e.g., the “account_to_user” edge 1631) making a connection from the vertex “account” 1628 to the first vertex “user” 1620. Moreover, the informative indicatives “From: User” and “To: User” correspond to the column name of the User column of the Account data table 1506. The informative indicatives “From: AccountNumber” and “To: AccountNumber” correspond to the column name of the AccountNumber column of the Account data table 1506. Additionally, as shown in FIG. 16B, the graph schema generator 1102 automatically displays the “user_to_account” suggestion 1624 and the “account_to_user” suggestion 1626 via the graphical interface 1120 to the user 1104. The user 1104 generates a user input 1632 (e.g., the respective first user input 1122-1′) to select a respective suggestion from the “user_to_account” suggestion 1624 and the “account to user” suggestion 1626. In this circumstance, the user input 1632 is a selection of the “user_to_account” suggestion 1624.

In some embodiments, the user input 1632 further includes a respective selection of attribute(s) corresponding to the selected respective suggestion. As shown in FIG. 16C, the user 1104 selects a “Balance” attribute from a plurality of attributes associated with the selected “user_to_account” suggestion 1624.

In some embodiments, as shown in FIG. 16D, the rule-based suggestion model 1116 updates, based on the user input 1628, the initial graph schema 1602-1 to form a second graph schema 1602-2 (e.g., the updated initial graph schema 1602-1) including the vertex “account” 1628, the first vertex “user” 1620, and the “user_to_account” edge 1630. The graph schema generator 1102 automatically generates, based on the second graph schema 1602-2 and via the graphical interface 1120, a second graph-based representation 1604-2. In some embodiments, the graph schema generator 1102 outputs the second graph schema 1602-2 (e.g., creating a JSON file).

In some embodiments, the vertex “account” 1628 becomes a vertex for starting a new iteration for expanding vertices and edges and updating the second graph schema 1602-2. More specifically, in the new iteration, the rule-based suggestion model 1116 receives (e.g., the operation 1402) the vertex “account” 1628 from the Account data table 1506 of the plurality of transaction trace data tables 1502. The rule-based suggestion model 1116 further identifies (e.g., the operation 1404) the Transaction data table 1508 (e.g., an unused data table in the new iteration) of the plurality of transaction trace data tables 1502. The rule-based suggestion model 1116 further computes (e.g., the operation 1406), for each column (e.g., TransactionId column, SenderAccount column, ReceiverAccount column, TransactionTimestamp column, and Amount column) of the Transaction data table 1508 and based on the first joining test rule 1407, a respective score (e.g., pass, no pass, etc.). The rule-based suggestion model 1116 further determines (e.g., the operation 1408) whether a respective score for each column of the Transaction data table 1508 meets a threshold level (e.g., a point level, a percentage level, or other types of threshold levels). In accordance with a determination that the Transaction data table 1508 includes two columns, the SenderAccount column and the ReceiverAccount column, having scores that meet the threshold level, the rule-based suggestion model 1116 further identifies (e.g., the operation 1410) the SenderAccount column and the ReceiverAccount column as two identity columns. As shown in FIG. 16E, the rule-based suggestion model 1116 further identifies (e.g., the operation 1412), based on at least the two identity columns, edges 1634-1 and 1634-2 (e.g., including self-loops) for the vertex “account” 1628 to automatically form a plurality of suggestions 1636. Moreover, as shown in FIG. 16E, the graph schema generator 1102 automatically displays the plurality of suggestions 1636 (e.g., “SenderAccount_to_ReceiverAccount” and “ReceiverAccount_to_SenderAccount”) via the graphical interface 1120 to the user 1104. The user 1104 generates a user input 1638 (e.g., the respective first user input 1122-1′) to select a respective suggestion from the plurality of suggestions 1636. In this circumstance, the user input 1632 is a selection of the “SenderAccount_to_ReceiverAccount” suggestion 1636-1 associated with the “SenderAccount_to_ReceiverAccount” edge 1634-1. In some embodiments, the edges 1634-1 and 1634-2 are part of a set of edges identified by the rule-based suggestion model 1116 including “SenderAccount_to_ReceiverAccount,” “ReceiverAccount_to_SenderAccount,” “account_to_SenderAccount,” “account_to_ReceiverAccount,” “SenderAccount_to_account,” and Receiver to account.”

In some embodiments, the user input 1638 further includes a respective selection of attribute(s) corresponding to the selected respective suggestion. As shown in FIG. 16F, the user 1104 selects an “Amount” attribute and a “TransactionTimeStamp” attribute from a plurality of attributes associated with the selected “SenderAccount_to_ReceiverAccount” suggestion 1636-1.

In some embodiments, as shown in FIG. 16G, the rule-based suggestion model 1116 updates, based on the user input 1638, the second graph schema 1602-2 to form a third graph schema 1602-3 (e.g., the updated second graph schema 1602-2) including the vertex “account” 1628, the first vertex “user” 1620, the “user_to_account” edge 1630, and the “SenderAccount_to_ReceiverAccount” edge 1634-1. The graph schema generator 1102 automatically generates, based on the third graph schema 1602-3 and via the graphical interface 1120, a third graph-based representation 1604-3. In some embodiments, the graph schema generator 1102 outputs the third graph schema 1602-3 (e.g., creating a JSON file).

In some embodiments, as shown in FIG. 16H, the user 1104 modifies labels of the vertices and edges of the third graph-based representation 1604-3 displayed via the graphical interface 1120. For example, the user 1104 modifies a title label 1640 from “SenderAccount_to_ReceiverAccount” to “transaction.”

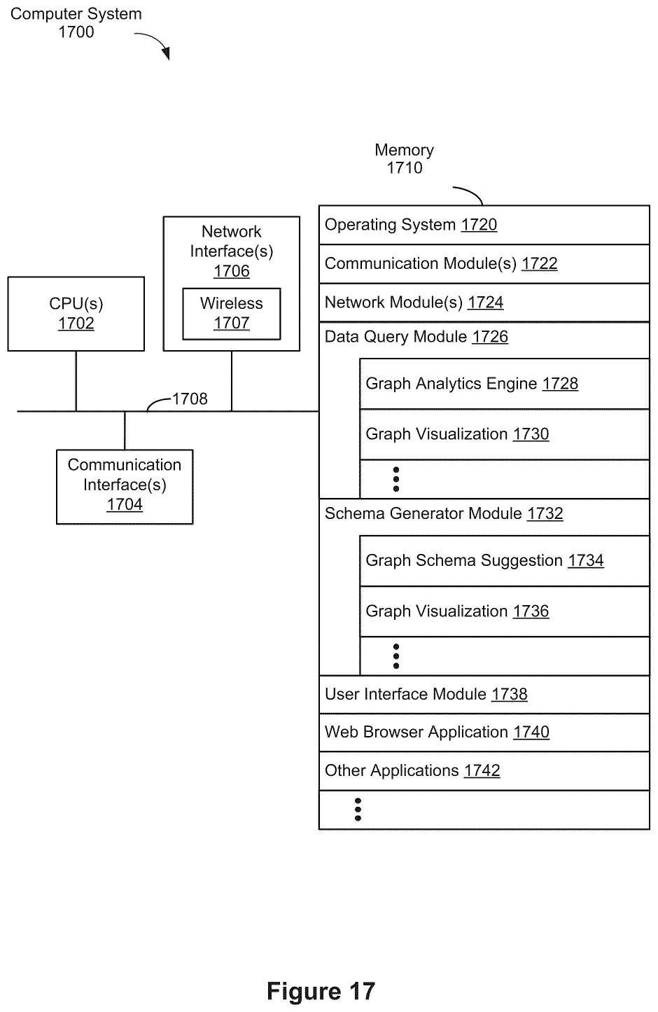

FIG. 17 is a block diagram illustrating a computer system 1700 that supports the data query system (e.g., the example data query systems 100 and 200, in references to FIGS. 1-2) and the schema generation system (e.g., the example schema generation systems 1100, 1200, and 1300, in reference to FIGS. 11-13), in accordance with some embodiments. The computer system 1700 includes one or more central processing units (CPU(s), i.e., processors or cores) 1702, one or more communication interfaces 1704, one or more network interfaces 1706, memory 1710, and one or more communication buses 1708 for interconnecting these components. The communication buses 1708 optionally include circuitry (e.g., a chipset) that interconnects and controls communications between system components.

In some embodiments, the one or more network interfaces 1706 include wireless and/or wired interfaces for communicating with databases (e.g., the to-be-queried databases 106 and 202, the database 1106, etc.) and other external resources (e.g., APIs, external data resources, external computation resources, etc.). In some embodiments, data communications are carried out using any of a variety of custom or standard wireless protocols (e.g., NFC, RFID, IEEE 802.117.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 1706 include a wireless interface 1707 for enabling wireless data communications with databases (e.g., the to-be-queried databases 106 and 202, the database 1106, etc.) and other external resources (e.g., APIs, external data resources, external computation resources, etc.). Furthermore, in some embodiments, the wireless interface 1707 (or a different communications interface of the one or more network interfaces 1706) enables data communications with other WLAN-compatible components (e.g., devices, servers, clouds, and/or other types) for displaying data, storing data, processing data, or other purposes related to data query.

Memory 1710 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 1710 may optionally include one or more storage devices remotely located from the CPU(s) 1702. Memory 1710, or alternately, the non-volatile memory solid-state storage devices within memory 1710, includes a non-transitory computer-readable storage medium. In some embodiments, memory 1710 or the non-transitory computer-readable storage medium of memory 1710 stores the following programs, modules, and data structures, or a subset or superset thereof:
an operating system 1720 that includes procedures for handling various basic system services and for performing hardware-dependent tasks;
communication module(s) 1722 for transmitting data, handling protocols (e.g., authentication/encryption), detecting error, and/or other functions;
network module(s) 1724 for connecting the data query system and the schema generation system to databases and other external resources, via the one or more network interfaces 1706 (wired or wireless);
a data query module 1726 associated with the data query system (e.g., the example data query systems 100 and 200, in references to FIGS. 1-2); In some embodiments, the data query module 1726 also includes the following sub-module(s), or a subset or superset thereof:
   a graph analytics engine sub-module 1728;
   a graph visualization sub-module 1730;
a schema generator module 1732 associated with the graph schema generator 1102; In some embodiments, the schema generation module 1732 also includes the following sub-module(s), or a subset or superset thereof:
   a graph schema suggestion sub-module 1734;
   a graph visualization sub-module 1736;
a user interface module 1738 that receives commands and/or inputs from a user via a user interface (e.g., from an input device) and provides outputs for display on the user interface (e.g., to an output device);
a web browser application 1740 for accessing, viewing, and interacting with web sites; and
other applications 1742, such as applications for word processing, calendaring, mapping, weather, time keeping, virtual digital assistant, presenting, number crunching (spreadsheets), drawing, instant messaging, e-mail, telephony, video conferencing, photo management, video management, and/or other purposes.

Each of the above identified modules stored in memory 1710 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. Likewise, although shown as stored in a single memory, the above-identified modules may be stored on physically separate memories and/or executed on physically separate (e.g., remote) devices. In some embodiments, memory 1710 optionally stores a subset or superset of the respective modules and data structures identified above. Furthermore, memory 1710 optionally stores additional modules and data structures not described above.

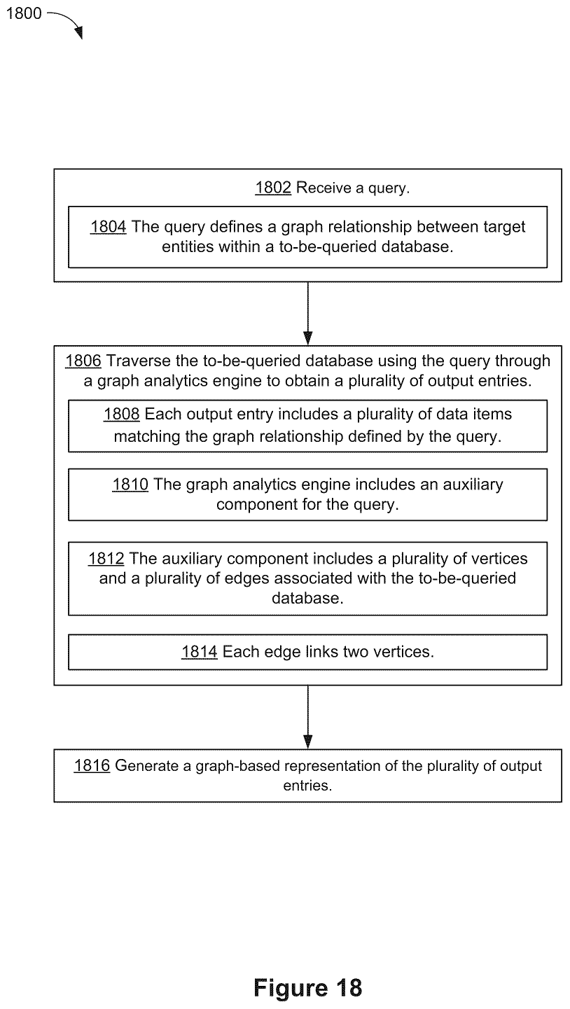

FIG. 18 illustrates a flow diagram of an example data query method 1800, in accordance with some embodiments. In some embodiments, the example data query method 1800 is performed at a computer system. In some embodiments, the data query method 1800 is governed by instructions that are stored in a non-transitory computer-readable storage medium and that are executed by one or more processors of the computer system.
(A1) The method 1800 includes receiving (operation 1802) a query. The query defines (operation 1804) a graph relationship between target entities within a to-be-queried database. The method 1800 further includes traversing (operation 1806) the to-be-queried database using the query through a graph analytics engine to obtain a plurality of output entries. Each output entry includes (operation 1808) a plurality of data items matching the graph relationship defined by the query. The graph analytics engine includes (operation 1810) an auxiliary component for the query. The auxiliary component includes (operation 1812) a plurality of vertices and a plurality of edges associated with the to-be-queried database. Each edge links (operation 1814) two vertices. The method 1800 further includes generating (operation 1816) a graph-based representation of the plurality of output entries.
(A2) In some embodiments of A1, traversing the to-be-queried database using the query through the graph analytics engine further comprises: mapping the query into a logical data plan in accordance with the auxiliary component; translating the logical data plan to a physical data plan; and querying, based on the physical data plan, the to-be-queried database through an execution node.
(A3) In some embodiments of A1-A2, the graph analytics engine includes a plurality of execution nodes. Each execution node is associated with a respective to-be-queried database.
(A4) In some embodiments of A1-A3, the query is written in a graph query language.
(A5) In some embodiments of A1-A4, the to-be-queried database is built in accordance with a data architecture. The data architecture includes at least one of relational database, data warehouse, or data lake.
(A6) In some embodiments of A1-A5, the to-be-queried database defines the graph relationship between the target entities in a tabular form.
(A7) In some embodiments of A1-A6, the to-be-queried database is compatible with structured query language (SQL).
(A8) In some embodiments of A1-A7, the to-be-queried database includes a non-SQL (NoSQL) database.
(A9) In some embodiments of A1-A8, traversing the to-be-queried database using the query through the graph analytics engine further comprises: obtaining catalogs, schemas, and attributes, based on the graph relationship between the target entities; defining the plurality of vertices and the plurality of edges in form of arrays, based on the catalogs, schemas, and attributes; and generating the auxiliary component, based on the plurality of vertices and the plurality of edges.
(A10) In some embodiments of A1-A9, the auxiliary component is a human-readable file.
(A11) In some embodiments of A1-A10, the human-readable file is in a standard text-based format, including at least one of JavaScript Object Notation (JSON), Human-Optimized Config Object Notation (HOCON), or Extensible Markup Language (XML).
(A12) In some embodiments of A1-A11, a respective edge linking two adjacent vertices of the plurality of vertices is directed or undirected.
(A13) In some embodiments of A1-A12, the respective edge linking two adjacent vertices of the plurality of vertices includes a weight component.
(A14) In some embodiments of A1-A13, the auxiliary component is created through a user interface associated with the auxiliary component.
(A15) In some embodiments of A1-A14, generating the graph-based representation of the plurality of output entries further comprises: obtaining a respective graph relationship of the plurality of output entries; optimizing the respective graph relationship of the plurality of output entries for scalability; and visualizing the optimized respective graph relationship of the plurality of output entries.
(A16) In some embodiments of A1-A15, the receiving the graph query, the traversing the to-be-queried database using the query through the graph analytics engine to obtain the plurality of output entries, and the generating the graph-based representation of the plurality of output entries are performed via an application or a user interface.
(B1) In accordance with some embodiments, a computer system comprises one or more processors and memory storing one or more programs The one or more programs include instructions that, when executed by the one or more processors, cause the one or more processors to perform operations corresponding to any of A1-A16.
(C1) In accordance with some embodiments, a non-transitory computer readable storage medium stores one or more programs. The one or more programs include instructions that, when executed by a computer system that includes one or more processors, cause the one or more processors to perform operations corresponding to any of A1-A16.

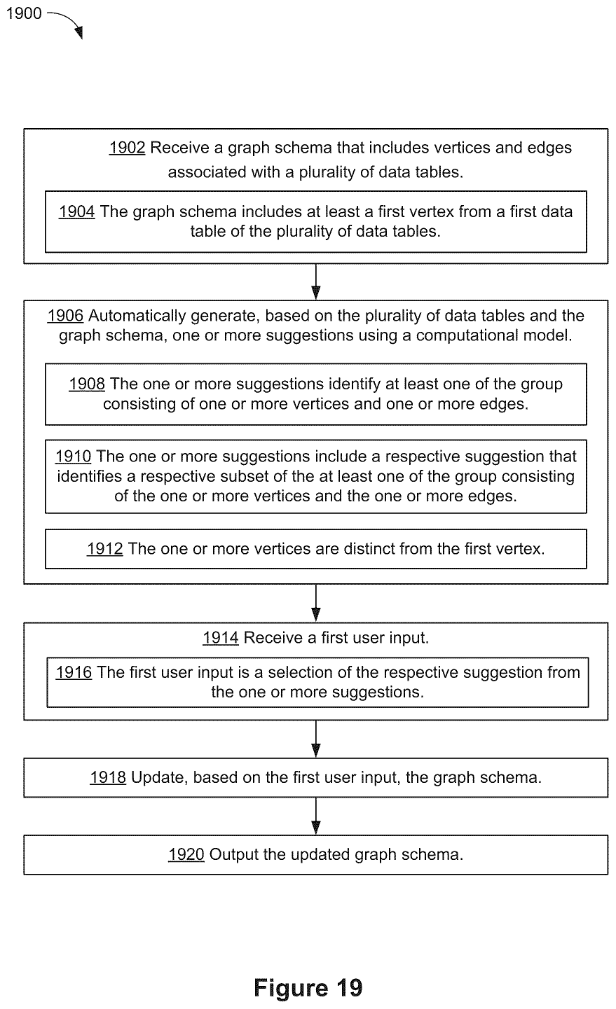

FIG. 19 illustrates a flow diagram of an example schema generation method 1900, in accordance with some embodiments. In some embodiments, the example schema generation method 1900 is performed at a computer system. In some embodiments, the example schema generation method 1900 is governed by instructions that are stored in a non-transitory computer-readable storage medium and that are executed by one or more processors of the computer system.
(D1) The method 1900 includes receiving (operation 1902) a graph schema that includes vertices and edges associated with a plurality of data tables. The graph schema includes (operation 1904) at least a first vertex from a first data table of the plurality of data tables. The schema generation method 1900 further includes automatically generating (operation 1906), based on the plurality of data tables and the graph schema, one or more suggestions using a computational model. The one or more suggestions identify (operation 1908) at least one of the group consisting of one or more vertices and one or more edges. The one or more suggestions include (operation 1910) a respective suggestion that identifies a respective subset of the at least one of the group consisting of the one or more vertices and the one or more edges. The one or more vertices are (operation 1912) distinct from the first vertex. The schema generation method 1900 further includes receiving (operation 1914) a first user input. The first user input is (operation 1916) a selection of the respective suggestion from the one or more suggestions. The schema generation method 1900 further includes updating (operation 1918), based on the first user input, the graph schema. The schema generation method 1900 further includes outputting (operation 1920) the updated graph schema.
(D2) In some embodiments of D1, the schema generation method 1900 further includes iteratively receiving a respective graph schema, automatically generating a respective suggestion, receiving a respective first user input, and updating the respective graph schema for a plurality of iterations to expand vertices and edges associated with the respective graph schema. Each iteration of the plurality of iterations corresponds to a respective updated graph schema. Each edge links two vertices.
(D3) In some embodiments of D1-D2, the computational model includes a plurality of models. Iteratively receiving the respective graph schema, automatically generating the respective suggestion, receiving the respective first user input, and updating the respective graph schema for the plurality of iterations to expand vertices and edges associated with the respective graph schema includes: in each iteration, receiving a respective second user input for selecting a respective model from the plurality of models and in response to the respective second user input, automatically generating, based on the plurality of data tables and the respective graph schema, the respective suggestion using the respective model.
(D4) In some embodiments of D1-D3, the computational model includes a rule-based suggestion model corresponding to a predefined rule.
(D5) In some embodiments of D1-D4, the computational model includes an intelligence model for executing large language models.
(D6) In some embodiments of D1-D5, the predefined rule includes a joining test rule. Automatically generating the one or more suggestions using the computational model includes identifying a second data table from the plurality of data tables. The second data table is distinct from the first data table. Automatically generating the one or more suggestions using the computational model further includes computing, for each column of the second data table and based on the joining test rule, a respective score. Automatically generating the one or more suggestions using the computational model further includes in accordance with a determination that the second data table includes two or more columns having scores that meet a threshold level, identifying, based on at least the second data table, a first set of edges to form a first suggestion. Automatically generating the one or more suggestions using the computational model further includes in accordance with a determination that the second data table includes one or more columns having scores that meet the threshold level, identifying, based on at least the second data table, a second set of edges and/or a first set of vertices to form a second suggestion. The first set of vertices is distinct from the first vertex.
(D7) In some embodiments of D1-D6, updating the graph schema includes adding the respective subset of the at least one of the group consisting of the one or more vertices and the one or more edges into the graph schema.
(D8) In some embodiments of D1-D7, the schema generation method 1900 further includes receiving a third user input for identifying an initial vertex from the plurality of data tables. The schema generation method 1900 further includes in response to the third user input, automatically generating the graph schema including the initial vertex.
(D9) In some embodiments of D1-D8, the schema generation method 1900 further includes receiving a user request. The schema generation method 1900 further includes in response to the user request, receiving the plurality of data tables.
(D10) In some embodiments of D1-D9, the schema generation method 1900 further includes displaying the one or more suggestions via a graphical interface.
(D11) In some embodiments of D1-D10, the schema generation method 1900 further includes displaying, based on at least one of the graph schema or the updated graph schema, a graph-based representation via a graphical interface.
(D12) In some embodiments of D1-D11, the plurality of data tables are relational data tables.
(D13) In some embodiments of D1-D12, the plurality of data tables are stored in at least one of the group consisting of relational database, data warehouse, and data lake.
(D14) In some embodiments of D1-D13, the receiving the graph schema, the automatically generating the one or more suggestions, the receiving the first user input, the updating the graph schema, and the outputting the updated graph schema are performed via an application or a user interface.
(E1) In accordance with some embodiments, a computer system comprises one or more processors and memory storing one or more programs. The one or more are configured to be executed by the one or more processors. The one or more programs include instructions corresponding to any of D1-D14.
(F1) In accordance with some embodiments, a non-transitory computer readable storage medium stores one or more programs. The one or more programs include instructions that, when executed by a computer system that includes one or more processors, cause the one or more processors to perform operations corresponding to any of D1-D14.

It should be understood that the particular order in which the operations in FIGS. 18 and 19 have been described are merely exemplary and are not intended to indicate that the described order is the only order in which the operations could be performed. One of ordinary skill in the art would recognize various ways to provide a computer system for performing data queries. It is also noted that more details on the data query method are explained above with reference to FIGS. 1-17. For brevity, these details are not repeated in the description herein.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A schema generation method, comprising:
receiving a graph schema that includes vertices and edges associated with a plurality of data tables, the graph schema including at least a first vertex from a first data table of the plurality of data tables;
automatically generating, based on the plurality of data tables and the graph schema, one or more suggestions using a computational model, wherein the one or more suggestions identify at least one of the group consisting of one or more vertices and one or more edges, the one or more suggestions including a respective suggestion that identifies a respective subset of the at least one of the group consisting of the one or more vertices and the one or more edges, the one or more vertices distinct from the first vertex;
receiving a first user input, wherein the first user input is a selection of the respective suggestion from the one or more suggestions;
updating, based on the first user input, the graph schema; and
outputting the updated graph schema.

2. The schema generation method of claim 1, including:
iteratively receiving a respective graph schema, automatically generating a respective suggestion, receiving a respective first user input, and updating the respective graph schema for a plurality of iterations to expand vertices and edges associated with the respective graph schema, each iteration of the plurality of iterations corresponding to a respective updated graph schema, each edge linking two vertices.

3. The schema generation method of claim 2, wherein:
the computational model includes a plurality of models; and
iteratively receiving the respective graph schema, automatically generating the respective suggestion, receiving the respective first user input, and updating the respective graph schema for the plurality of iterations to expand vertices and edges associated with the respective graph schema includes:
in each iteration:
receiving a respective second user input for selecting a respective model from the plurality of models; and
in response to the respective second user input, automatically generating, based on the plurality of data tables and the respective graph schema, the respective suggestion using the respective model.

4. The schema generation method of claim 1, wherein the computational model includes a rule-based suggestion model corresponding to a predefined rule.

5. The schema generation method of claim 1, wherein the computational model includes an intelligence model for executing large language models.

6. The schema generation method of claim 4, wherein:
the predefined rule includes a joining test rule; and
automatically generating the one or more suggestions using the computational model includes:
identifying a second data table from the plurality of data tables, the second data table distinct from the first data table;
computing, for each column of the second data table and based on the joining test rule, a respective score;
in accordance with a determination that the second data table includes two or more columns having scores that meet a threshold level:
identifying, based on at least the second data table, a first set of edges to form a first suggestion; and
in accordance with a determination that the second data table includes one or more columns having scores that meet the threshold level:
identifying, based on at least the second data table, a second set of edges and/or a first set of vertices to form a second suggestion, the first set of vertices distinct from the first vertex.

7. The schema generation method of claim 1, wherein:
updating the graph schema includes adding the respective subset of the at least one of the group consisting of the one or more vertices and the one or more edges into the graph schema.

8. The schema generation method of claim 1, including:
receiving a third user input for identifying an initial vertex from the plurality of data tables; and
in response to the third user input, automatically generating the graph schema including the initial vertex.

9. The schema generation method of claim 1, including:
receiving a user request; and
in response to the user request, receiving the plurality of data tables.

10. The schema generation method of claim 1, including:
displaying the one or more suggestions via a graphical interface.

11. The schema generation method of claim 1, including:
displaying, based on at least one of the graph schema or the updated graph schema, a graph-based representation via a graphical interface.

12. The schema generation method of claim 1, wherein the plurality of data tables are relational data tables.

13. The schema generation method of claim 1, wherein the plurality of data tables are stored in at least one of the group consisting of relational database, data warehouse, and data lake.

14. The schema generation method of claim 1, wherein the receiving the graph schema, the automatically generating the one or more suggestions, the receiving the first user input, the updating the graph schema, and the outputting the updated graph schema are performed via an application or a user interface.

15. A computer system, comprising:
one or more processors; and
memory storing one or more programs, wherein the one or more programs are configured to be executed by the one or more processors, the one or more programs including instructions for:
receiving a plurality of data tables, wherein the plurality of data tables have vertices and edges;
receiving a graph schema that includes at least a first vertex from a first data table of the plurality of data tables;
automatically generating, based on the plurality of data tables and the graph schema, a suggestion using a computational model, wherein the suggestion identifies at least one of the group consisting of one or more edges and one or more vertices, the one or more vertices distinct from the first vertex;
receiving a first user input corresponding to the suggestion;
updating, based on the first user input, the graph schema; and
outputting the updated graph schema.

16. The computer system of claim 15, wherein the one or more programs include instructions for:
iteratively receiving a respective graph schema, automatically generating a respective suggestion, receiving a respective first user input, and updating the respective graph schema for a plurality of iterations to expand vertices and edges associated with the respective graph schema, each iteration of the plurality of iterations corresponding to a respective updated graph schema, each edge linking two vertices.

17. The computer system of claim 16, wherein:
the computational model includes a plurality of models; and
iteratively receiving the respective graph schema, automatically generating the respective suggestion, receiving the respective first user input, and updating the respective graph schema for the plurality of iterations to expand vertices and edges associated with the respective graph schema includes:
in each iteration:
receiving a respective second user input for selecting a respective model from the plurality of models; and
in response to the respective second user input, automatically generating, based on the plurality of data tables and the respective graph schema, the respective suggestion using the respective model.

18. A non-transitory computer-readable storage medium storing one or more programs, the one or more programs comprising instructions that, when executed by a computer system that includes one or more processors, cause the one or more processors to perform operations, comprising:
receiving a plurality of data tables, wherein the plurality of data tables have vertices and edges;
receiving a graph schema that includes at least a first vertex from a first data table of the plurality of data tables;
automatically generating, based on the plurality of data tables and the graph schema, a suggestion using a computational model, wherein the suggestion identifies at least one of the group consisting of one or more edges and one or more vertices, the one or more vertices distinct from the first vertex;
receiving a first user input corresponding to the suggestion;
updating, based on the first user input, the graph schema; and
outputting the updated graph schema.

19. The non-transitory computer-readable storage medium of claim 18, wherein the one or more programs include instructions that, when executed by the computer system, cause the computer system to perform operations, including:
iteratively receiving a respective graph schema, automatically generating a respective suggestion, receiving a respective first user input, and updating the respective graph schema for a plurality of iterations to expand vertices and edges associated with the respective graph schema, each iteration of the plurality of iterations corresponding to a respective updated graph schema, each edge linking two vertices.

20. The non-transitory computer-readable storage medium 19, wherein:
the computational model includes a plurality of models; and
iteratively receiving the respective graph schema, automatically generating the respective suggestion, receiving the respective first user input, and updating the respective graph schema for the plurality of iterations to expand vertices and edges associated with the respective graph schema includes:
in each iteration:
receiving a respective second user input for selecting a respective model from the plurality of models; and
in response to the respective second user input, automatically generating, based on the plurality of data tables and the respective graph schema, the respective suggestion using the respective model.
